(19) United States
(12) Patent Application Publication
(10) Pub. No.: US 2026/0028562 A1
(43) Pub. Date: Jan. 29, 2026

(54) FLAVORED POROUS MATERIAL FOR FLAVORED BEVERAGE PRODUCTION

(71) Applicant: DANSTAR FERMENT AG, Zug (CH)

(72) Inventors: Robert FOTHERINGHAM, Montréal (CA); Chris RICHARDS, Montréal (CA); Struan REID, Montréal (CA); Elena FOSSATI, Montréal (CA)

(21) Appl. No.: 18/997,446

(22) PCT Filed: Jul. 21, 2023
(86) PCT No.: PCT/IB2023/057467

§ 371 Date: Jan. 21, 2025

Related U.S. Application Data
(60) Provisional application No. 63/391,575, filed on Jul. 22, 2022.

(51) Int. Cl. C12G 3/07; A23L 27/20; A23L 27/24

(52) U.S. Cl. CPC C12G 3/07; A23L 27/2026; A23L 27/2028; A23L 27/24

(57) ABSTRACT

The present disclosure concerns a flavored porous material as well as a flavored beverage obtained from using such flavored porous material. The flavored porous material can be obtained from contacting a flavored solution (which can be obtained from fermentation) with the porous material. The flavored beverage can be obtained from contacting the flavored porous material with an untreated beverage.

### CROSS-REFERENCE TO RELATED APPLICATION(S) AND DOCUMENT(S)

This application claims priority from U.S. provisional patent application 63/391,575 filed on Jul. 22, 2022 and herewith incorporated in its entirety. This application also comprises a sequence listing in electronic form which is also incorporated in its entirety.

### TECHNOLOGICAL FIELD

The present disclosure relates to processes for treating porous material used for imparting a flavor in the production of flavored beverages and to methods of flavoring a beverage thereof.

### BACKGROUND

Introducing a flavor to a beverage, more specifically an alcoholic beverage, during its aging or maturation is technically challenging and resource intensive as it requires the use of different techniques or technology to deliver the flavor. In many instances, the regulatory and trade association requirements associated with the production of some beverages limit the ability of a producer to introduce flavors by, for example, prohibiting the use of additives.

The process of aging or maturing new-make spirit (also known as ‘distillate’) is an important factor in the development of flavor and appearance for mature spirits. The practice is often required by laws such as the Spirit Drinks Verification Scheme (DEFRA). For example, a spirit resulting from distillation is required to mature for a period of at least three years prior to being marketed as Scotch Whisky. Maturation of spirit in contact with wood can be completed on the scale of days to decades in length, depending on the desired product, method of maturation, and climate in which the product is matured.

While other beverages do not have as strict rules about maturing the product prior to bottling, maturation is nonetheless a key feature of other distilled spirits including, but not limited to, other whiskey categories including bourbon, rye, wheat as well as world whisk(e)y categories such as Japanese, Canadian, and other origins. Other spirits originating from non-cereal substrates that practice maturation include rum (rhum, cachaça), tequila (mezcal, agave spirits), brandy (Cognac), and gin (jenever).

Maturation typically takes place in wooden casks, however, other methods of placing ethanol containing matrices in contact with wooden material (oak chips, barrel staves, etc) can also be utilized. During the process of maturation, three main processes occur extraction, evaporation and chemical reaction. The evaporation process occurs as the cask material, typically white oak (Quercus alba, Q. robur) (Nishimura et al) is porous. This allows for the gradual loss of volatile components of the maturing spirit (including both ethanol and water) as well as the relative increase in concentration of other non-volatiles throughout the maturation process (Hasuo et al). Chemical reactions may also occur during the process of maturation, where existing compounds in the maturing liquid may be broken down by processes such as hydrolysis and oxidation or by the reaction of compounds in solution with one another, including condensation reactions (Philip et al.).

Extraction processes occur during maturation due to a combination of the porosity, drying and heat treatments of the wood, treatments to the wood and the history of the cask. Barrel staves can be charred, toasted, or a combination of both, and these treatments influence what wood-derived molecules are extracted by the spirit. Due to the high ethanol content of maturing spirit and charring effects, breakdown of lignin-derived components in the wood lead to the release of important flavor-active components that are typical of mature spirits, such as vanillin (vanilla, sweet) and whisky lactone (coconut) (Conner et al). The water present in the spirit also plays a role in extraction of flavor by extracting water soluble flavors such as wood sugars. The choice of spirit fill strength influences this ethanol/water extraction profile and not all previous use casks have been extracted by the same prior fill strength; for example, wine is 13-18% ABV.

Depending on the intended spirit category, casks may also have historically contained a different spirit, such that ex-bourbon casks are commonly used to mature other types of spirits. Reuse of casks reduces the cost to the producer. Furthermore, casks are often referred to as ‘1st fill’, the first fill of that spirit type, ‘2nd fill’, the second fill of that spirit type directly following a 1st fill maturation period (Conner et al). This process can occur multiple times, where the cask extraction effect becomes increasingly weaker over time due to a lack of accessible wood flavor-active compounds.

Casks can be conditioned or seasoned using other non-bourbon beverages as well such as sherry, cognac, rum and, increasingly, tequila and mezcal. Men the fresh spirit is added it then takes on the characteristics of this cask, providing novel flavor characteristics in the process.

The novel flavor characteristics that these traditional style beverages impart to the maturation substrate are desirable to producers looking to create spirit profiles that are complementary to the matured product. By utilizing spirits produced using novel techniques, such as using high concentration flavor extracts or producing congener-enriched spirits from fermentations with bioengineered yeast strains, innovative cask characteristics can be produced. These in turn will influence the flavor of any subsequently matured spirit.

There is thus a need to expand the flavor profile of beverages while observing regulatory requirements associated with such beverage.

### BRIEF SUMMARY

The present disclosure concerns a method for obtaining a flavored porous material comprising at least one flavor compound and/or to a method for flavoring a beverage to obtain a flavored beverage by contacting the flavored porous material with the beverage.

According to a first aspect, the present disclosure provides a method for obtaining a flavored porous material comprising at least one flavor compound, the method comprising:
a) optionally fermenting a biomass with a recombinant microbial host cell comprising at least one genetic modification to produce the at least one flavor compound to obtain a first fermentation product;
b) providing a flavored solution having the at least one flavor compound, wherein the flavored solution is:
I. the first fermentation product or is derived from the first fermentation product; and/or
II. obtained by adding the at least one flavor compound to an aqueous solution; and
c) contacting the flavored solution with a porous material for a period of time allowing the at least first flavor compound to generate the flavored porous material.

In some embodiments, the method further comprises, after step c): separating the flavored solution from the flavored porous material to obtain an isolated flavored porous material and an isolated flavored solution. In an embodiment, the porous material is a container or a piece.

In a further embodiment, the container is a cask and the piece is a chip. In a more further embodiment, the porous material comprises a wooden material. In a more further embodiment, the wooden material comprises or is derived from an oak wood. In another embodiment, the period of time is at least 1 day. In still another embodiment, the flavored solution is at a temperature between 15-35° C. for the period of time. In yet another embodiment, the at least one flavor compound comprises a volatile compound or a non-volatile compound. In a further embodiment, the at least one flavor compound comprises 1-(2,3,6-Trimethyl phenyl)-1,3-butadiene, 1,2,5,6-Tetrahydrobenzaldehyde, 1,2-Epithiohumulene, 10-Undecenal, 2-(or 5)-Ethyl-5-(or 2)-methyl-4-hydroxy-3(2H)-furanone, 2,2-Dimethyl-trans-4-heptenal, 2,3,5-Trithiahexane, 2,3,6-Trichloroanisole, 2,3-Butanediol, 2,3-Dihydro-5-hydroxy-8-methyl-4(H)-pyran-4-one, 2,3-Dimethylpyrazine, 2,3-Hexanedione, 2,3-Pentanedione, 2,4-Dimethyl-3-pentanone, 2,5-Dimethyl-4-(1-pyrrolidinyl)-3(2H)-furanone, 2,5-Dimethyl-4-hydroxy-3(2H)-furanone, 2,5-Dimethylpyrazine, 2,6-Dimethyl-4-heptanone, 2,6-Dimethylpyrazine, 2-Acetyl-1-pyrroline, 2-Acetylfuran, 2-Acetylpyrrole, 2-Aminoacetophenone, 2-Butanethiol, 2-Butanol, 2-Butanone, 2-Butenal, 2-Butyl acetate, 2-Decanol, 2-Decanone, 2-Dodecanone, 2-Ethyl-2-hexenal, 2-Ethyl-5-methylpyrazine, 2-Ethyl-8-methylpyrazine, 2-Ethylbutanal, 2-Ethylhexanal, 2-Furfurylmercaptan, 2-Heptanol, 2-Heptanone, 2-Hexanol, 2-Hexanone, 2-Hexenal, 2-Methoxyphenol, 2-Methoxypyrazine, 2-Methyl-2-butenal, 2-Methylbutanal, 2-Methylbutanoic acid, 2-Methylbutanol, 2-Methylbutyl 2-methylpropanoate, 2-Methylbutyl acetate, 2-Methylpropanal, 2-Methylpropanoic acid, 2-Methylpropanol, 2-Nonanol, 2-Nonanone, 2-Octanol, 2-Octanone, 2-Pentanol, 2-Pentanone, 2-Phenylethanal, 2-Phenylethanol, 2-Phenylethyl acetate, 2-Propanol, 2-Propenal, 2-Tridecanone, 2-Undecanone, 3,3-Dimethyl-2-butanone, 3-Decanone, 3-Heptanone, 3-Hexenoic acid, 3-Hydroxy-3-methyl-2-butanone, 3-Hydroxy-4,5-dimethyl-2(5H)-furanone, 3-Mercaptohexanol, 3-Methyl-2-(1-pyrrolidiny)-2-cyclopenten-1-one, 3-Methyl-2-butanone, 3-Methyl-2-butene-1-thiol, 3-Methyl-3-mercaptobutyl, 3-Methyl-3-mercaptobutyl formate, 3-Methylbutanal, 3-Methylbutanol, 3-Methylthiophene, 3-Octanone, 3-Pentanol, 3-Pentanone, 4-(4-Hydroxyphenyl)-2-butanone, 4-Ethyl phenol, 4-Ethylguaiacol, 4-Heptanone, 4-Hydroxybenzaldehyde, 4-Mercapto-4-methyl-pentan-2-one, 4-Methoxybenzaldehyde, 4-Methyl-2-pentanone, 4-Methylcyclo-hexanone, 4-Phenyl-3-buten-2-one, 4-Propyl syringol, 4-Vinyl phenol, 4-Vinylguaiacol, 5-Hydroxymethylfurfural, 5-Methyl-2-hexanone, 5-Methyl-4-hydroxy-3(2H)-furanone, 5-Methylfurfural, 6-Methyl-3-heptanone, 8-methyl-N-vanillyl-8-nonenamide, 9-Decenoic acid, 9-Undecenal, Acetaldehyde, Acetic acid, Acetoin, Acetone, Acetophenone, Acetosyringone, Acetovanillone, Acetylpyrazine, Adenosine, Adenosine-5′-monophosphate, Alanine, Aldol, Ammonium chloride, Arginine, Asparagine, Aspartic acid, Benzaldehyde, Benzyl alcohol, Benzylacetone, Butanal, Butanoic acid, Butyl acetate, Butyl butyrate, Butyric acid, Caffeic acid, Calcium carbonate, Calcium chloride, Calcium sulfate, Capric acid, Caproic acid, Chlorophenol, Cinnamaldehyde, Cinnamic acid, cis-1,5-Octadien-3-one, cis-3-Hexenal, cis-3-Hexenoic acid, cis-3-Hexenol, cis-4-Heptenal, Citralt, Citric acid, Citronellal, Citronellol, Cuminaldehyde, Cyclohexanone, Cyclooctanecarboxaldehyde, Cyclopentanone, Cytidine, D-2-Octanol, D-Carvone, Decanal, Decanoic acid, D-Glyceraldehyde, Diacetyl, Dibutyl sulfide, Diethoxyethane, Diethyl disulfide, Diethyl sulfide, Dimethyl disulfide, Dimethyl sulfide, Dimethyl trisulfide, Dimethylallyl methyl sulfide, Dodecanal, D-Tartaric acid, Ellagic acid, Ethanol, Ethyl 2-methylbutanoate, Ethyl 2-methylpropanoate, Ethyl 3-hydroxyhexanoate, Ethyl 3-methylbutanoate, Ethyl 3-phenylpropanoate, Ethyl 4-methylpentanoate, Ethyl acetate, Ethyl butanoate, Ethyl caprylate, Ethyl cinnamate, Ethyl decanoate, Ethyl formate, Ethyl heptanoate, Ethyl hexanoate, Ethyl lactate, Ethyl laurate, Ethyl levulinate, Ethyl linoleate, Ethyl mercaptan, Ethyl myristate, Ethyl nicotinate, Ethyl nonanoate, Ethyl oleate, Ethyl palmitate, Ethyl palmitoleate, Ethyl pentadecanoate, Ethyl pentanoate, Ethyl stearate, Ethyl thioacetate, Ethyl tridecanoate, Ethyl undecanoate, Eugenol, Farnesene, Ferulic acid, Formaldehyde, Formic acid, Fructose, Fumaric acid, Furfural, Furfuryl acetate, Furfuryl alcohol, Furfuryl ethyl ether, Furylacrolein, Galactose, Gallic acid, Geraniol, Geranyl acetate, Geranyl isobutyrate, Glucose, Glutamic acid, Glutamine, Glycerinaldehyde, Glycerol, Glycine, Glyoxal, Glyoxylic acid, Guaiacol, Guanosine-5′-monophosphate, Heptanal, Heptanol, Hepten-3-ol, Heptyl acetate, Heptyl butyrate, Hexanal, Hexanol, Hexyl acetate, Histidine, Humuladienone, Humulene, Humulene epoxide, Hydrocinnamaldehyde, Hydrogen sulfide, Hydroxycitronellal, Inosine, Isoamyl acetate, Isoamyl caprate, Isoamyl caproate, Isoamyl caprylate, Isoamyl formate, Isoamyl isobutyrate, Isoamyl mercaptan, Isoamyl nonanoate, Isoamyl propionate, Isobutyl acetate, Isobutyl formate, Isobutyl mercaptan, Isoeugenol, Isohumulone, Isomaltol, Isomaltose, Isopropyl sulphidey, Isovaleric acid, Lactic acid, Lactose, Lauric acid, Leucine, Linalool, Linoleic acid, Linolenic acid, Lysine, Magnesium carbonate, Magnesium chloride, Magnesium sulfate, Malic acid, Maltol, Maltose, Maltotriose, m-Cresol, Mercaptan, Mesityl oxide, Methanethiol, Methanol, Methional, Methionine, Methionol, Methyl acetate, Methyl caprate, Methyl formate, Methyl vanillate, Methylglyoxal, Methylpyrazine, Methylthioacetate, Myrcene, Myrcene disulfide, N-[(4-hydroxy-3-methoxyphenyl)methyl]nonanamide, n-Amyl butyrate, n-Butanol, n-Butyl mercaptan, n-Decanal, n-Decanol, n-Dodecanol, Nerol, Niacin, n-Nonanol, n-Octyl acetate, n-Octyl butyrate, n-Octyl caproate, Nonanal, Nonanoic acid, Nootkatone, Nootkatone, n-Pentanol, n-Propyl acetate, n-Propylmercaptan, n-Undecan-2-ol, n-Undecanal, n-Undecanol, N-vanillyl octanamide, o-Cresol, Oct-2-enal, Octanal, Octanoic acid, Octanol, Octen-3-ol, Octen-3-one, Octyl ester acetate, Oleic acid, Oxalacetic acid, Oxalic acid, Pantothenic acid, p-Coumaric acid, p-Cresol, Pentanal, Pentanedione, Penten-3-ol, Penten-3-one, Phenol, Phenylacetic acid, Phenylalanine, Phenylethanol, Phenylpyruvic acid, p-Hydroxybenzoic acid. p-Methane-8-thiol-3-one, Potassium chloride, Proline, Propanal, Propanoic acid, Propanol, Pyrazine, Pyridoxine, Pyroglutamic acid, Pyruvic acid, Quercitrin, Riboflavin, Salicylaldehyde, Serine, S-Methyl-2-methylthiobutanoate, S-Methyl-2-methylthiopropionate, S-Methyl-3-methylthiobutanoate, S-Methylthiohexanoate, S-Methylthiomethyl-2-methylbutanethiolate, Sodium carbonate, Sodium chloride, Sodium sulfate, Stearic acid, Succinic acid, Succinic acid diethyl ester, Sucrose, Sulfur dioxide, Syringaldehyde, Tartaric acid, tert-Amyl mercaptan, tert-Butanol, tert-Butyl acetate, tert-Butyl mercaptan, Thiamine, Thiazole, Threonine, Thymol, trans,cis-2,4-Hexadienal, trans,cis-2,6-Nonadienal, trans,trans-2,4-Decadienal, trans,trans-2,4-Hexadienal, trans,trans-2,4-Nonadienal, trans-2-Decenal, trans-2-Heptenal, trans-2-Hexen-1-ol, trans-2-Hexenal, trans-2-Nonenal, trans-2-Nonenoic acid, trans-2-Octenal, Trichloroanisole, Trimethylpyrazine, Tryptophan, Tryptophol, Tyrosine, Tyrosol, Valencene, Valeric acid, Valine, Vanillic acid, Vanillin, Vanillin acetate, Vanillyl alcohol (4-Hydroxy-3-methoxybenzyl alcohol), Xylose, α-Ionone, α-Terpineol, β-Caryophyllene, β-Damascenone, β-Eudesmol, β-Farnesene, β-Ionone, β-Phenylacetaldehyde, γ-Aminobutyric acid, γ-Butyrolactone, γ-Decalactone, γ-Hexalactone, γ-Nonalactone, γ-Octalactone, γ-Pentalactone, and δ-Decalactone. In still another embodiment, the flavored solution comprises a further flavor compound. In yet another embodiment, the flavored solution comprises a distillate derived/obtained from the first fermentation product. In a more further embodiment, the aqueous solution is an ethanol-containing solution. In a further embodiment, the ethanol-containing solution is derived from a second fermentation product or comprises a distillate obtained from the second fermentation product. In an embodiment, the microbial host cell has a heterologous nucleic acid molecule encoding one or more heterologous polypeptide for the production the at least one flavor compound. In a further embodiment the at least one flavor compound comprises isoamyl acetate and:
i. the one or more heterologous polypeptide comprises a heterologous alcohol acetyl transferase (ATF) enzyme, a variant thereof or a fragment thereof; and/or
ii. optionally, the recombinant yeast host cell overexpresses a native alcohol acetyl transferase (ATF) enzyme.

In another embodiment, the at least first flavor compound comprises 4-(4-hydroxypheny)-2-butanone and the one or more heterologous polypeptide comprises:
i. a heterologous phenylalanine-ammonium lyase (PAL) enzyme, a variant thereof or a fragment thereof;
ii. a heterologous cinnimate-4-hydroxylase (C4H) enzyme, a variant thereof or a fragment thereof;
iii. a heterologous coumarate-CoA ligase (4CL) enzyme, a variant thereof or a fragment thereof;
iv. a heterologous benzalacetone synthase (BAS) enzyme, a variant thereof or a fragment thereof; and/or
v. a chimeric enzyme comprising a heterologous coumarate-CoA ligase (4CL) enzyme moiety and a heterologous benzalacetone synthase (BAS) enzyme moiety; and
vi. optionally, the recombinant yeast host cell overexpresses a native benzalactone reductase.

In another embodiment, the at least first flavor compound comprises ethyl lactate and the one or more heterologous polypeptide comprises heterologous lactate dehydrogenase.

In yet another embodiment, the recombinant microbial host cell is a recombinant yeast host cell.

According to a second aspect, the present disclosure provides a method for flavoring a beverage to obtain a flavored beverage, the method comprising contacting the isolated flavored porous material with a first untreated beverage to release the at least one flavor compound to obtain a first flavored beverage. In an embodiment, the isolated flavored porous material and the first untreated beverage are in contact for at least 1 day. In another embodiment, the flavored porous material and the first untreated beverage are in contact at a temperature between 15-35° C. In yet another embodiment, the method further comprises a step of separating the flavored beverage from the isolated flavored porous material to obtain a separated flavored porous material and a separated flavored beverage. In still another embodiment, the method further comprises contacting the separated flavored porous material with a second untreated beverage to release the at least one flavor compound to obtain a second flavored beverage. In one embodiment, the beverage is an alcoholic beverage. In a further embodiment, the alcoholic beverage is beer, brandy, cachaça, Cognac, mezcal, whisky, whiskey (for example bourbon, rye whiskey, wheat whiskey), gin, tequila, rum (for example rhum agricole), wine, mead, sake, baiju, shochu, soju, cider, perry, arrack, jenever, vermouth, Armangnac, kom, raki, pulque, basi, vodka, poitin, akvavit, aquavit, absinthe, spirits, new-make spirit, white dog, or moonshine. In yet another embodiment, the at least one flavor compound comprises a typical flavor compound or an atypical flavor for the beverage.

According to a third aspect, the present disclosure provides a flavored porous material obtained by the method defined herein.

According to a fourth aspect, the present disclosure provides a flavored beverage obtained by the method defined herein.

### BRIEF DESCRIPTION OF THE DRAWINGS

Having thus generally described the nature of the invention, reference will now be made to the accompanying drawings, showing by way of illustration, a preferred embodiment thereof, and in which:

FIG. 1 provides Isoamyl acetate quantification in distillates at filling time (T=0) and after 1, 3, 6 and 12 months of maturation in the three different casks: Untreated Bourbon cask control (ex-Bourbon single fill cask (control) used as a non-treated control), C1 control cask (ex-Bourbon single fill cask, treated with the whisky distillate from A-1 parental strain), and M1 cask (ex-Bourbon single fill cask, treated with the isoamyl acetate flavored distillate from strain A-1).

### DETAILED DESCRIPTION

The present disclosure provides a method for obtaining a flavored porous material comprising at least one flavor compound and/or to a method for flavoring a beverage to obtain a flavored beverage by contacting the flavored porous material with the beverage. As used herein, a “flavor compound” refers to compounds capable of triggering a flavor sensation in humans.

The method of the present disclosure comprises providing a flavored solution having the at least one flavor compound and contacting the flavored solution with a porous material for a period of time allowing the at least flavor compound to produce the flavored porous material. In some embodiments of the present disclosure, the flavored solution is a fermentation product or is derived from the first fermentation product. The first fermentation product can be obtained, for example, by fermenting a biomass with a recombinant microbial host cell comprising at least one genetic modification to produce the at least one flavor compound. The term “derived from” when referring to a first fermentation product includes any substance or combination of substances (including a solution) obtained by modifying the fermentation product, for example by distilling, filtering, concentrating, diluting the first fermentation product, or adding exogenous substances to said fermentation product. Alternatively or in combination, the flavored solution is obtained by adding the at least one flavor compound to an aqueous solution. The method can also include separating the flavored solution from the flavored porous material to obtain an isolated flavored porous material and an isolated flavored solution. In an alternate embodiment, the alcohol-containing solution has between 1 to 99 Percentage Alcohol By Volume (% ABV), between 5 to 99% ABV, between 5 to 80% ABV, between 5 to 60% ABV, or between 5 to 40% ABV. In a more particular embodiment, the alcohol-containing solution is an ethanol-containing solution. The ethanol-containing solution could be prepared by adding ethanol to an aqueous solution or by a second fermentation using conditions well-known in the art. In an embodiment, the ethanol-containing solution is a distillate obtained by distillation of the second fermentation. It is understood that the person in the art would know how to perform alcoholic fermentation by a microorganism and distil the resulting liquor to obtain a distillate.

As used herein, a “porous material” refers to a material containing pores in which fluids, such as the flavored solution, may penetrate and in compounds, such as the at least one flavor compound, may be absorbed or discharged. The porous material of the present disclosure could be a vessel, such as a container for holding a liquid (for example a cask or barrel), or a fragment or piece of a material, produced by cutting, tearing, or breaking the whole of a material. It is contemplated that the fragment of piece could have any form including powder, sticks, chunks, chips, staves, or combinations thereof. It is also contemplated that the fragment or pieces could be provided with a distinct shape, such as cubes, balls, a geometrical shape, and other shapes and can be sized such that they are able to fit through an opening of a container.

In an embodiment, the porous material is a wooden material of any type of wood or combinations of type of woods, including but not limited to oak, maple, hickory, mesquite, cherry, apple, pecan, alder, guava, almond, peach, apricot, acacia, ash, birch, cottonwood, lemon, lilac, mulberry, nectarine, orange, pear, plum, walnut, cedar, pine, grapefruit, lime, chestnut, sycamore, jequitibá, amburana, balsam, amendoim bravo, castanheira, freijo, Ipê, and combinations thereof. In a preferred embodiment, the porous material is an oak wood. When the porous material is a wooden material, the porous material can be heat-treated (e.g., roasted) prior the contact with the flavored solution. It is also contemplated that the wooden material can be roasted wood, charred wood, toasted wood, dehydrated wood, dried wood, raw wood, or combinations thereof. In some embodiments, the porous material is a cask. In some embodiments, the cask is a wooden cask. In further embodiments, the wooden cask may be a barrel, a hogshead, a butt, a quarter cask, a barrique, a puncheon, a port pipe, vats, or a madeira drum as those terms are commonly understood in the alcoholic beverage industry. In a preferred embodiment, the porous material is an American Standard Barrel. In other embodiments, the wooden cask is less than or equal in volume to 700 liters, the wooden cask is less than or equal in volume to 650 liters, the wooden cask is less than or equal in volume to 500 liters, the wooden cask is less than or equal in volume to 300 liters, the wooden cask is less than or equal in volume to 200 liters, the wooden cask is less than or equal in volume to 100 liters. In another embodiment, the wooden cask is between 50 liters and 650 liters in volume or the wooden cask is between 200 liters and 300 liters in volume.

In the context of the present disclosure, the term “flavor compound” is compound that can desirably affect the smell and/or taste of a beverage and the enjoyment associated with drinking the flavored beverage (Burdock et al.). Such flavor compound are well known in the art and have been described for example in Burdock et al, which is incorporated herein by reference. Some examples of flavor compound are summarized in Table 1. In one embodiment the flavor compound is an acid, alcohol, aldehyde, amide, amino acid, carbohydrate, ester, furan, hydrocarbon, inorganic, ketone, lactone, nitrogen-containing, organic acid, phenol, pyrazine, pyrrole, sulfur-containing, terpene and/or vitamin chemical compound. In a more particular embodiment, the flavor compound is an alcohol, aldehyde, ketone, acid, ester, lactone, and/or terpene chemical compound.

In one embodiment, the flavor compound is 1-(2,3,6-Trimethyl phenyl)-1,3-butadiene, 1,2,5,6-Tetrahydrobenzaldehyde, 1,2-Epithiohumulene, 10-Undecenal, 2-(or 5)-Ethyl-5-(or 2)-methyl-4-hydroxy-3(2H)-furanone, 2,2-Dimethyl-trans-4-heptenal, 2,3,5-Trithiahexane, 2,3,6-Trichloroanisole, 2,3-Butanediol, 2,3-Dihydro-5-hydroxy-8-methyl-4(H)-pyran-4-one, 2,3-Dimethylpyrazine, 2,3-Hexanedione, 2,3-Pentanedione, 2,4-Dimethyl-3-pentanone, 2,5-Dimethyl-4-(1-pyrrolidinyl)-3(2H)-furanone, 2,5-Dimethyl-4-hydroxy-3(2H)-furanone, 2,5-Dimethylpyrazine, 2,6-Dimethyl-4-heptanone, 2,6-Dimethylpyrazine, 2-Acetyl-1-pyrroline, 2-Acetylfuran, 2-Acetylpyrrole, 2-Aminoacetophenone, 2-Butanethiol, 2-Butanol, 2-Butanone, 2-Butenal, 2-Butyl acetate, 2-Decanol, 2-Decanone, 2-Dodecanone, 2-Ethyl-2-hexenal, 2-Ethyl-5-methylpyrazine, 2-Ethyl-8-methylpyrazine, 2-Ethylbutanal, 2-Ethylhexanal, 2-Furfurylmercaptan, 2-Heptanol, 2-Heptanone, 2-Hexanol, 2-Hexanone, 2-Hexenal, 2-Methoxyphenol, 2-Methoxypyrazine, 2-Methyl-2-butenal, 2-Methylbutanal, 2-Methylbutanoic acid, 2-Methylbutanol, 2-Methylbutyl 2-methylpropanoate, 2-Methylbutyl acetate, 2-Methylpropanal, 2-Methylpropanoic acid, 2-Methylpropanol, 2-Nonanol, 2-Nonanone, 2-Octanol, 2-Octanone, 2-Pentanol, 2-Pentanone, 2-Phenylethanal, 2-Phenylethanol, 2-Phenylethyl acetate, 2-Propanol, 2-Propenal, 2-Tridecanone, 2-Undecanone, 3,3-Dimethyl-2-butanone, 3-Decanone, 3-Heptanone, 3-Hexenoic acid, 3-Hydroxy-3-methyl-2-butanone, 3-Hydroxy-4,5-dimethyl-2(5H)-furanone, 3-Mercaptohexanol, 3-Methyl-2-(1-pyrrolidiny)-2-cyclopenten-1-one, 3-Methyl-2-butanone, 3-Methyl-2-butene-1-thiol, 3-Methyl-3-mercaptobutyl, 3-Methyl-3-mercaptobutyl formate, 3-Methylbutanal, 3-Methylbutanol, 3-Methylthiophene, 3-Octanone, 3-Pentanol, 3-Pentanone, 4-(4-Hydroxyphenyl)-2-butanone, 4-Ethyl phenol, 4-Ethylguaiacol, 4-Heptanone, 4-Hydroxybenzaldehyde, 4-Mercapto-4-methyl-pentan-2-one, 4-Methoxybenzaldehyde, 4-Methyl-2-pentanone, 4-Methylcyclo-hexanone, 4-Phenyl-3-buten-2-one, 4-Propyl syringol, 4-Vinyl phenol, 4-Vinylguaiacol, 5-Hydroxymethylfurfural, 5-Methyl-2-hexanone, 5-Methyl-4-hydroxy-3(2H)-furanone, 5-Methylfurfural, 6-Methyl-3-heptanone, 8-methyl-N-vanillyl-8-nonenamide, 9-Decenoic acid, 9-Undecenal, Acetaldehyde, Acetic acid, Acetoin, Acetone, Acetophenone, Acetosyringone, Acetovanillone, Acetylpyrazine, Adenosine, Adenosine-5′-monophosphate, Alanine, Aldol, Ammonium chloride, Arginine, Asparagine, Aspartic acid, Benzaldehyde, Benzyl alcohol, Benzylacetone, Butanal, Butanoic acid, Butyl acetate, Butyl butyrate, Butyric acid, Caffeic acid, Calcium carbonate, Calcium chloride, Calcium sulfate, Capric acid, Caproic acid, Chlorophenol, Cinnamaldehyde, Cinnamic acid, cis-1,5-Octadien-3-one, cis-3-Hexenal, cis-3-Hexenoic acid, cis-3-Hexenol, cis-4-Heptenal, Citralt, Citric acid, Citronellal, Citronellol, Cuminaldehyde, Cyclohexanone, Cyclooctanecarboxaldehyde, Cyclopentanone, Cytidine, D-2-Octanol, D-Carvone, Decanal, Decanoic acid, D-Glyceraldehyde, Diacetyl, Dibutyl sulfide, Diethoxyethane, Diethyl disulfide, Diethyl sulfide, Dimethyl disulfide, Dimethyl sulfide, Dimethyl trisulfide, Dimethylallyl methyl sulfide, Dodecanal, D-Tartaric acid, Ellagic acid, Ethanol, Ethyl 2-methylbutanoate, Ethyl 2-methylpropanoate, Ethyl 3-hydroxyhexanoate, Ethyl 3-methylbutanoate, Ethyl 3-phenylpropanoate, Ethyl 4-methylpentanoate, Ethyl acetate, Ethyl butanoate, Ethyl caprylate, Ethyl cinnamate, Ethyl decanoate, Ethyl formate, Ethyl heptanoate, Ethyl hexanoate, Ethyl lactate, Ethyl laurate, Ethyl levulinate, Ethyl linoleate, Ethyl mercaptan, Ethyl myristate, Ethyl nicotinate, Ethyl nonanoate, Ethyl oleate, Ethyl palmitate, Ethyl palmitoleate, Ethyl pentadecanoate, Ethyl pentanoate, Ethyl stearate, Ethyl thioacetate, Ethyl tridecanoate, Ethyl undecanoate, Eugenol, Farnesene, Ferulic acid, Formaldehyde, Formic acid, Fructose, Fumaric acid, Furfural, Furfuryl acetate, Furfuryl alcohol, Furfuryl ethyl ether, Furylacrolein, Galactose, Gallic acid, Geraniol, Geranyl acetate, Geranyl isobutyrate, Glucose, Glutamic acid, Glutamine, Glycerinaldehyde, Glycerol, Glycine, Glyoxal, Glyoxylic acid, Guaiacol, Guanosine-5′-monophosphate, Heptanal, Heptanol, Hepten-3-ol, Heptyl acetate, Heptyl butyrate, Hexanal, Hexanol, Hexyl acetate, Histidine, Humuladienone, Humulene, Humulene epoxide, Hydrocinnamaldehyde, Hydrogen sulfide, Hydroxycitronellal, Inosine, Isoamyl acetate, Isoamyl caprate, Isoamyl caproate, Isoamyl caprylate, Isoamyl formate, Isoamyl isobutyrate, Isoamyl mercaptan, Isoamyl nonanoate, Isoamyl propionate, Isobutyl acetate, Isobutyl formate, Isobutyl mercaptan, Isoeugenol, Isohumulone, Isomaltol, Isomaltose, Isopropyl sulphide, Isovaleric acid, Lactic acid, Lactose, Lauric acid, Leucine, Linalool, Linoleic acid, Linolenic acid, Lysine, Magnesium carbonate, Magnesium chloride, Magnesium sulfate, Malic acid, Maltol, Maltose, Maltotriose, m-Cresol, Mercaptan, Mesityl oxide, Methanethiol, Methanol, Methional, Methionine, Methionol, Methyl acetate, Methyl caprate, Methyl formate, Methyl vanillate, Methylglyoxal, Methylpyrazine, Methylthioacetate, Myrcene, Myrcene disulfide, N-[(4-hydroxy-3-methoxyphenyl)methyl]nonanamide, n-Amyl butyrate, n-Butanol, n-Butyl mercaptan, n-Decanal, n-Decanol, n-Dodecanol, Nerol, Niacin, n-Nonanol, n-Octyl acetate, n-Octyl butyrate, n-Octyl caproate, Nonanal, Nonanoic acid, Nootkatone, n-Pentanol, n-Propyl acetate, n-Propylmercaptan, n-Undecan-2-ol, n-Undecanal, n-Undecanol, N-vanillyl octanamide, o-Cresol, Oct-2-enal, Octanal, Octanoic acid, Octanol, Octen-3-ol, Octen-3-one, Octyl ester acetate, Oleic acid, Oxalacetic acid, Oxalic acid, Pantothenic acid, p-Coumaric acid, p-Cresol, Pentanal, Pentanedione, Penten-3-ol, Penten-3-one, Phenol, Phenylacetic acid, Phenylalanine, Phenylethanol, Phenylpyruvic acid, p-Hydroxybenzoic acid. p-Methane-8-thiol-3-one, Potassium chloride, Proline, Propanal, Propanoic acid, Propanol, Pyrazine, Pyridoxine, Pyroglutamic acid, Pyruvic acid, Quercitrin, Riboflavin, Salicylaldehyde, Serine, S-Methyl-2-methylthiobutanoate, S-Methyl-2-methylthiopropionate, S-Methyl-3-methylthiobutanoate, S-Methylthiohexanoate, S-Methylthiomethyl-2-methylbutanethiolate, Sodium carbonate, Sodium chloride, Sodium sulfate, Stearic acid, Succinic acid, Succinic acid diethyl ester, Sucrose, Sulfur dioxide, Syringaldehyde, Tartaric acid, tert-Amyl mercaptan, tert-Butanol, tert-Butyl acetate, tert-Butyl mercaptan, Thiamine, Thiazole, Threonine, Thymol, trans,cis-2,4-Hexadienal, trans,cis-2,6-Nonadienal, trans,trans-2,4-Decadienal, trans,trans-2,4-Hexadienal, trans,trans-2,4-Nonadienal, trans-2-Decenal, trans-2-Heptenal, trans-2-Hexen-1-ol, trans-2-Hexenal, trans-2-Nonenal, trans-2-Nonenoic acid, trans-2-Octenal, Trichloroanisole, Trimethylpyrazine, Tryptophan, Tryptophol, Tyrosine, Tyrosol, Valencene, Valeric acid, Valine, Vanillic acid, Vanillin, Vanillin acetate, Vanillyl alcohol (4-Hydroxy-3-methoxybenzyl alcohol), Xylose, α-Ionone, α-Terpineol, β-Caryophyllene, β-Damascenone, β-Eudesmol, β-Farnesene, β-Ionone, β-Phenylacetaldehyde, γ-Aminobutyric acid, γ-Butyrolactone, γ-Decalactone, γ-Hexalactone, γ-Nonalactone, γ-Octalactone, γ-Pentalactone, and/or δ-Decalactone.

In a more specific embodiment, the flavor compound is lactic acid, sucrose, lactose, ethyl decanoate, valencene, nootkatone, vanillin, isoamyl acetate, 4-(4-hydroxyphenyl)-2-butanone, 4-ethylphenol and/or 4-ethylguaiacol, ethyl caproate, or vanillyloctanamide. In a more specific embodiment, the flavor compound is 10-Undecenal, 2,3,6-Trichloroanisole, 2,3-Butanediol, 2,3-Dimethylpyrazine, 2,3-Pentanedione, 2,5-Dimethyl-4-hydroxy-3(2H)-furanone, 2,5-Dimethylpyrazine, 2,6-Dimethylpyrazine, 2-Acetyl-1-pyrroline, 2-Acetylfuran, 2-Acetylpyrrole, 2-Butanethiol, 2-Butanol, 2-Butyl acetate, 2-Decanol, 2-Ethyl-2-hexenal, 2-Ethyl-5-methylpyrazine, 2-Ethyl-8-methylpyrazine, 2-Ethylbutanal, 2-Ethylhexanal, 2-Furfurylmercaptan, 2-Heptanol, 2-Hexanol, 2-Hexenal, 2-Methoxyphenol, 2-Methoxypyrazine, 2-Methylbutanal, 2-Methylbutanoic acid, 2-Methylbutanol, 2-Methylbutyl 2-methylpropanoate, 2-Methylbutyl acetate, 2-Methylpropanal, 2-Methylpropanoic acid, 2-Methylpropanol, 2-Octanol, 2-Phenylethanal, 2-Phenylethanol, 2-Phenylethyl acetate, 2-Propenal, 2-Tridecanone, 2-Undecanone, 3,3-Dimethyl-2-butanone, 3-Decanone, 3-Hexenoic acid, 3-Hydroxy-3-methyl-2-butanone, 3-Hydroxy-4,5-dimethyl-2(5H)-furanone, 3-Methyl-2-butanone, 3-Methyl-3-mercaptobutyl, 3-Methyl-3-mercaptobutyl formate, 3-Methylbutanal, 3-Methylbutanol, 3-Methylthiophene, 3-Octanone, 3-Pentanol, 3-Pentanone, 4-Ethyl phenol, 4-Ethylguaiacol, 4-Hydroxybenzaldehyde, 4-Vinyl phenol, 4-Vinylguaiacol, 5-Hydroxymethylfurfural, 5-Methylfurfural, 9-Decenoic acid, Acetaldehyde, Acetic acid, Acetoin, Acetophenone, Acetosyringone, Acetovanillone, Acetylpyrazine, Benzaldehyde, Butanoic acid, Butyl acetate, Butyl butyrate, Butyric acid, Capric acid, Caproic acid, Cinnamaldehyde, Cinnamic acid, cis-3-Hexenal, cis-3-Hexenoic acid, cis-3-Hexenol, Decanoic acid, D-Glyceraldehyde, Diacetyl, Diethoxyethane, Diethyl disulfide, Diethyl sulfide, Dimethyl disulfide, Dimethyl sulfide, Dimethyl trisulfide, Ellagic acid, Ethanol, Ethyl 2-methylbutanoate, Ethyl 2-methylpropanoate, Ethyl 3-hydroxyhexanoate, Ethyl 3-methylbutanoate, Ethyl 3-phenylpropanoate, Ethyl 4-methylpentanoate, Ethyl acetate, Ethyl butanoate, Ethyl caprylate, Ethyl cinnamate, Ethyl decanoate, Ethyl formate, Ethyl heptanoate, Ethyl hexanoate, Ethyl lactate, Ethyl laurate, Ethyl linoleate, Ethyl mercaptan, Ethyl myristate, Ethyl nonanoate, Ethyl oleate, Ethyl palmitate, Ethyl palmitoleate, Ethyl pentadecanoate, Ethyl pentanoate, Ethyl stearate, Ethyl thioacetate, Ethyl tridecanoate, Ethyl undecanoate, Eugenol, Farnesene, Ferulic acid, Formaldehyde, Formic acid, Fructose, Furfural, Furfuryl acetate, Furfuryl alcohol, Furfuryl ethyl ether, Gallic acid, Glucose, Glycerol, Guaiacol, Heptanal, Heptanol, Heptyl acetate, Heptyl butyrate, Hexanal, Hexanol, Hexyl acetate, Hydrocinnamaldehyde, Hydrogen sulfide, Isoamyl acetate, Isoamyl caprate, Isoamyl caproate, Isoamyl caprylate, Isoamyl formate, Isoamyl isobutyrate, Isoamyl mercaptan, Isoamyl nonanoate, Isoamyl propionate, Isobutyl acetate, Isobutyl formate, Isobutyl mercaptan, Isoeugenol, Isovaleric acid, Lactic acid, Lauric acid, Linalool, Linoleic acid, Linolenic acid, m-Cresol, Mercaptan, Methanethiol, Methanol, Methional, Methionol, Methyl acetate, Methyl caprate, Methyl formate, Methylpyrazine, Methylthioacetate, n-Butanal, n-Butanol, n-Butyl mercaptan, n-Decanal, n-Decanol, n-Dodecanol, n-Nonanal, n-Nonanol, n-Octanal, n-Octyl acetate, n-Octyl butyrate, n-Octyl caproate, Nonanoic acid, n-Pentanal, n-Pentanol, n-Propanal, n-Propyl acetate, n-Propyl mercaptan, n-Undecan-2-ol, n-Undecanal, n-Undecanol, o-Cresol, Oct-2-enal, Octanoic acid, Octanol, Oleic acid, Oxalic acid, p-Coumaric acid, p-Cresol, Pentanedione, Phenol, Phenylacetic acid, Phenylethanol, p-Hydroxybenzoic acid, Propanoic acid, Propanol, Pyrazine, Pyruvic acid, Stearic acid, Succinic acid, Succinic acid diethyl ester, Sucrose, Sulfur dioxide, Syringaldehyde, tert-Amyl mercaptan, tert-Butanol, tert-Butyl acetate, tert-Butyl mercaptan, Thiazole, trans,cis-2,4-Hexadienal, trans,cis-2,6-Nonadienal, trans,trans-2,4-Decadienal, trans,trans-2,4-Hexadienal, trans,trans-2,4-Nonadienal, trans-2-Decenal, trans-2-Heptenal, trans-2-Hexen-1-ol, trans-2-Hexenal, trans-2-Nonenal, trans-2-Nonenoic acid, trans-2-Octenal, Trichloroanisole, Trimethylpyrazine, Valencene, Valeric acid, Vanillic acid, Vanillin, Vanillin acetate, Vanillyl alcohol, α-Ionone, β-Damascenone, β-Farnesene, β-Ionone, β-Methyl-γ-octalactone, β-Phenylacetaldehyde, γ-Butyrolactone, γ-Decalactone, γ-Hexalactone, γ-Nonalactone, γ-Octalactone, γ-Pentalactone, or α-Decalactone.

In a specific embodiment, the flavor compound is lactic acid, valencene, nootkatone, vanillin, isoamyl acetate, 4-(4-hydroxyphenyl)-2-butanone, 4-ethyl-phenol and/or 4-ethyl guaiacol, ethyl caproate, and/or vanillyloctanamide.

In a specific embodiment, the flavor compound is lactic acid, ethyl lactate, valencene, nootkatone, vanillin, isoamyl acetate, 4-(4-hydroxyphenyl)-2-butanone, 4-ethyl-phenol and/or 4-ethyl guaiacol, ethyl caproate, and/or vanillyloctanamide. In a more specific embodiment, the flavor compound is galactose, sucrose, ethyl decanoate, ethyl acetate, isoamyl acetate, and/or vanillin.

In a more specific embodiment, the flavor compound is galactose, sucrose, ethyl decanoate, ethyl acetate, ethyl lactate, 4-(4-Hydroxyphenyl)-2-butanone, isoamyl acetate, phenethyl acetate and/or vanillin.

In a more specific embodiment, the flavor compound is ethyl lactate, 4-(4-Hydroxypheny)-2-butanone, and/or isoamyl acetate.

Some of those flavor compounds have a low gas/liquid partition coefficient which makes them non-volatile (for example sucrose) while some other flavor compounds have higher gas/liquid partition coefficients making them volatile (for example isoamyl acetate, ethyl caproate, etc.). In the context of the present disclosure, the term “volatile compound” is a compound that goes through a distillation process and is found in the resulting liquor and a non-volatile compound is a compound with a higher boiling point that does not complete the distillation process and remains in the residues. This property of the flavor compounds is for example in the context of a distillation of a beverage such as a spirit. In one embodiment, the flavor compound comprises or is a volatile compound. In a particular embodiment, the volatile compound is isoamyl acetate, 4-(4-hydroxyphenyl)-2-butanone, 4-ethyl phenol and/or 4-ethyl guaiacol, and/or ethyl caproate. In another embodiment, the flavor compound comprises or is a non-volatile compound. In a particular embodiment, the non-volatile compound is lactose, galactose, and/or sucrose.

TABLE 1
Flavor compounds description

| | Compound | |
|---|---|---|
| Chemical Name | Classification | Flavor Descriptors |
| 1-(2,3,6-Trimethyl phenyl)-1,3- | Hydrocarbon | leather, geranium-like |
| butadiene | | |
| 1,2,5,6-Tetrahydrobenzaldehyde | Aldehyde | fruity, aromatic, sweet, astringent |
| 1,2-Epithiohumulene | Sulfur | musty, sulfurous, cardboard |
| | compound | |
| 10-Undecenal | Aldehyde | aldehyde, bitter, orange peel |
| 2-(or 5)-Ethyl-5-(or 2)-methyl-4- | Furan | sweet, caramel-like |
| hydroxy-3(2H)-furanone | | |
| 2,2-Dimethyl-trans-4-heptenal | Aldehyde | aldehyde, bitter, astringent, |
| | | orange, unpleasant |
| 2,3,5-Trithiahexane | Sulfur | burnt, rubber |
| | compound | |
| 2,3,6-Trichloroanisole | Phenol | musty |
| 2,3-Butanediol | Alcohol | rubber, sweet, warming, diacetyl, |
| | | butterscotch |
| 2,3-Dihydro-5-hydroxy-6-methyl- | Ketone | caramel-like |
| 4(H)-pyran-4-one | | |
| 2,3-Dimethylpyrazine | Pyrazine | cocoa, green, nutty |
| 2,3-Hexanedione | Ketone | strawberry, diacetyl, pleasant |
| 2,3-Pentanedione | Ketone | fruity, butterscotch-like, butter, |
| | | honey-like, woody, diacetyl, |
| | | fruity, sweet |
| 2,4-Dimethyl-3-pentanone | Ketone | ethyl ether, varnish, sweet |
| 2,5-Dimethyl-4-(1-pyrrolidinyl)- | Furan | cooling effect |
| 3(2H)-furanone | | |
| 2,5-Dimethyl-4-hydroxy-3(2H)- | Furan | sweet, caramel-like, pineapple, |
| furanone | | toffee |
| 2,5-Dimethylpyrazine | Pyrazine | earthy, potato |
| 2,6-Dimethyl-4-heptanone | Ketone | ketone, banana |
| 2,6-Dimethylpyrazine | Pyrazine | nutty, coffee |
| 2-Acetyl-1-pyrroline | Pyrrole | roasted |
| 2-Acetylfuran | Furan | almonds, rubber, burnt/phenolic, |
| | | pyrazole, nutty |
| 2-Acetylpyrrole | Pyrrole | walnut, liquorice |
| 2-Aminoacetophenone | Ketone | stale, grainy, waxy, grape |
| | | (seeds), papery, sweet, flowery, |
| | | astringent |
| 2-Butanethiol | Sulfur | putrefaction (of onion, garlic, |
| | compound | cheese, fish, egg) |
| 2-Butanol | Alcohol | alcoholic |
| 2-Butanone | Ketone | acetone, varnish, stale |
| 2-Butenal | Aldehyde | apple, green leaves, almond |
| 2-Butyl acetate | Ester | banana, sweet, paint thinner, |
| | | plastic glue |
| 2-Decanol | Alcohol | coconut, aniseed |
| 2-Decanone | Ketone | ketone, flowery, sweet |
| 2-Dodecanone | Ketone | ketone, varnish, green plants, |
| | | geranium |
| 2-Ethyl-2-hexenal | Aldehyde | aldehyde, bitter, rancid, fruity, |
| | | flowery |
| 2-Ethyl-5-methylpyrazine | Pyrazine | grassy, nutty, roasted |
| 2-Ethyl-6-methylpyrazine | Pyrazine | baked potato, roasted |
| 2-Ethylbutanal | Aldehyde | fruity, varnish, bitter, aldehyde |
| 2-Ethylhexanal | Aldehyde | orange, grass, aldehyde, |
| | | astringent |
| 2-Furfurylmercaptan | Sulfur | rubbery |
| | compound | |
| 2-Heptanol | Alcohol | coconut |
| 2-Heptanone | Ketone | varnish, ketone, walnut, hops, |
| | | stale |
| 2-Hexanol | Alcohol | coconut |
| 2-Hexanone | Ketone | ketone, Roquefort cheese |
| 2-Hexenal | Aldehyde | almond, fruity, green, sweet |
| 2-Methoxyphenol | Phenol | smoky |
| 2-Methoxypyrazine | Pyrazine | cereal roasted |
| 2-Methyl-2-butenal | Aldehyde | ethereal, green, penetrating, |
| | | powerful |
| 2-Methylbutanal | Aldehyde | green grass, fruity, cheese, |
| | | sour/medicinal, almond, apple- |
| | | like, malty |
| 2-Methylbutanoic acid | Acid | sweaty, rancid, unpleasantly |
| | | sour |
| 2-Methylbutanol | Alcohol | malty, alcoholic, vinous, banana, |
| | | sweetish, solvent, medicinal |
| 2-Methylbutyl 2-methylpropanoate | Ester | fruity |
| 2-Methylbutyl acetate | Ester | apple, banana |
| 2-Methylpropanal | Aldehyde | malty, grainy, husk-like, varnish, |
| | | fruity, banana, melon, green |
| | | malt, green leaves, bitter, |
| | | alcoholic |
| 2-Methylpropanoic acid | Acid | sweaty, bitter, sour |
| 2-Methylpropanol | Alcohol | alcoholic, malty, solvent-like |
| 2-Nonanol | Alcohol | coconut |
| 2-Nonanone | Ketone | ketone, varnish, stale |
| 2-Octanol | Alcohol | coconut, walnut, oily, rancid |
| 2-Octanone | Ketone | varnish, ketone, walnut, stale |
| 2-Pentanol | Alcohol | alcoholic, fruity, raspberry, |
| | | walnut, ethereal, nutty |
| 2-Pentanone | Ketone | jasmine, geranium, ketone, |
| | | varnish |
| 2-Phenylethanal | Aldehyde | floral (hyacinth, roses, lilac), |
| | | honey-like, sweet, aldehyde |
| 2-Phenylethanol | Alcohol | alcohol, flowery, honey-like, |
| | | roses, sweet |
| 2-Phenylethyl acetate | Ester | roses, honey, apple, sweet, |
| | | flowery |
| 2-Propanol | Alcohol | alcoholic |
| 2-Propenal | Aldehyde | sweet, honey, sherry |
| 2-Tridecanone | Ketone | ketone, varnish |
| 2-Undecanone | Ketone | ketone, varnish, bitter, green |
| | | plants, geranium |
| 3,3-Dimethyl-2-butanone | Ketone | varnish, ethyl ether, ketone, |
| | | sweet |
| 3-Decanone | Ketone | ketone, sweet, varnish |
| 3-Heptanone | Ketone | ketone, varnish, sweet |
| 3-Hexenoic acid | Acid | dry leaves, goaty, fatty acids |
| 3-Hydroxy-3-methyl-2-butanone | Ketone | sweet, ketone, bitter, caramel, |
| | | unpleasant |
| 3-Hydroxy-4,5-dimethyl-2(5H)- | Furan | spicy, hydrolyzed protein |
| furanone | | |
| 3-Mercaptohexanol | Alcohol | fruity, catty, thiol-like |
| 3-Methyl-2-(1-pyrrolidinyl)-2- | Ketone | cooling effect |
| cyclopenten-1-one | | |
| 3-Methyl-2-butanone | Ketone | ketone, sweet, mint |
| 3-Methyl-2-butene-1-thiol | Sulfur | almond, roasted, sulfurous, |
| | compound | mercaptan, skunk, leek-like, |
| | | lightstruck |
| 3-Methyl-3-mercaptobutyl | Sulfur | catty, Ribes |
| | compound | |
| 3-Methyl-3-mercaptobutyl formate | Sulfur | catty, Ribes |
| | compound | |
| 3-Methylbutanal | Aldehyde | malty, cherry, almond, chocolate, |
| | | apple, cheese, unripe banana |
| 3-Methylbutanol | Alcohol | alcohol, banana, sweet, |
| | | aromatic, malty, vinous, pungent |
| 3-Methylthiophene | Sulfur | burnt, astringent |
| | compound | |
| 3-Octanone | Ketone | ketone, varnish, spicy |
| 3-Pentanol | Alcohol | alcohol, medicinal, ether, nutty, |
| | | fruity |
| 3-Pentanone | Ketone | ethyl ether, ketone, sweet |
| 4-(4-Hydroxyphenyl)-2-butanone | Ketone | citrus, raspberry |
| 4-Ethyl phenol | Phenol | phenolic, astringent |
| 4-Ethylguaiacol | Phenol | phenolic, sweet, medicinal |
| 4-Heptanone | Ketone | ketone, varnish, mint |
| 4-Hydroxybenzaldehyde | Aldehyde | vanilla, sweet, warm |
| 4-Mercapto-4-methyl-pentan-2-one | Sulfur | Ribes, blackcurrant, muscat-like, |
| | compound | fruity |
| 4-Methoxybenzaldehyde | Aldehyde | aniseed-like |
| 4-Methyl-2-pentanone | Ketone | varnish, ketone, melon, apricot |
| 4-Methylcyclo-hexanone | Ketone | mint, coconut |
| 4-Phenyl-3-buten-2-one | Ketone | ketone, cake topping aerosol, |
| | | varnish |
| 4-Propyl syringol | Phenol | phenolic |
| 4-Vinyl phenol | Phenol | strongly phenolic |
| 4-Vinylguaiacol | Phenol | smoky, spicy, cloves, vanilla-like, |
| | | phenolic, clove-like, bitter |
| 5-Hydroxymethylfurfural | Aldehyde | stale, vegetable oil, paper-like, |
| | | vegetables, bready, caramel |
| 5-Methyl-2-hexanone | Ketone | ketone, sweet |
| 5-Methyl-4-hydroxy-3(2H)-furanone | Furan | brothy, meaty |
| 5-Methylfurfural | Aldehyde | almond, marzipan, spicy, sweet, |
| | | caramel, vanilla, bitter, |
| | | burnt/phenolic |
| 6-Methyl-3-heptanone | Ketone | varnish |
| 8-methyl-N-vanillyl-6-nonenamide | Amide | herbal, spicy, warm |
| 9-Decenoic acid | Acid | fruity, milky, waxy |
| 9-Undecenal | Aldehyde | aldehyde, orange, peel, bitter |
| Acetaldehyde | Aldehyde | grassy, green leaves, fruity, |
| | | green apple, apple skin, paint, |
| | | sweet, pungent |
| Acetic acid | Acid | acid, acetic, sour, pungent, |
| | | vinegar |
| Acetoin | Ketone | fruity, moldy, woody |
| Acetone | Ketone | acetone, fruity |
| Acetophenone | Ketone | almonds, marzipan, earthy |
| Acetosyringone | Ketone | smoky, sweet |
| Acetovanillone | Ketone | vanilla-like, spicy |
| Acetylpyrazine | Pyrazine | sweet, candy floss, caramel |
| Adenosine | N-Compound | glutamate-like, slightly bitter |
| Adenosine-5′-monophosphate | N-Compound | chalky, bitter, glutamate-like |
| Alanine | Amino acid | sweet |
| Aldol | Alcohol | varnish, banana |
| Ammonium chloride | Inorganic | sour-salty |
| | compound | |
| Arginine | Amino acid | sweet-bitter, astringent |
| Asparagine | Amino acid | sweet, bitter, glutamate-like |
| Aspartic acid | Amino acid | methanol-like, sour, glutamate- |
| | | like |
| Benzaldehyde | Aldehyde | bitter almond, cherry stone, |
| | | almond |
| Benzyl alcohol | Alcohol | almonds, bitter |
| Benzylacetone | Ketone | banana, mango, sweet |
| Butanal | Aldehyde | green malt, melons, varnish-like, |
| | | green leaves |
| Butanoic acid | Organic acid | baby vomit, unpleasant |
| Butyl acetate | Ester | solvent, banana, acetone, sweet |
| Butyl butyrate | Ester | banana, fruity, green, pineapple, |
| | | tropical |
| Butyric acid | Acid | buttery, rancid, cheesy, butyric |
| Caffeic acid | Phenol | astringent |
| Calcium carbonate | Inorganic | salty, sweet, sour compensatory |
| | compound | |
| Calcium chloride | Inorganic | soapy, salty, sour |
| | compound | |
| Calcium sulfate | Inorganic | chalky, bitter, sweet-sour |
| | compound | |
| Capric acid | Acid | waxy, caprylic, tallowy, rancid, |
| | | soapy |
| Caproic acid | Acid | goaty, fatty acid, vegetable oil, |
| | | sweaty, caprylic |
| Chlorophenol | Phenol | medicinal |
| Cinnamaldehyde | Aldehyde | cinnamon, sweet, aldehyde |
| Cinnamic acid | Phenol | burning, sweet |
| cis-1,5-Octadien-3-one | Ketone | green, metallic |
| cis-3-Hexenal | Aldehyde | green, leafy, green leaves, |
| | | freshly cut grass |
| cis-3-Hexenoic acid | Acid | rancid, sweaty |
| cis-3-Hexenol | Alcohol | green, grassy, green leaves, |
| | | bananas, sweet |
| cis-4-Heptenal | Aldehyde | aldehyde, bitter, papery, vinous, |
| | | unpleasant |
| Citral | Terpene | lemon, bitter |
| Citric acid | Acid | citrus-like, sour |
| Citronellal | Terpene | orange peel, bitter, burning |
| Citronellol | Terpene | floral, citrus, rose-like |
| Cuminaldehyde | Aldehyde | cumin seed, almond, cinnamon, |
| | | varnish |
| Cyclohexanone | Ketone | almond, ketone, bitter |
| Cyclooctanecarboxaldehyde | Aldehyde | mint, bitter, aldehyde |
| Cyclopentanone | Hydrocarbon | almond, sweet, ethyl ether |
| Cytidine | N-Compound | glutamate-like, bitter |
| D-2-Octanol | Alcohol | coconut, walnut, oily, rancid |
| D-Carvone | Terpene | caraway seed, mint |
| Decanal | Aldehyde | bitter, orange peel, aldehydic |
| Decanoic acid | Acid | caprylic |
| D-Glyceraldehyde | Aldehyde | walnut, sherry, fruity |
| Diacetyl | Ketone | butterscotch, buttery, diacetyl, |
| | | buttermilk, rancid |
| Dibutyl sulfide | Sulfur | rubber, rotten, onion, sulfurous |
| | compound | |
| Diethoxyethane | Ketone | fruity |
| Diethyl disulfide | Sulfur | garlic, burnt rubber, H2S |
| | compound | |
| Diethyl sulfide | Sulfur | cooked vegetables (onion, garlic) |
| | compound | |
| Dimethyl disulfide | Sulfur | cooked vegetable, onion, |
| | compound | rubbery, rotten vegetables |
| Dimethyl sulfide | Sulfur | cooked vegetable (corn, onion), |
| | compound | garlic, sweet corn, tin, black |
| | | currant, sulfurous, cooked |
| | | cabbage, tinned tomato, baked |
| | | beans |
| Dimethyl trisulfide | Sulfur | onion, rotting fruit, red cabbage, |
| | compound | sulfurous, rotten vegetables, |
| | | fresh onion, cooked vegetables |
| Dimethylallyl methyl sulfide | Sulfur | garlic, rubbery, onion |
| | compound | |
| Dodecanal | Aldehyde | caprylic, aldehydic, fatty acids |
| D-Tartaric acid | Acid | acid |
| Ellagic acid | Acid | woody |
| Ethanol | Alcohol | warming, strong, alcoholic |
| Ethyl 2-methylbutanoate | Ester | fruity, apple, sweet, candy, citrus, |
| | | wine-like |
| Ethyl 2-methylpropanoate | Ester | apple, sweet, citrus, fruity, |
| | | pineapple |
| Ethyl 3-hydroxyhexanoate | Ester | fruity |
| Ethyl 3-methylbutanoate | Ester | fruity, apple, sweet, valeric, |
| | | citrus, wine-like, artificial |
| | | strawberry, candy, violet |
| Ethyl 3-phenylpropanoate | Ester | fruity, sweet |
| Ethyl 4-methylpentanoate | Ester | fruity, citrus, pineapple |
| Ethyl acetate | Ester | solvent, fruity, sweet, estery |
| Ethyl butanoate (ethyl butyrate) | Ester | papaya, butter, sweet, apple, |
| | | perfumed, fruity |
| Ethyl caprylate | Ester | apple, sweet, fruity, sour apple |
| Ethyl cinnamate | Ester | fruity, sweet |
| Ethyl decanoate | Ester | caprylic, fruity, apple |
| Ethyl formate | Ester | light estery, fruity, solvent |
| Ethyl heptanoate | Ester | fruity, perfumed, fatty |
| Ethyl caproate (ethyl hexanoate) | Ester | sour apple, aniseed, fruity, |
| | | sweet, estery, solvent, apple, |
| | | fatty acids |
| Ethyl lactate | Ester | artificial strawberry, raspberry, |
| | | perfumed, fruity, buttery |
| Ethyl laurate | Ester | caprylic, soapy, estery |
| Ethyl levulinate | Ester | estery, burnt, unpleasant, sweet |
| Ethyl linoleate | Ester | fatty acids, vegetable oil, rancid |
| Ethyl mercaptan | Sulfur | putrefaction (of leek, onion, |
| | compound | garlic, egg), rotting vegetables |
| Ethyl myristate | Ester | fatty acids, caprylic, vegetable oil |
| Ethyl nicotinate | Ester | medicinal, tincture, solvent, anis, |
| | | stale, grainy, grape, papery |
| Ethyl nonanoate | Ester | fruity, fatty acids, perfumed, |
| | | sweet |
| Ethyl oleate | Ester | fatty acids, vegetable oil, rancid |
| Ethyl palmitate | Ester | fatty acids, fruity, sweet, rancid |
| Ethyl palmitoleate | Ester | fatty, oily |
| Ethyl pentadecanoate | Ester | fatty acids |
| Ethyl pentanoate | Ester | papaya, fruity, apple, sweet, |
| | | sweaty (body odor) |
| Ethyl stearate | Ester | fatty acids |
| Ethyl thioacetate | Ester | cabbage |
| Ethyl tridecanoate | Ester | fatty acids, soapy, hot (spicy) |
| Ethyl undecanoate | Ester | fatty acids, pear, grassy |
| Eugenol | Phenol | cloves, sweet, dentist antiseptic |
| Farnesene | Terpene | fruity, herbaceous |
| Ferulic acid | Phenol | astringent |
| Formaldehyde | Aldehyde | astringent, fruity, lingering |
| Formic acid | Acid | acetic, astringent |
| Fructose | Carbohydrate | fruity, sweet |
| Fumaric acid | Acid | acid |
| Furfural | Furan | caramel, bready, cooked meat, |
| | | papery, husk |
| Furfuryl acetate | Ester | ethereal, fruity |
| Furfuryl alcohol | Furan | sugar cane, woody |
| Furfuryl ethyl ether | Furan | solvent-like, stale |
| Furylacrolein | Aldehyde | vanilla, cinnamon, bitter, perfume |
| Galactose | Carbohydrate | sweet |
| Gallic acid | Phenol | astringent |
| Geraniol | Terpene | floral, citrus, rose-like, flowery |
| Geranyl acetate | Terpene | flowery, lavender, rose-like |
| Geranyl isobutyrate | Ester | floral |
| Glucose | Carbohydrate | sweet |
| Glutamic acid | Amino acid | sour, lingering, glutamate-like |
| Glutamine | Amino acid | bitter, sweet |
| Glycerinaldehyde | Carbohydrate | walnut |
| Glycerol | Carbohydrate | mild, sweet |
| Glycine | Amino acid | bitter, sweet |
| Glyoxal | Aldehyde | burning, astringent, dishcloth |
| Glyoxylic acid | Acid | acid |
| Guaiacol | Phenol | phenolic, sweet |
| Guanosine-5′-monophosphate | N-Compound | strong glutamate-like |
| Heptanal | Aldehyde | aldehyde, vinous, bitter, very |
| | | unpleasant |
| Heptanol | Alcohol | coconut, unpleasant, ketonic |
| | | solvent |
| Hepten-3-ol | Alcohol | green leaves |
| Heptyl acetate | Ester | pear, fruity, aromatic, sweet |
| Heptyl butyrate | Ester | fruity, papaya, red currant |
| Hexanal | Aldehyde | bitter, winey, vinous, green, leafy, |
| | | aldehyde |
| Hexanol | Alcohol | coconut, green leaves, |
| | | unpleasant |
| Hexyl acetate | Ester | sweet, aromatic, perfumed |
| Histidine | Amino acid | light sweetness, bitter, astringent |
| Humuladienone | Terpene | spicy, grassy |
| Humulene | Terpene | oceanic, spicy, woody |
| Humulene epoxide | Terpene | hay, grassy |
| Hydrocinnamaldehyde | Aldehyde | cinnamon, sweet, cider |
| Hydrogen sulfide | Sulfur | eggy, rotten eggs |
| | compound | |
| Hydroxycitronellal | Terpene | astringent, flowery, aldehyde |
| Inosine | N-Compound | bitter, astringent |
| Isoamyl acetate | Ester | fruity, banana, pear, solvent, |
| | | estery, apple, sweet |
| Isoamyl caprate | Ester | fatty acids, tropical fruits |
| Isoamyl caproate | Ester | fatty acids, fruity, solvent, |
| | | perfumed, tropical fruits |
| Isoamyl caprylate | Ester | fruity, hot (spicy), orange, pear, |
| | | melon |
| Isoamyl formate | Ester | plum, solvent, unpleasant |
| Isoamyl isobutyrate | Ester | apricot, fruity, pineapple |
| Isoamyl mercaptan | Sulfur | putrefaction (of onion, garlic, |
| | compound | egg) |
| Isoamyl nonanoate | Ester | fruity (peach), coconut, sweet, |
| | | fatty acids |
| Isoamyl propionate | Ester | pineapple, aniseed |
| Isobutyl acetate | Ester | banana, sweet, fruity |
| Isobutyl formate | Ester | fruity, solvent |
| Isobutyl mercaptan | Sulfur | putrefaction (of onion, garlic, |
| | compound | egg) |
| Isoeugenol | Phenol | carnation |
| Isohumulone | Hydrocarbon | bitter |
| Isomaltol | Furan | caramel, burnt sugar |
| Isomaltose | Carbohydrate | sweet |
| Isopropyl sulphide | Sulfur | cooked vegetable (garlic, onion, |
| | compound | leek), ethereal |
| Isovaleric acid | Acid | sweat, cheese, rancid, old hops, |
| | | floral, minty, sweet |
| Lactic acid | Acid | acidic, neutral, pleasant sour |
| Lactose | Carbohydrate | sweet |
| Lauric acid | Acid | soapy, waxy, caprylic |
| Leucine | Amino acid | sour, bitter, astringent |
| Linalool | Terpene | flowery, fruity, floral, citrus, |
| | | rosewood-like, aniseed, terpenic, |
| | | rose-like, hoppy |
| Linoleic acid | Acid | faint, fatty |
| Linolenic acid | Acid | faint, fatty |
| Lysine | Amino acid | sweet, lemony |
| Magnesium carbonate | Inorganic | bitter, sweet |
| | compound | |
| Magnesium chloride | Inorganic | salty-bitter, rather neutral in |
| | compound | flavor, sweet, salty, soapy |
| Magnesium sulfate | Inorganic | sweet-sour, soapy, bitter |
| | compound | |
| Malic acid | Acid | neutral sour |
| Maltol | Pyrazine | caramel, malty, sweet, toasted, |
| | | roasted |
| Maltose | Carbohydrate | sweet |
| Maltotriose | Carbohydrate | sweet |
| m-Cresol | Phenol | phenolic |
| Mercaptan | Sulfur | drains |
| | compound | |
| Mesityl oxide | Ketone | sweet, peach, strawberry, |
| | | varnish |
| Methanethiol | Sulfur | putrefaction, drains, egg, rotting |
| | compound | vegetables, estery |
| Methanol | Alcohol | alcohol, solvent |
| Methional | Aldehyde | potato-like, cooked potatoes, |
| | | soup-like, warm, raw potato, |
| | | mashed potato |
| Methionine | Amino acid | bitter, potato-like, sulfurous |
| Methionol | Alcohol | potato-like, raw potatoes, cooked |
| | | potatoes |
| Methyl acetate | Ester | light solvent, fruity, pleasant |
| Methyl caprate | Ester | coconut, fatty acids, fruity |
| Methyl formate | Ester | ethereal, light, flowery, pleasant |
| Methyl vanillate | Phenol | vanilla, spicy, warm |
| Methylglyoxal | Aldehyde | sour milk |
| Methylpyrazine | Pyrazine | cocoa, chocolate, nutty, peanut, |
| | | roasted |
| Methylthioacetate | Sulfur | cabbage |
| | compound | |
| Myrcene | Terpene | herbs, metallic, resinous, spicy |
| Myrcene disulfide | Sulfur | fragrant, grassy |
| | compound | |
| N-[(4-hydroxy-3- | Amide | burning, pungent |
| methoxyphenyl)methyl]nonanamide | | |
| n-Amyl butyrate | Ester | cider, apple, sweets, papaya, |
| | | fatty acids |
| n-Butanol | Alcohol | alcohol |
| n-Butyl mercaptan | Sulfur | putrefaction (of onion, garlic, |
| | compound | egg) |
| n-Decanal | Aldehyde | bitter, aldehyde, orange peel |
| n-Decanol | Alcohol | coconut, walnut, oily, rancid |
| n-Dodecanol | Alcohol | fatty acids, coconut, banana |
| Nerol | Terpene | flowery (hyacinth, rose), lime, |
| | | lemon |
| Niacin | Vitamin | sour, metallic |
| n-Nonanol | Alcohol | coconut, walnut, oily |
| n-Octyl acetate | Ester | coconut, vegetable oil, aromatic |
| n-Octyl butyrate | Ester | fatty acids, coconut, tropical, |
| | | fruits |
| n-Octyl caproate | Ester | orange peel, fruity, coconut, fatty |
| | | acids |
| Nonanal | Aldehyde | bitter, astringent, cardboard, |
| | | aldehydic |
| Nonanoic acid | Acid | cheesy, waxy |
| Nootkatone | Terpene | citrus, fruity, grapefruit, sweet |
| n-Pentanol | Alcohol | alcohol, medicinal, solvent-like |
| n-Propyl acetate | Ester | solvent, sweet, perfumed |
| n-Propylmercaptan | Sulfur | putrefaction (of onion, garlic, |
| | compound | egg) |
| n-Undecan-2-ol | Alcohol | perfumed, sweet, coconut, |
| | | varnish, musty |
| n-Undecanal | Aldehyde | bitter, orange, aldehyde, vinous |
| n-Undecanol | Alcohol | fatty acids, coconut |
| N-vanillyl octanamide | Amide | spicy, warm |
| o-Cresol | Phenol | phenolic |
| Oct-2-enal | Aldehyde | green, leafy |
| Octanal | Aldehyde | aldehydic, orange peel, bitter, |
| | | vinous |
| Octanoic acid | Acid | caprylic, goaty, fatty acid, |
| | | vegetable oil, wet dog |
| Octanol | Alcohol | coconut, walnut, oily |
| Octen-3-ol | Alcohol | green leaves, perfumed, sweet |
| Octen-3-one | Ketone | mushroom, metallic, bitter |
| Octyl ester acetate | Ester | fruity, jasmine, neroli |
| Oleic acid | Acid | faint, fatty |
| Oxalacetic acid | Acid | acid, salty, oxidized, lemon-like, |
| | | sour, numbing |
| Oxalic acid | Acid | caramel, mild |
| Pantothenic acid | Vitamin | astringent, salty |
| p-Coumaric acid | Phenol | astringent, phenolic |
| p-Cresol | Phenol | phenolic |
| Pentanal | Aldehyde | grassy, banana, aldehyde |
| Pentanedione | Ketone | moldy, wood-like |
| Penten-3-ol | Alcohol | pungent, alcoholic, solvent |
| Penten-3-one | Ketone | green, vegetable, fruity |
| Phenol | Phenol | hospital, disinfectant-like |
| Phenylacetic acid | Acid | honey, sweet-like, flowery |
| | | (roses) |
| Phenylalanine | Amino acid | sweet-sour, bitter, astringent |
| Phenylethanol | Alcohol | flowery, rose-like |
| Phenylpyruvic acid | Acid | phenolic, sour, grainy |
| p-Hydroxybenzoic acid | Phenol | acrid, sweet |
| p-Methane-8-thiol-3-one | Ketone | Ribes, cat piss, black currants |
| Potassium chloride | Inorganic | sour-bitter, salty as NaCl, bitter, |
| | compound | soapy, astringent |
| Proline | Amino acid | pleasant sweetness |
| Propanal | Aldehyde | green grass, fruity |
| Propanoic acid | Acid | acetic acid, vinegar, milky |
| Propanol | Alcohol | alcoholic, solvent-like |
| Pyrazine | Pyrazine | corn, hazelnut, roasted, sweet |
| Pyridoxine | Vitamin | sour, metallic |
| Pyroglutamic acid | Amino acid | soapy, astringent, less intense |
| | | sour than other org. Acids |
| Pyruvic acid | Acid | peas, freshly cut grass, acid, |
| | | salty, forage, oil paint |
| Quercitrin | Phenol | astringent, bitter |
| Riboflavin | Vitamin | bitter, astringent |
| Salicylaldehyde | Aldehyde | bitter, spicy, phenolic |
| Serine | Amino acid | astringent, sweet-bitter |
| S-Methyl-2-methylthiobutanoate | Sulfur | truffle |
| | compound | |
| S-Methyl-2-methylthiopropionate | Sulfur | cheesy, estery, cooked |
| | compound | vegetable |
| S-Methyl-3-methylthiobutanoate | Sulfur | cheesy, hop, cooked vegetable |
| | compound | |
| S-Methylthiohexanoate | Sulfur | cooked vegetable, sulfurous, |
| | compound | soapy |
| S-Methylthiomethyl-2- | Sulfur | onion, garlic, astringent |
| methylbutanethiolate | compound | |
| Sodium carbonate | Inorganic | sweet, soapy |
| | compound | |
| Sodium chloride | Inorganic | salty, sweet in low concentrations |
| | compound | |
| Sodium sulfate | Inorganic | bitter, soapy, salty |
| | compound | |
| Stearic acid | Acid | fatty, waxy |
| Succinic acid | Acid | bitter |
| Succinic acid diethyl ester | Ester | faint, fruity, tropical |
| Sucrose | Carbohydrate | sweet |
| Sulfur dioxide | Inorganic | sulfurous, burnt match, struck |
| | compound | match |
| Syringaldehyde | Aldehyde | soft, sweet |
| Tartaric acid | Acid | acid, salty |
| tert-Amyl mercaptan | Sulfur | putrefaction (of fruit (guava, |
| | compound | peach), fish), sunstruck, cat urine |
| tert-Butanol | Alcohol | alcohol |
| tert-Butyl acetate | Ester | paint thinner, medicinal, menthol |
| tert-Butyl mercaptan | Sulfur | putrefaction (of onion, garlic, |
| | compound | egg) |
| Thiamine | Vitamin | glutamate-like, sour |
| Thiazole | Sulfur | sulfurous, grainy, carbon dioxide |
| | compound | |
| Threonine | Amino acid | sweet-bitter, astringent |
| Thymol | Terpene | thyme, spicy |
| trans,cis-2,4-Hexadienal | Aldehyde | cinnamon, sweet, green leaves, |
| | | bitter |
| trans,cis-2,6-Nonadienal | Aldehyde | green, cucumber, green leaves |
| trans,trans-2,4-Decadienal | Aldehyde | oily, rancid, aldehyde, deep-fried, |
| | | papery |
| trans,trans-2,4-Hexadienal | Aldehyde | cinnamon |
| trans,trans-2,4-Nonadienal | Aldehyde | oily, rancid, aldehyde, paper, |
| | | cardboard |
| trans-2-Decenal | Aldehyde | rancid, cardboard, bitter, stale |
| trans-2-Heptenal | Aldehyde | fatty, green, oily |
| trans-2-Hexen-1-ol | Alcohol | bitter, green, leaves |
| trans-2-Hexenal | Aldehyde | bitter, astringent, green leaves |
| trans-2-Nonenal | Aldehyde | papery, cardboard, oxidized, |
| | | stale, fresh linen, fatty, tallowy, |
| | | cucumber, waxy |
| trans-2-Nonenoic acid | Acid | harsh, astringent, papery |
| trans-2-Octenal | Aldehyde | bitter, cardboard, aldehyde, stale |
| Trichloroanisole | Phenol | moldy |
| Trimethylpyrazine | Pyrazine | earthy, nutty |
| Tryptophan | Amino acid | bitter, methanol-like, sweet-sour |
| Tryptophol | Alcohol | almonds, solvent, unpleasant |
| Tyrosine | Amino acid | sweet-bitter, glutamate, salty |
| Tyrosol | Alcohol | bitter, chemical, sour aftertaste, |
| | | old fruit, pepper, unpleasant |
| Valencene | Terpene | citrus, grapefruit, orange, sweet, |
| | | woody |
| Valeric acid | Acid | acidic, putrid, rancid, sweaty |
| Valine | Amino acid | sweet-bitter, astringent |
| Vanillic acid | Phenol | vanilla, sweet, astringent |
| Vanillin | Aldehyde | vanilla, sweet, soft, warm |
| Vanillin acetate | Ester | creamy, sweet, vanilla |
| Vanillyl alcohol | Phenol | creamy, milky, sweet |
| Xylose | Carbohydrate | sweet |
| α-Ionone | Terpene | artificial raspberry, cedarwood |
| α-Terpineol | Terpene | pine, terpenoid, lilac-like, conifer- |
| | | like |
| β-Caryophyllene | Terpene | woody, spicy, flower, turpentine, |
| | | clove |
| β-Damascenone | Ketone | stewed apple, honey-like, |
| | | rhubarb, strawberry, red fruit, |
| | | cooked fruit, kettle hop aroma, |
| | | peach, fruity, tobacco, coconut |
| β-Eudesmol | Terpene | spicy |
| β-Farnesene | Terpene | citrus, herbal, woody |
| β-Ionone | Terpene | raspberry, citrus, woodlands, |
| | | violet, kettle hop aroma, artificial |
| | | raspberry, strawberry, floral, |
| | | berry |
| β-Phenylacetaldehyde | Aldehyde | violets |
| γ-Aminobutyric acid | Amino acid | sweet-bitter, sour, glutamate-like |
| γ-Butyrolactone | Lactone | fruity, sour |
| γ-Decalactone | Lactone | apricot, peach |
| γ-Hexalactone | Lactone | peach, fruity |
| γ-Nonalactone | Lactone | coconut, vanilla, glue, rancid, |
| | | peach, fruity |
| γ-Octalactone | Lactone | coconut-like |
| γ-Pentalactone | Lactone | fruity, sweet |
| δ-Decalactone | Lactone | peach, apricot, dull |

In a further embodiment, the flavored solution comprises a further flavor compound or a combination of further flavor compounds. In yet another embodiment, the flavored solution comprises at least 1, 2, 3, 4, 5, 6, 7, 8, 9, or at least distinct 10 flavor compounds.

In an embodiment, the one or more flavor compounds can be used to generate a flavor (or aroma), such as, for example sweet, caramel, vanilla, toffee, butterscotch, cereal, malty, bready, creamy, honey, fruity, red fruits, green fruits, citrus (orange, lemon, lime, grapefruit), banana, pear, peach, apple, strawberry, raspberry, cherry, tropical (pineapple, mango, guava, apricot), berry (blackberry, blueberry, cranberry, elderberry, gooseberry, juniper, gooseberry) currant (blackcurrant, redcurrant, whitecurrant), coconut, nutty (almond, pine nut, walnut, peanut), waxy, fatty, buttery, soapy, perfume, floral (rose, lavender, geranium, hyacinth), herbal, earthy, woodland, petrichor, peaty, phenolic, smoky, tobacco, clove, medicinal, anise, cinnamon, spicy, grassy, green, leafy, mushroom, garlic, coffee, leather, roasted, and cocoa, meaty, rubbery, bacon, vegetal, and peppery.

It is contemplated that the flavored solution is in contact with the porous material under conditions for allowing the at least first flavor compound to associate with the porous material and generate the flavored porous material. Such conditions can include, without limitation, contacting the flavored solution comprising at least one flavor compound with the porous material for a (first) period of time. Alternatively, or in combination, such conditions can include contacting the flavored solution with the at least one flavor compound with the porous material at a certain temperature or within a certain temperature range. It is understood that the period of time/temperature necessary to generate the flavored porous material may depend on the flavor compound and also of the porous material selected. The skilled person of the art would be able to determine what period of time/temperature is necessary to obtain the desired level of absorption of the at least one flavor in the selected porous material. In one embodiment, the period of time for contacting the flavored solution with the porous material and allowing the at least first flavor compound to generate the flavored porous material is at least one day, one week, two weeks, three weeks, one month, or one year. In a more specific embodiment, the the period of time for contacting the flavored solution with the porous material is between one day to a year, between one day to six months, between one day to a month, between one day to seven days, between a week and a year, between a week and 6 months, between a week and four weeks, between a month and 6 months, or a month and 3 months.

In the context of the present disclosure, the flavored solution and the porous material are in contact for a period of time allowing the at least first flavor compound to generate the flavored porous material at room temperature. It is understood by the person skilled in the art that the temperature could vary depending on the at least first flavor compound, the porous material, and/or the location where the method is performed. In one embodiment, the flavored solution and the porous material are in contact at a temperature above −20° C., above 0° C., above 5° C., above 10° C., above 15° C., above 20° C., above 25° C., above 30° C., above 35° C., above 40° C., above 45° C., above 50° C., above 55° C., above 60° C., above 65° C., above 70° C. or above 75° C. In another embodiment, the flavored solution and the porous material are in contact at a temperature below 76° C., below 75° C., below 70° C., below 65° C., below 60° C., below 55° C., below 50° C., below 45° C., below 40° C., below 35° C., below 30° C., below 25° C., below 20° C., below 15° C., below 10° C. or below 6° C. In still another embodiment, the flavored solution and the porous material are in contact at a temperature between about 0° C. and about 76° C., between about 0° C. and about 40° C., between about 0° C. and about 35° C., between about 0° C. and about 30° C., between about 0° C. and about 25° C., between about 5° C. and about 76° C., between about 5° C. and about 75° C., between about 5° C. and about 70° C., between about 5° C. and about 65° C., between about 5° C. and about 60° C., between about 5° C. and about 55° C., between about 5° C. and about 50° C., between about 5° C. and about 45° C., between about 10° C. and about 40° C., between about 5° C. and about 35° C., between about 5° C. and about 25° C., between about 5° C. and about 20° C., between about 5° C. and about 15° C., or between about 5° C. and about 10° C. In still another embodiment, the flavored solution and the porous material are in contact at a temperature between about 10° C. and about 76° C., between about 10° C. and about 75° C., between about 10° C. and about 70° C., between about 10° C. and about 65° C., between about 10° C. and about 60° C., between about 10° C. and about 55° C., between about 10° C. and about 50° C., between about 10° C. and about 45° C., between about 10° C. and about 40° C., between about 10° C. and about 35° C., between about 10° C. and about 25° C., between about 10° C. and about 20° C., or between about 10° C. and about 15° C. In still another embodiment, the flavored solution and the porous material are in contact at a temperature between about 15° C. and about 76° C., between about 15° C. and about 75° C., between about 15° C. and about 70° C., between about 15° C. and about 65° C., between about 15° C. and about 60° C., between about 15° C. and about 55° C., between about 15° C. and about 50° C., between about 15° C. and about 45° C., between about 15° C. and about 40° C., between about 15° C. and about 35° C., between about 15° C. and about 25° C., or between about 15° C. and about 20° C. In still another embodiment, the flavored solution and the porous material are in contact at a temperature between about 20° C. and about 76° C., between about 20° C. and about 75° C., between about 20° C. and about 70° C., between about 20° C. and about 65° C., between about 20° C. and about 60° C., between about 20° C. and about 55° C., between about 20° C. and about 50° C., between about 20° C. and about 45° C., between about 20° C. and about 40° C., between about 20° C. and about 35° C., or between about 20° C. and about 25° C. In still another embodiment, the flavored solution and the porous material are in contact at a temperature between about 25° C. and about 76° C., between about 25° C. and about 75° C., between about 25° C. and about 70° C., between about 25° C. and about 65° C., between about 25° C. and about 60° C., between about 25° C. and about 55° C., between about 25° C. and about 50° C., between about 25° C. and about 45° C., between about 25° C. and about 40° C., between about 25° C. and about 35° C. In still another embodiment, the flavored solution and the porous material are in contact at a temperature between about 30° C. and about 76° C., between about 30° C. and about 75° C., between about 30° C. and about 70° C., between about 30° C. and about 65° C., between about 30° C. and about 60° C., between about 30° C. and about 55° C., between about 30° C. and about 50° C., between about 30° C. and about 45° C., between about 30° C. and about 40° C., or between about 30° C. and about 35° C. In still another embodiment, the flavored solution and the porous material are in contact at a temperature between about 35° C. and about 76° C., between about 35° C. and about 75° C., between about 35° C. and about 70° C., between about 35° C. and about 65° C., between about 35° C. and about 60° C., between about 35° C. and about 55° C., between about 35° C. and about 50° C., between about 35° C. and about 45° C., or between about 35° C. and about 40° C. In still another embodiment, the flavored solution and the porous material are in contact at a temperature between about 40° C. and about 76° C., between about 40° C. and about 75° C., between about 40° C. and about 70° C., between about 40° C. and about 65° C., between about 40° C. and about 60° C., between about 40° C. and about 55° C., between about 40° C. and about 50° C., or between about 40° C. and about 45° C. In still another embodiment, the flavored solution and the porous material are in contact at a temperature between about 45° C. and about 76° C., between about 45° C. and about 75° C., between about 45° C. and about 70° C., between about 45° C. and about 65° C., between about 45° C. and about 60° C., between about 45° C. and about 55° C., or between about 45° C. and about 50° C. In still another embodiment, the flavored solution and the porous material are in contact at a temperature between about 50° C. and about 76° C., between about 50° C. and about 75° C., between about 50° C. and about 70° C., between about 50° C. and about 65° C., between about 50° C. and about 60° C., or between about 50° C. and about 55° C. In still another embodiment, the flavored solution and the porous material are in contact at a temperature between about 55° C. and about 76° C., between about 55° C. and about 75° C., between about 55° C. and about 70° C., between about 55° C. and about 65° C., or between about 55° C. and about 60° C. In still another embodiment, the flavored solution and the porous material are in contact at a temperature between about 60° C. and about 76° C., between about 60° C. and about 75° C., between about 60° C. and about 70° C., or between about 60° C. and about 65° C. In still another embodiment, the flavored solution and the porous material are in contact at a temperature between about 65° C. and about 76° C., between about 65° C. and about 75° C., or between about 65° C. and about 70° C. In still another embodiment, the flavored solution and the porous material are in contact at a temperature between about 70° C. and about 76° C., or between about 70° C. and about 75° C. In still another embodiment, the flavored solution and the porous material are in contact at a temperature between about 75° C. and about 76° C. In a particular embodiment, the flavored solution and the porous material are in contact about 20° C. In another embodiment, the flavored solution and the porous material are in contact at a temperature higher than room temperature, for example, between about 60° C. and about 76° C.

In some embodiments, the flavored solution can be used to generate a plurality of flavored porous materials. For example, a first flavored solution can be contacted with a first porous material to generate a first flavored porous material. After the first flavored porous material is generated, the flavored solution is dissociated from the first flavored porous material to generate an isolated flavored solution. The isolated flavored solution can then be contacted with another porous material to generate a second flavored porous material. It is understood that the concentration of the at least one flavor compound in the first flavored solution is lower than the concentration of the at least one flavor compound in the isolated flavored solution and as such, the conditions for generating the second flavored porous material may be different than the conditions for generating the first flavored porous material.

The method of the present disclosure also comprises flavoring a beverage to obtain a flavored beverage by contacting the isolated flavored porous material with a first untreated beverage to release the at least one flavor compound to obtain a first flavored beverage. The term “flavoring” meaning adding a flavor to improve or change the taste of a beverage. It is understood by the person skilled in the art that the term “flavoring” comprises maturing or aging a beverage to obtain the desired organoleptic properties. The method can also include separating the flavored beverage from the isolated flavored porous material to obtain a separated flavored porous material and a separated flavored beverage.

As used herein, a “beverage” refers to a potable liquid for human consumption. In an embodiment, the beverage is an alcoholic beverage. In some embodiment, the alcoholic beverage has between 1 to 99% ABV, between 1 to 80% ABV, between 5 to 99% ABV, between 5 to 80% ABV, between 5 to 80% ABV, between 5 to 40% ABV, between 20 to 80% ABV, between 30 to 80% ABV, or between 35 to 80% ABV. Examples of alcoholic beverage products include, but are not limited to beer, brandy, cachaça, Cognac, mezcal, whisky, whiskey (for example bourbon, rye whiskey, wheat whiskey), gin, tequila, rum (for example rhum agricole), wine, mead, sake, baiju, shochu, soju, cider, perry, arrack, jenever, vermouth, Armangnac, kom, raki, pulque, basi, vodka, poitin, akvavit, aquavit, absinthe, spirits, new-make spirit, white dog, or moonshine. The term “flavored beverage” refers to the beverage that has been flavored by the method described in the present application. Examples of flavored alcoholic beverage products include, but are not limited to flavored beer, flavored brandy, flavored cachaça, flavored Cognac, flavored mezcal, flavored whisky, flavored whiskey, flavored bourbon, flavored rye whiskey, flavored wheat whiskey, flavored gin, flavored tequila, flavored rum, flavored rhum agricole, flavored baiju, flavored shochu, flavored soju, flavored arrack, flavored jenever, flavored vermouth, flavored Armangnac, flavored kom, flavored raki, flavored vodka, flavored poitin, flavored akvavit, flavored aquavit, flavored absinthe, flavored spirits, flavored new-make spirit, flavored white dog, or flavored moonshine. In a particular embodiment, the beverage is whisky or whiskey. In one embodiment the method of the present invention is flavoring the beverage during the maturation (or aging) process of said beverage. In one embodiment the beverage is an unmatured distilled spirit and the flavored beverage is a matured distilled spirit. In another embodiment, the method of the present invention is flavoring the beverage before, during, or after the maturation (or aging) process of said beverage. In such embodiment, the beverage and the flavored beverage are both unmatured distilled spirit or both matured distilled spirits or one or both of the beverage and the flavored beverage reaches maturation during the claimed process. In a more particular embodiment, the unmatured distilled spirit is a sugar cane spirit, a grain spirit, a fruit spirit, a vegetable spirit, or an agave spirit. The flavor compound could be a typical flavor which is commonly found in a specific beverage or an non-typical (or atypical) flavor usually not found in said beverage. Typical flavors in beverage are those derived from the raw material used a fermentable substrate (cereal, sugar, plant), from yeast metabolism products or resulting from the maturation step. Atypical flavors would not be derived from these materials using standard procedures described in the art. For example, vanilla, pear, toffee, sweet, caramel, vanilla, toffee, butterscotch, cereal, malty, bready, creamy, honey, fruity, red fruits, green fruits, citrus, banana, phenolic, medicinal and smoky are typical flavors for whiskey while raspberry, chilli (spicy), bacon, grapefruit, and garlic flavor are atypical for this type of beverage.

It is understood that the isolated flavored porous material and the first untreated beverage are in contact for a second period of time to release the at least one flavor compound to obtain a first flavored beverage. It is understood that the second period of time necessary to release the at least one flavor compound may depend on the flavor compound, the concentration of the flavor compound, the porous material selected, and the beverage. The skilled person of the art would be able to determine what period of time is necessary to obtain the desired level sensory profile for the selected beverage. In one embodiment, the second period of time for contacting the isolated flavored porous material and the first untreated beverage is at least one day, one week, two weeks, three weeks, one month, three months, four months, one year, two years, three years, 10 years, 20 years, or 50 years. In a more specific embodiment, the period of time for contacting the flavored solution with the porous material is between one day to a year, between one day to 50 years, between one day to 40 years, between one day to 35 years, between one day to 30 years, between one day to 20 years, between one day to 10 years, between one day to 5 years, between one day to 3 years, between one day to two years, between one day to one year, between one day to 6 months, between one day to one month, between a week and a year, between a week and 6 months, between a week and four weeks, between a month and 6 months, or a month and 3 months.

In the context of the present disclosure, the isolated flavored porous material and the first untreated beverage are in contact at room temperature. It is understood by the person skilled in the art that the temperature could vary depending on the at least first flavor compound, the porous material, the beverage, and/or the location where the method is performed. In one embodiment, the isolated flavored porous material and the first untreated beverage are in contact are in contact at a temperature above −20° C., above 0° C., above 5° C., above 10° C., above 15° C., above 20° C., above 25° C., above 30° C., above 35° C., above 40° C., above 45° C., above 50° C., above 55° C., above 60° C., above 65° C., above 70° C. or above 75° C. In another embodiment, the flavored solution and the porous material are in contact at a temperature below 76° C., below 75° C., below 70° C., below 65° C., below 60° C., below 55° C., below 50° C., below 45° C., below 40° C., below 35° C., below 30° C., below 25° C., below 20° C., below 15° C., below 10° C. or below 6° C. In still another embodiment, the flavored solution and the porous material are in contact at a temperature between about 0° C. and about 76° C., between about 0° C. and about 40° C., between about 0° C. and about 35° C., between about 0° C. and about 30° C., between about 0° C. and about 25° C., between about 5° C. and about 76° C., between about 5° C. and about 75° C., between about 5° C. and about 70° C., between about 5° C. and about 65° C., between about 5° C. and about 60° C., between about 5° C. and about 55° C., between about 5° C. and about 50° C., between about 5° C. and about 45° C., between about 10° C. and about 40° C., between about 5° C. and about 35° C., between about 5° C. and about 25° C., between about 5° C. and about 20° C., between about 5° C. and about 15° C., or between about 5° C. and about 10° C.. In a particular embodiment, the flavored solution and the porous material are in contact about 20° C. In another embodiment, the isolated flavored porous material and the first untreated beverage are in contact at a temperature higher than room temperature, for example between about 60° C. and about 76° C.

In some embodiments, the flavored porous material can be used to generate a plurality of flavored beverages. For example, a first flavored porous material can be contacted with a first beverage to generate a first flavored beverage. After the first flavored beverage is generated, the flavored porous material is dissociated from the first flavored beverage to generate an isolated flavored porous material. The isolated flavored porous material can then be contacted with another beverage to generate a second flavored beverage. It is understood that the amount of the at least one flavor compound in the first flavored porous material is lower than the amount of the at least one flavor compound in the isolated flavored porous material and as such, the conditions for generating the second flavored beverage may be different than the conditions for generating the first flavored beverage.

In some embodiments, the flavored porous material is a cask. In some embodiments, the cask is a wooden cask. In further embodiments, the wooden cask may be a barrel, a hogshead, a butt, a quarter cask, a barrique, a puncheon, a port pipe, vats, or a madeira drum as those terms are commonly understood in the alcoholic beverage industry. In a preferred embodiment, the flavored porous material is an American Standard Barrel. In other embodiments, the wooden cask is less than or equal in volume to 700 liters, the wooden cask is less than or equal in volume to 650 liters, the wooden cask is less than or equal in volume to 500 liters, the wooden cask is less than or equal in volume to 300 liters, the wooden cask is less than or equal in volume to 200 liters, the wooden cask is less than or equal in volume to 100 liters. In another embodiment, the wooden cask is between 50 liters and 650 liters in volume or the wooden cask is between 200 liters and 300 liters in volume.

The method of the present disclosure optionally comprises fermenting a biomass with a recombinant microbial host cell comprising at least one genetic modification to produce the at least one flavor compound to obtain a first fermentation product or a product derived from such first fermentation product. Examples of recombinant microbial host cell bearing “heterologous flavor expression background” and allowing the heterologous expression of flavor compounds by the host cell are described in WO2019171230A1 (incorporated herewith in its entirety). In one embodiment, the flavored solution is derived from the first fermentation product. In another embodiment, the flavored solution is or comprises a distillate of the first fermentation product.

In some embodiments of the present disclosure, the production of the at least one flavor compound in the first fermentation product occurs during the conversion of a substrate, such as a carbohydrate substrate, into biomass (e.g., the fermentation) during a first fermentation.

During the first fermentation, at least a portion of a carbohydrate substrate is utilized/converted by the recombinant microbial host cell to make both the at least one flavor compound (e.g., to at least a minimal level) and ethanol (to at least a minimal level). The present disclosure provides for a recombinant microbial host cell capable of producing the at least one flavor compound in a fermentation medium, so as to accumulate a minimal and/or maximal concentration of the flavor compound in the fermentation medium once the carbohydrates have been converted (e.g., after the conversion of the carbohydrates). As used herein, the “conversion of the carbohydrates” or the “carbohydrates have been converted” is achieved when at least 50%, at least 60%, at least 70%, at least 80%, at least 90%, at least 95%, at least 99%, or at least 99.9% of the carbohydrate substrate is utilized by the microbial biomass. The “conversion of carbohydrates” or “carbohydrates have been converted” can also be achieved when a certain level of ethanol is produced in the fermentation medium, for example when at least 1%, 2%, 3%, 4%, 5%, 6%, 7%, 8%, 9%, 10%, 12%, 14%, 16%, 18%, 20%, 25%, 30%, 35%, 40% v/w or more of ethanol is produced in the fermentation medium. In some embodiments, the “conversion of carbohydrates” or “carbohydrates have been converted” is achieved when a certain level of carbohydrates remains in the fermentation medium, for example when at most 15, 14, 13, 12, 11, 10, 9, 8, 7, 6, 5, 4, 3, 2 or 1 g/L of carbohydrates remain in the fermentation medium.

In the context of the present disclosure, the production of the at least one flavor compound and ethanol usually occurs during the fermentation and, in an embodiment, simultaneously during the fermentation. In an embodiment, the substrate of the fermentation medium or mixture include fermentable materials which contain C6 sugar as for example fructose, glucose, galactose, sucrose, maltose or starch, as well as their degradation products. As an example, the fermentable material can comprise be a fruit (apple, grape, pears, plums, cherries, peaches), a plant (sugar cane, agave, cassava, ginger), a sugar material (honey, molasses), a starchy material (rice, rye, corn, sorghum, millet, barley, wheat, potatoes) or a derived product (grape must, apple mash, malted grain (or cereal), crushed fruit, fruit puree, fruit juice, fruit must, plant mash, gelatinized and saccharified starch from different plant origins as rice, corn, sorghum, wheat, barley). In another embodiment, the substrate of the fermentation medium or mixture can be or comprise a starchy material. In the context of the present disclosure, a “starchy material” refers to a material that contains starch that could be converted into alcohol by a yeast during alcoholic fermentation. Starchy material could be for example, gelatinized and saccharified starch from cereals, grains (wheat, barley, rice, buckwheat) or grain derived-products (malted grain or a wort) or vegetable (potatoes, beets). In yet another embodiment, the fermentation medium can be or comprise, but is not limited to, barley, wheat, rye, oats, corn, maize, buckwheat, millet, rice, sorghum, including variants of these cereals that have been subject to the malting, cooking (torrefication) or micronization process, or a combination thereof. In one embodiment, the malted grain (or cereal) are malted barley, malted wheat, malted rye, malted oats, malted corn, malted buckwheat, malted millet, malted rice, and malted sorghum. In another embodiment, the torrefied grain (or cereal) are torrefied barley, torrefied wheat, torrefied rye, torrefied oatas, torrefied corn, torrefied buckwheat, torrefied millet, torrefied rice and torrefied sorghum. In yet another embodiment, the micronized grain (or cereal) are micronized barley, micronized wheat, micronized rye, micronized oatas, micronized corn, micronized buckwheat, micronized millet, micronized rice and micronized sorghum.

The propagated biomass comprising the recombinant microbial host cell can be used in a fermenting step (usually under anaerobic conditions) to allow the production of the desired metabolites (e.g., the at least one flavor compound and ethanol). The recombinant microbial host cells can advantageously be easily measured, dosed and formulated for ease of use in downstream operations.

### Recombinant Microbial Host Cells

The recombinant microbial host cells of the present disclosure are intended to be used for making the first fermentation product. In preferred embodiments, the recombinant microbial host cells of the present disclosure are used in a fermentation process (such as, for example, an anaerobic fermentation process). The fermentation process can be followed by a distillation process to make the flavored solution derived from the first fermentation product.

The recombinant microbial host cells of the present disclosure can be provided in an active form (e.g., liquid (such as, for example, a cream), compressed, or fluid-bed dried), in a semi-active form (e.g., liquid, compressed, or fluid-bed dried), in an inactive form (e.g., drum- or spray-dried) as well as a mixture thereof. In an embodiment, the recombinant microbial host cells are provided in an active and dried form.

The present disclosure concerns recombinant microbial host cells that have been genetically engineered. The genetic modification(s) is(are) aimed at increasing the expression of a specific targeted gene (which is considered heterologous to the yeast host cell) and can be made in one or multiple (e.g., 1, 2, 3, 4, 5, 6, 7, 8 or more) genetic locations. The genetic modification(s) is(are) also aimed at decreasing or removing the expression of a specific targeted gene (which is considered native to the yeast host cell) and can be made in one or multiple (e.g., 1, 2, 3, 4, 5, 6, 7, 8 or more) genetic locations. In the context of the present disclosure, when recombinant microbial cell is qualified as being “genetically engineered”, it is understood to mean that it has been manipulated to add at least one or more heterologous or exogenous nucleic acid residue. In some embodiments, the one or more nucleic acid residues that are added can be derived from a heterologous cell or the recombinant microbial host cell itself. In the latter scenario, the nucleic acid residue(s) is (are) added at one or more genomic location which is different than the native genomic location. The genetic manipulations did not occur in nature and are the results of in vitro manipulations of the microbial. The genetic modification(s) in the recombinant microbial host cell of the present disclosure comprise, consist essentially of or consist of a genetic modification allowing the expression of a heterologous nucleic acid molecule encoding for one or more heterologous polypeptide for the production of a flavor compound. In the context of the present disclosure, the expression “a genetic modification allowing the expression of a heterologous nucleic acid molecule encoding for one or more heterologous polypeptide for the production of a flavor compound” refers to the fact that the recombinant microbial host cell can include other genetic modifications which are unrelated to the anabolism or the catabolism of the flavor compound or ethanol.

When expressed in a recombinant microbial host cell, the heterologous polypeptides described herein can be encoded on one or more heterologous nucleic acid molecule. The term “heterologous” when used in reference to a nucleic acid molecule (such as a promoter, a terminator or a coding sequence) or a protein/polypeptide refers to a nucleic acid molecule or a protein/polypeptide that is not natively found in the recombinant microbial cell. “Heterologous” also includes a native coding region/promoter/terminator, or portion thereof, that was removed from the source organism and subsequently reintroduced into the source organism in a form that is different from the corresponding native gene, e.g., not in its natural location in the organism's genome. The heterologous nucleic acid molecule is purposively introduced into the recombinant microbial host cell. For example, a heterologous element could be derived from a different strain of host cell, or from an organism of a different taxonomic group (e.g., different kingdom, phylum, class, order, family genus, or species, or any subgroup within one of these classifications). As used herein, the term “native” when used in inference to a gene, polypeptide, enzymatic activity, or pathway refers to an unmodified gene, polypeptide, enzymatic activity, or pathway originally found in the recombinant host cell. In some embodiments, heterologous polypeptides derived from a different strain of host cell, or from an organism of a different taxonomic group (e.g., different kingdom, phylum, class, order, family genus, or species, or any subgroup within one of these classifications) can be used in the context of the present disclosure.

The heterologous nucleic acid molecule present in the recombinant host cell can be integrated in the recombinant microbial host cell's genome. The term “integrated” as used herein refers to genetic elements that are placed, through molecular biology techniques, into the genome of a host cell. For example, genetic elements can be placed into the chromosomes of the host cell as opposed to in a vector such as a plasmid carried by the host cell. Methods for integrating genetic elements into the genome of a recombinant microbial host cell are well known in the art and include homologous recombination. The heterologous nucleic acid molecule can be present in one or more copies (e.g., 2, 3, 4, 5, 6, 7, 8 or even more copies) in the recombinant microbial host cell's genome. Alternatively, the heterologous nucleic acid molecule can be independently replicating from the recombinant microbial host cell's genome. In such embodiment, the nucleic acid molecule can be stable and self-replicating.

In an embodiment of the present disclosure, the recombinant microbial host cell is a yeast, a bacteria, or a fungi. In a particular embodiment, the recombinant microbial host cell is a yeast. Suitable recombinant yeast host cells can be, for example, from the genus Saccharomyces, Kluyveromyces, Arxula, Debaryomyces, Candida, Pichia, Phafia, Schizosaccharomyces, Hansenula, Kloeckera, Schwanniomyces, Torula, Hanseniaspora, Lachancea, Wickerhamomyces or Yarrowia. Suitable yeast species can include, for example, S. cerevisiae, S. bulderi, S. bamefti, S. exiguus, S. uvarum, S. diastaticus, C. utilis, K. lactis, K. marxianus K. fiagilis, Hanseniaspora vineae, Lachancea femrentati, Lachancea themfotolerans, Schizosaccharomyces japonicus and/or Wickerhamomyces anomalus. In some embodiments, the yeast is selected from the group consisting of Saccharomyces cerevisiae, Schizzosaccharomyces pombe, Candida albicans, Pichia pastos, Pichia stipitis, Yarrowia lipolytica, Hansenula polymorpha, Phafia rhodozyma, Candida utilis, Arxula adeninivorans, Debaryomyces hansenii, Debaryomyces polymorphus, Schizosaccharomyces pombe and Schwanniomyces occidentalis. In one particular embodiment, the yeast is Saccharomyces cerevisiae. In some embodiment, the host cell can be an oleaginous yeast cell. For example, the oleaginous yeast host cell can be from the genus Blakeslea, Candida, Cryptococcus, Cunninghamella, Lipomyces, Mortierella, Mucor, Phycomyces, Pythium, Rhodosporidum, Rhodoforula, Trichosporon or Yarrowia. In some alternative embodiment, the host cell can be an oleaginous microalgae host cell (e.g., for example, from the genus Thraustochytrium or Schizochytrium). In an embodiment, the recombinant yeast host cell is from the genus Saccharomyces and, in some embodiments, from the species Saccharomyces cerevisiae. In another embodiment, the recombinant microbial host cell is a bacteria. The recombinant bacterial host cell can be any bacterial cell which has the intrinsic ability to ferment a biomass into ethanol or that can be genetically engineered to have the ability to ferment a biomass into ethanol. In an embodiment, the recombinant bacterial host cell can be a Gram-negative bacterial cell. For example, the recombinant bacterial host cell can be from the genus Escherichia (such as for example, from the species Escherichia coli) or from the genus Zymomonas (such as, for example, from the species Zymomonas mobilis). In another embodiment, the recombinant bacterial host cell can be a Gram-positive bacterial cell. In yet another embodiment, the recombinant bacterial host cell can be a lactic acid bacteria or LAB. LAB are a group of Gram-positive bacteria, non-respiring non-spore-forming, cocci or rods, which produce lactic acid as the major end product of the fermentation of carbohydrates. Bacterial genus of LAB include, but are not limited to, Lactobacillus, Leuconostoc, Pediococcus, Lactococcus, Streptococcus, Aerococcus, Camobactenum, Enterococcus, Oenococcus, Sporolactobadllus, Tetragenococcus, Vagococcus, and Weissella. Bacterial species of LAB include, but are not limited to, Lactococcus lactis, Lactococcus garviae, Lactococcus raffinolactis, Lactococcus plantarum, Oenococcus oeni, Pediococcus pentosaceus, Pediococcus acidilactici, Camococcus allantoicus, Camobacterium gallinarum, Vagococcus fessus, Streptococcus thermophilus, Enterococcus phoeniculicola, Enterococcus plantarum, Enterococcus rafinosus, Enterococcus avium, Enterococcus pallens Enterococcus hermanniensis, Enterococcus faecalis, and Enterococcus faecium. In an embodiment, the LAB is a Lactobacillus sp. and, include, without limitation the following genera Lactobacillus delbrueckii group, Paralactobacillus, Holzapfelia, Amylolactobacillus, Bombilactobacillus, Companilactobadllus, Lapidilactobacillus, Agilactobacillus, Schleierilactobacillus, Loigolactobacillus, Lacticaseibacillus, Latilactobacillus, Dellaglioa, Liquorilactobacillus, Ligilactobacillus, Lactiplantibacillus, Furfurilactobacillus, Paucilactobacillus, Limosilactobacillus, Fructilactobacillus, Acetilactobacillus, Apilactobacillus, Levilactobacillus, Secundilactobacillus and Lentilactobacillus. In some additional embodiments, the Lactobacillus species is L. acetotolerans, L. acidifarinae, L. acidipiscis, L. acidophilus, L. agilis, L. algidus, L. alimentarius, L. amylolyticus, L. amylophilus, L. amylorophicus, L. amylovorus, L. animalis, L. antri, L. apodemi, L. aviarius, L. bifermentans, L. brevis, L. buchneri, L. camelliae, L. casei, L. catenaformis, L. ceti, L. coleohominis, L. collinoides, L. composti, L. concavus, L. corynidbrmis, L. crispatus, L. crustorum, L. curvatus, L. delbrueckii (including L. delbrueckii subsp. bulgaricus, L. delbrueckii subsp. delbrueckii, L. delbrueckii subsp. lactis), L. dextrinicus, L. diolivorans, L. equi, L. equigenerosi, L. farraginis, L. farciminis, L. fermentum, L. fbmicalis, L. fructivorans, L. fumenti, L. fuchuensis, L. gallinarum, L. gasseri, L. gasticus, L. ghanensis, L. graminis, L. ammesii, L. hamsteri, L. harbinensis, L. hayakitensis, L. helveticus, L. hilgardii, L. omohiochii, L. iners, L. ingluviei, L. intestinalis, L. jensenii, L. johnsonii, L. kalixensis, L. enranofaciens, L. kefri, L. kimchii, L. kitasatonis, L. kunkeei, L. leichmannii, L. lindneri, L. alefrmentans, L. mali, L. manihotivorans, L. mindensis, L. mucosae, L. murinus, L. nagelii, L. namurensis, L. nantensis, L. oligofermentans, L. oris, L. panis, L. pantheris, L. parabrevis, L. parabuchneri, L. paracasei, L. paracollinoides, L. parafarraginis, L. parakefiri, L. aralimentarius, L. paraplantarum, L. pentosus, L. perolens, L. plantarum, L. pontis, L. protectus, L. psittaci, L. rennini, L. reuteri, L. rhamnosus, L. rimae, L. rogosae, L. rossiae, L. ruminis, L. saerimneri, L. sakei, L. salivarius, L. sanfranciscensis, L. satsumensis, L. secaliphilus, L. sharpeae, L. siliginis, L. spicheri, L. suebicus, L. thailandensis, L. ultunensis, L. vaccinostercus, L. vaginalis, L. versmoldensis, L. vini, L. vitulinus, L. zeae or L. zymae. In some embodiments, the bacterial host cell is from the genus Lactiplantibacillus sp., and in some further embodiments, from the species Lactiplantibacillus plantarum (which was previously referred to as Lactobacillus plantarum).

In a particular embodiment, the recombinant microbial host cell is a fungi. Suitable recombinant fungi host cells can be, for example, from the genus Trichoderma, aspergillus, and neurospora.

The present disclosure concerns recombinant microbial host cells having the intrinsic ability to make a minimal amount of ethanol suitable in the manufacture of an alcoholic beverage by fermentation. For example, the recombinant microbial host cells can express one or more polypeptides (which can be endogenous/native or heterologous) in an ethanol production pathway in order to achieve a minimal amount of ethanol during or after the fermentation. In some embodiments, the minimal amount of ethanol is at least 5 g/L, 10 g/L, 20 g/L, 30 g/L, 40 g/L, 50 g/L or more during or after fermentation (but prior to distillation, if any), or after at least partial conversion of the carbohydrate substrate into its metabolites. In one embodiment, the minimal amount of ethanol is 5 g/L. The recombinant microbial host cell of the present disclosure may have a native (e.g., not genetically modified) and functional ethanol production pathway to allow it to reach the minimal ethanol level during fermentation. Enzymes involved in ethanol production include, but are not limited to, pyruvate decarboxylase (PDC), alcohol dehydrogenase (ALD), invertase, lactate dehydrogenase (LDH), glucokinase, glucose-6-phosphate isomerase, phosphofructokinase, aldolase, triosephosphate isomerase, glyceraldehyde 3-phosphate dehydrogenase, 3-phosphoglycerate kinase, phosphoglycerate mutase, enolase, pyruvate kinase, pyruvate decarboxylase and/or alcohol dehydrogenase.

However, in some embodiments, the recombinant microbial host cell of the present disclosure may be genetically modified to increase the activity of one or more polypeptide in the ethanol production pathway so as to reach the minimal ethanol level. In one embodiment, the recombinant microbial host cells can have a modified/heterologous promoter to increase expression of one or more polypeptide in the ethanol production pathway. In another embodiment, the recombinant microbial host cells have a heterologous nucleic acid molecule encoding one or more heterologous polypeptide in the ethanol production pathway. The polypeptides involved in the ethanol production pathway include, but are not limited to pyruvate decarboxylase(s) (PDC), alcohol dehydrogenase(s) (ALD), mitochondrial lactate dehydrogenase (CYB2 and/or DLD1) as well as the enzymes involved in glycolysis (for example those listed in Table 2). In an embodiment, the recombinant microbial host cell of the present disclosure comprises at least one genetic modification to increase the expression of at least one of the following enzymes: pyruvate decarboxylase (PDC), alcohol dehydrogenase (ALD), lactate dehydrogenase (LDH), glucokinase, glucose-6-phosphate isomerase, phosphofructokinase, aldolase, triosephosphate isomerase, glyceraldehyde 3-phosphate dehydrogenase, 3-phosphoglycerate kinase, phosphoglycerate mutase, enolase, pyruvate kinase, pyruvate decarboxylase and/or alcohol dehydrogenase. In an embodiment, the recombinant microbial host cell of the present disclosure comprises a combination of more than one genetic modification to increase the expression of more than one of the following enzymes: pyruvate decarboxylase (PDC), alcohol dehydrogenase (ALD), lactate dehydrogenase (LDH), glucokinase, glucose-6-phosphate isomerase, phosphofructokinase, aldolase, triosephosphate isomerase, glyceraldehyde 3-phosphate dehydrogenase, 3-phosphoglycerate kinase, phosphoglycerate mutase, enolase, pyruvate kinase, pyruvate decarboxylase and/or alcohol dehydrogenase.

TABLE 2
Primary genes involved in glycolysis

| Gene | Enzyme |
|---|---|
| GLK1, HXK1, HXK2 | glucokinase |
| PGI1 | glucose-6-phosphate isomerase |
| PFK1, PFK2 | phosphofructokinase |
| FBA1 | aldolase |
| TPI1 | triosephosphate isomerase |
| TDH1, TDH2, TDH3 | glyceraldehyde 3-phosphate dehydrogenase |
| PGK1 | 3-phosphoglycerate kinase |
| GPM1 | phosphoglycerate mutase |
| ENO1, ENO2 | enolase |
| PYK2, CDC19 | pyruvate kinase |
| PDC1, PDC5, PDC6 | pyruvate decarboxylase |
| ADH1, ADH2, ADH3, | alcohol dehydrogenase |
| ADH4, ADH5 | |

In an embodiment, the recombinant microbial host cell of the present disclosure includes (and in an embodiment expresses) a nucleic acid molecule coding for a pyruvate decarboxylase. The pyruvate decarboxylase may be native or heterologous to the recombinant microbial host cell and includes, but is not limited to, fungal, plant, bacterial, yeast, or other microorganism derived pyruvate decarboxylase. In one embodiment, the pyruvate decarboxylase is derived from the PDC1, PDC5, and/or PDC6 gene. In one embodiment, the pyruvate decarboxylase is derived from the PDC1 and PDC5 genes, the PDC5 and PDC6 genes, or the PDC1 and PDC6 genes. In one embodiment, the pyruvate decarboxylase is of the PDC1, PDC5, and PDC6 genes. In another embodiment, the pyruvate decarboxylase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for an alcohol dehydrogenase. The alcohol dehydrogenase may be native or heterologous to the recombinant microbial host cell and includes, but is not limited to, fungal, plant, bacterial, yeast, or other microorganism derived alcohol dehydrogenase. In an embodiment, the alcohol dehydrogenase is derived from the ADH1, ADH2, ADH3, ADH4, and/or ADH5 genes. In another embodiment, the alcohol dehydrogenase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a glucokinase. The glucokinase may be native or heterologous to the recombinant yeast host cell and includes, but is not limited to, fungal, plant, bacterial, yeast, or other microorganism derived glucokinase. In one embodiment, the glucokinase is derived from the GLK1, HXK1, or HXK2 gene. In one embodiment, the glucokinase is derived from the GLK1 and HXK1 genes, the HXK1 and HXK2 genes, or the GLK1 and HXK2 genes. In one embodiment, the glucokinase is derived from the GLK1, HXK1, and HXK2 genes. In another embodiment, the glucokinase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a glucose-6-phosphate isomerase. The glucose-6-phosphate isomerase may be native or heterologous to the recombinant yeast host cell and includes, but is not limited to, fungal, plant, bacterial, yeast, or other microorganism derived glucose-6-phosphate isomerase. In one embodiment, the glucose-6-phosphate isomerase is derived from the PGI1 gene. In another embodiment, the glucose-6-phosphate isomerase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a phosphofructokinase. The phosphofructokinase may be native or heterologous to the recombinant microbial host cell and includes, but is not limited to, fungal, plant, bacterial, yeast, or other microorganism derived phosphofructokinase. In one embodiment, the phosphofructokinase is derived from the PFK1 and/or PFK2 gene. In another embodiment, the phosphofructokinase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for an aldolase. The aldolase may be native or heterologous to the recombinant microbial host cell and includes, but are not limited to, fungal, plant, bacterial, yeast, or other microorganism derived aldolase. In one embodiment, the aldolase is of the FBA1 gene. In another embodiment, the aldolase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a triosephosphate isomerase. The triosephosphate isomerase may be native or heterologous to the recombinant yeast host cell and includes, but is not limited to, fungal, plant, bacterial, yeast, or other microorganism derived triosephosphate isomerase. In one embodiment, the triosephosphate isomerase is of the TPI1 gene. In one embodiment, the aldolase is of the FBA1 gene. In another embodiment, the triosephosphate isomerase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a glyceraldehyde 3-phosphate dehydrogenase. The glyceraldehyde 3-phosphate dehydrogenase may be native or heterologous to the recombinant microbial host cell and includes, but is not limited to, fungal, plant, bacterial, yeast, or other microorganism derived glyceraldehyde 3-phosphate dehydrogenase. In one embodiment, the glyceraldehyde 3-phosphate dehydrogenase is derived from the TDH1, TDH2, or TDH3 gene. In one embodiment, the glyceraldehyde 3-phosphate dehydrogenase is derived from the TDH1 and TDH2 genes, TDH2 and TDH3 genes, or TDH1 and TDH3 genes. In one embodiment, the glyceraldehyde 3-phosphate dehydrogenase is derived from the TDH1, TDH2, and TDH3 genes. In another embodiment, the glyceraldehyde 3-phosphate dehydrogenase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a 3-phosphoglycerate kinase. The 3-phosphoglycerate kinase may be native or heterologous to the recombinant microbial host cell and includes, but is not limited to, fungal, plant, bacterial, yeast, or other microorganism derived 3-phosphoglycerate kinase. In one embodiment, the 3-phosphoglycerate kinase is derived from the PGK1 gene. In another embodiment, the glyceraldehyde 3-phosphoglycerate kinase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a phosphoglycerate mutase. The phosphoglycerate mutase may be native or heterologous to the recombinant microbial host cell and includes, but is not limited to, fungal, plant, bacterial, yeast, or other microorganism derived phosphoglycerate mutase. In one embodiment, the phosphoglycerate mutase is derived from the GPM1 gene. In another embodiment, the phosphoglycerate mutase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for an enolase. The enolase may be native or heterologous to the recombinant microbial host cell and includes, but is not limited to, fungal, plant, bacterial, yeast, or other microorganism derived enolase. In one embodiment, the enolase is derived from the ENO1, and/or ENO2 gene. In another embodiment, the enolase is from a yeast, for example from the species Saccharomyces and in a further embodiment from Saccharomyces cerevisiae.

In an embodiment, the recombinant microbial host cell of the present disclosure includes (and in an embodiment expresses) a nucleic acid molecule coding for a pyruvate kinase. The pyruvate kinase may be native or heterologous to the recombinant microbial host cell and includes, but is not limited to, fungal, plant, bacterial, yeast, or other microorganism derived pyruvate kinase. In one embodiment, the pyruvate kinase is of the PYK2, and/or CDC19 gene. In another embodiment, the enolase is from a yeast, for example from the species Saccharomyces and in a further embodiment from Saccharomyces cerevisiae.

The recombinant microbial host cell of the present disclosure includes a heterologous nucleic acid molecule encoding one or more heterologous polypeptide for the production of at least one or a combination of flavor compound(s), such as, for example, those listed in Table 3. As such, the recombinant microbial host cells of the present disclosure is intended to express, at least during the fermentation process for making the first fermentation product, one or more heterologous polypeptide for making at least one flavor compound. However, in some embodiments, in order to avoid organoleptic defects in the alcoholic beverage, care must be taken to as to limit the production of the one or more flavor compounds to a maximal amount. For example, in embodiments in which the flavor compound should not exceed a specific threshold (e.g., lactic acid for example), the recombinant microbial host cell can be used to provide a maximal amount of the at least one flavor compound produced during fermentation which can be at most about 3.0, 2.9, 2.8, 2.7, 2.6, 2.5, 2.4, 2.3, 2.2, 2.1, 2.0, 1.9, 1.8, 1.7, 1.6, 1.5, 1.4, 1.3, 1.2, 1.1, 1.0, 0.9, 0.8, 0.7, 0.6, 0.5, 0.4, 0.3, 0.2, 0.1, 0.09, 0.08, 0.07, 0.06, 0.05, 0.04, 0.03, 0.02 or 0.01 w/v percent with respect to the weight of the alcoholic mixture after fermentation. In such embodiments, the recombinant microbial host cell can also be used to provide a minimal detectable amount of the flavor compound which is going to depend on the type of alcoholic beverage produced. In yet another example, in embodiments in which the flavor compound should met a minimal threshold (such as, for example, valencene, nootkatone, vanillin, isoamyl acetate, 4-(4-hydroxyphenyl)-2-butanone, 4-ethyl-phenol and 4-ethyl guaiacol, phenylethyl alcohol, ethyl capraote, and/or vanillyloctanamide), the recombinant microbial host cell can be used to provide a minimal amount of the flavor compound produced during fermentation which can be at least about 0.1, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1 000 ppb or more. In still another example, in embodiments in which the flavor compound should meet a minimal threshold (such as, for example, valencene, nootkatone, vanillin, isoamyl acetate, 4-(4-hydroxyphenyl)-2-butanone, 4-ethyl-phenol and 4-ethyl guaiacol, phenylethyl alcohol and/or ethyl capraote, vanillyloctanamide), the recombinant microbial host cell can be used to provide a minimal amount of the at least one flavor compound produced during fermentation which can be at least about 0.1, 1, 2, 3, 4, 5, 6, 7, 8, 9, 10, 20, 30, 40, 50, 60, 70, 80, 90, 100, 110, 120, 130, 140, 150, 160, 170, 180, 190, 200, 210, 220, 230, 240, 250, 260, 270, 280, 290, 300, 400, 500, 600, 700, 800, 900, 1 000 ppm or more. In one embodiment, the maximal amount or minimal amount of flavor compound the recombinant microbial host cells can produce during fermentation depends on the type of flavor compound and/or the type of alcoholic beverage. A list of embodiments of the flavor compounds is provided in Table 3, together with example gene expression modification in a recombinant host microbial cell for the production of the flavor compounds. A list of the detectable amounts of flavor compound for the embodiments of flavor compounds (from Table 3) is provided in Table 4.

In some embodiments, the recombinant microbial host cell of the present disclosure can be further modified to delete and/or upregulate the expression of one or more native genes for the production of at least one or a combination of flavor compound(s), such as, yeast strains bearing “heterologous flavor expression background” described in WO2019171230A1 (incorporated herewith in its entirety) and allowing the heterologous expression of flavor compounds by a yeast host cell. As such, the recombinant microbial host cells of the present disclosure is intended to express, at least during the fermentation process for making the flavored alcoholic beverage, one or more heterologous polypeptide for making at least one flavor compound.

In some embodiments, recombinant microbial host cell of the present disclosure includes a heterologous nucleic acid molecule encoding one or more heterologous polypeptide and is modified to delete and/or upregulate one or more native genes for the production of at least one or a combination of flavor compound(s), such as, for example, those listed in Table 3. As such, the recombinant microbial host cells of the present disclosure are intended to express, at least during the fermentation process for making the flavored alcoholic beverage, one or more heterologous polypeptide for making at least one flavor compound.

TABLE 3
Flavors, genes, and pathways involved in production of flavor compounds

| | | | Native |
|---|---|---|---|
| | Flavor | Genes for expression or | genes for |
| Flavor | compound | overexpression | deletion |
| Sour | lactic acid | lactate dehydrogenase | N.A. |
| Citrus | valencene | farnesyl diphosphate synthase, | N.A. |
| (orange) | | valencene synthase | |
| | | 3-hydroxy-3-methylglutaryl- | |
| | | coenzyme A reductase 1 (HMG1) | |
| Citrus | nootkatone | farnesyl diphosphate synthase, | N.A. |
| (Grapefruit) | | valencene synthase, | |
| | | valencene oxydase | |
| | | cytochrome P450 monooxygenase | |
| | | cytochrome P450 hydroxylase | |
| | | cytochrome P450 reductase | |
| | | 3-hydroxy-3-methylglutaryl- | |
| | | coenzyme A reductase 1 (HMG1) | |
| Vanilla | vanillin | feruloyl-CoA synthetase, | Δ PAD1 |
| | | feruloyl-CoA hydratase | |
| Banana | isoamyl acetate | alcohol acetyl transferase (ATF1 | N.A. |
| | | and/or ATF2) | |
| Raspberry | 4-(4- | phenylalanine-ammonium lyase | N.A. |
| | hydroxyphenyl)-2- | cinnimate-4-hydroxylase | |
| | butanone | coumarate-CoA ligase | |
| | | benzalacetone synthase | |
| Brettanomyces | 4-ethyl-phenol | vinylphenol reductase | N.A. |
| flavors | and 4-ethyl | | |
| | guaiacol | | |
| Rose-like | phenylethyl | ARO8 | |
| | alcohol | ARO9 | |
| | | ARO10 | |
| | | PDC1 | |
| | | PDC5 | |
| | | PDC6 | |
| | | SFA1 | |
| | | ADH4 | |
| | | ADH5 | |
| Green apple | ethyl caproate | Mutant FAS2 | N.A. |
| Spicy | vanillyloctanamide | capsaicin synthase | N.A. |
| | | pAMT1 | |

TABLE 4
Embodiments of detectable of flavor compounds produced
by the recombinant microbial host cells during fermentation
(depending on the alcholic beverage)

| Flavor compound | Detectable Amount | |
|---|---|---|
| lactic acid | 1.0-3.0 | g/L |
| nootkatone | 150-200 | ppb |
| vanillin | 20-200 | ppb |
| isoamyl acetate | 250-300 | ppb |
| ethyl acetate | 5-5000 | ppb |
| phenylethyl acetate | 3-5 | ppm |
| isobutyl acetate | 50-1000 | ppb |
| heptyl acetate | 200-300 | ppb |
| nonyl acetate | 50-600 | ppb |
| 4-(4-hydroxyphenyl)-2-butanone | 20-100 | ppb |
| 4-ethyl phenol | 40-130 | ppb |
| 4-ethyl guaiacol | 25-50 | ppb |

The heterologous enzymes listed in Table 3 are examples, and other heterologous enzymes derived from a different strain of host cell, or from an organism of a different taxonomic group (e.g., different kingdom, phylum, class, order, family genus, or species, or any subgroup within one of these classifications) can be used. In some embodiments, the recombinant microbial host cell of the present disclosure includes one or more heterologous nucleic acid molecule encoding one or more heterologous polypeptide for the production of the at least one flavor compound, including one or more of the flavor compounds listed in Table 2 and combinations thereof. In an embodiment, the recombinant microbial host cell is genetically modified to make a single flavor compound from the following list: lactic acid, valencene, nootkatone, vanillin, isoamyl acetate, 4-(4-hydroxypheny)-2-butanone, 4-ethyl-phenol, 4-ethyl guaiacol, ethyl capraote, phenylethyl alcohol, or vanillyloctanamide. In still another embodiment, the recombinant microbial host cell is genetically modified to make at least two flavor compounds from any combinations of the following list: lactic acid, valencene, nootkatone, vanillin, isoamyl acetate, 4-(4-hydroxypheny)-2-butanone, 4-ethyl-phenol, 4-ethyl guaiacol, ethyl capraote, phenylethyl alcohol, and/or vanillyloctanamide. In still a further embodiment, the recombinant microbial host cell is genetically modified to make at least three flavor compounds from any combinations of the following list: lactic acid, valencene, nootkatone, vanillin, isoamyl acetate, 4-(4-hydroxypheny)-2-butanone, 4-ethyl-phenol, 4-ethyl guaiacol, ethyl capraote, phenylethyl alcohol, and/or vanillyloctanamide. In yet another embodiment, the recombinant microbial host cell is genetically modified to make at least four flavor compounds from any combinations of the following list: lactic acid, valencene, nootkatone, vanillin, isoamyl acetate, 4-(4-hydroxypheny)-2-butanone, 4-ethyl-phenol, 4-ethyl guaiacol, ethyl capraote, phenylethyl alcohol, and/or vanillyloctanamide. In another embodiment, the recombinant microbial host cell is genetically modified to make at least five flavor compounds from any combinations of the following list: lactic acid, valencene, nootkatone, vanillin, isoamyl acetate, 4-(4-hydroxypheny)-2-butanone, 4-ethyl-phenol, 4-ethyl guaiacol, ethyl capraote, phenylethyl alcohol, and/or vanillyloctanamide. In a further embodiment, the recombinant microbial host cell is genetically modified to make at least six flavor compounds from any combinations of the following list: lactic acid, valencene, nootkatone, vanillin, isoamyl acetate, 4-(4-hydroxyphenyl)-2-butanone, 4-ethyl-phenol, 4-ethyl guaiacol, ethyl capraote, phenylethyl alcohol, and/or vanillyloctanamide. In still yet another embodiment, the recombinant microbial host cell is genetically modified to make at least seven flavor compounds from any combinations of the following list: lactic acid, valencene, nootkatone, vanillin, isoamyl acetate, 4-(4-hydroxypheny)-2-butanone, 4-vinyl-phenol, 4-vinyl guaiacol, ethyl capraote, phenylethyl alcohol, and/or vanillyloctanamide. In still yet another embodiment, the recombinant microbial host cell is genetically modified to make at least eight flavor compounds from any combinations of the following list: lactic acid, valencene, nootkatone, vanillin, isoamyl acetate, 4-(4-hydroxypheny)-2-butanone, 4-vinyl-phenol, 4-vinyl guaiacol, ethyl capraote, phenylethyl alcohol, and/or vanillyloctanamide. In still yet another embodiment, the recombinant microbial host cell is genetically modified to make at least nine flavor compounds from any combinations of the following list: lactic acid, valencene, nootkatone, vanillin, isoamyl acetate, 4-(4-hydroxypheny)-2-butanone, 4-vinyl-phenol, 4-vinyl guaiacol, ethyl capraote, phenylethyl alcohol, and/or vanillyloctanamide. In still yet another embodiment, the recombinant microbial host cell is genetically modified to make at least ten flavor compounds from any combinations of the following list: lactic acid, valencene, nootkatone, vanillin, isoamyl acetate, 4-(4-hydroxypheny)-2-butanone, 4-vinyl-phenol, 4-vinyl guaiacol, ethyl capraote, phenylethyl alcohol, and/or vanillyloctanamide. In still another embodiment, the recombinant microbial host cell is genetically modified to make all the flavor compounds from the following list: lactic acid, valencene, nootkatone, vanillin, isoamyl acetate, 4-(4-hydroxypheny)-2-butanone, 4-ethyl-phenol, 4-ethyl guaiacol, ethyl capraote, phenylethyl alcohol, and/or vanillyloctanamide.

In an embodiment, the recombinant microbial host cell of the present disclosure includes (and in an embodiment expresses) a nucleic acid molecule coding one or more heterologous polypeptide for the production of lactic acid. As used in the present disclosure, the term “lactate dehydrogenase” (LDH) refers to a polypeptide capable of the enzyme classification 1.1.1.27 and capable of catalyzing the conversion of lactate to pyruvic acid and/or pyruvic acid into lactate.

In one embodiment, the enzyme having LDH activity is a heterologous LDH enzyme. For example, the one or more polypeptide for the production of lactic acid can comprise lactate dehydrogenase from a Rhizopus sp. (such as for example, from a Rhizopus oryzae), a variant thereof or a fragment thereof. In some embodiments, the Rhizopus oryzae lactate dehydrogenase is encoded by the nucleotide molecule having the sequence of SEQ ID NO: 1 (or a variant thereof or a fragment thereof). In some embodiment, the Rhizopus oryzae lactate dehydrogenase has the amino acid sequence of SEQ ID NO: 2 (or a variant thereof or a fragment thereof). In some embodiments, the heterologous lactate dehydrogenase is derived from the Lachancea sp. (for example from Lanchancea fermentati (which can have, for example, the amino acid sequence of SEQ ID NO: 3, 4, 5 6 or 10 a variant thereof or a fragment thereof) or Lachancea themotolerans (which can have, for example, the amino acid sequence of SEQ ID NO: 8 or 9, a variant thereof or a fragment thereof)) or from the Wickerhamomyces sp. (for example from Wickerhamomyces anomalus and can have, for example, the amino acid sequence of SEQ ID NO: 11, a variant thereof or a fragment thereof).

In some embodiments, the recombinant microbial host cell is genetically engineered to redirect the expression of a mitochondrial LDH enzyme to the cytosol. In such embodiment, the native gene encoding for the mitochondrial LDH enzyme can be mutated in the recombinant microbial host cell. Alternatively, or in combination, a heterologous nucleic acid molecule coding for a mutated LDH enzyme (which can be expressed and localized in the cytosol) can be introduced in the recombinant microbial host cell. As such, the recombinant microbial host cell can comprise a heterologous nucleic acid coding for a mutated mitochondrial LDH enzyme that can localize to the cytosol. In an embodiment, the heterologous nucleic acid includes a gene coding for a mitochondrial LDH enzyme lacking a mitochondrial signal sequence which, upon expression, will provide the mitochondrial enzyme in the cytosol. In an embodiment, the genes encoding the mitochondrial lactate dehydrogenase (LDH) enzymes that can be mutated include, but are not limited to, the DLD1 gene and/or the CYB2 gene. For example, the mitochondrial LDH enzyme can be a mutant of the S. cerevisiae DLD1 enzyme having the amino acid sequence of SEQ ID NO: 90, a variant thereof or a fragment thereof. In another example, the mitochondrial LDH enzyme can be a mutant of the S. cerevisiae CYB2 enzyme having the amino acid sequence of SEQ ID NO: 89, a variant thereof or a fragment thereof. In one embodiment, the recombinant microbial host cell is modified for cytosolic enzymatic function and/or expression of these mitochondrial LDH of the DLD1 and/or CYB2 genes for the production of lactic acid. In another embodiment, the mitochondrial LDH enzyme is from a yeast, for example from the species Saccharomyces and in a further embodiment from Saccharomyces cerevisiae.

In some embodiments, the recombinant microbial host cell is genetically engineered to express a mutated malate dehydrogenase having LDH activity. Malate dehydrogenase is an enzyme having highly similar structure to lactate dehydrogenase. In such embodiment, the native gene encoding for the malate dehydrogenase can be mutated in the recombinant microbial host cell. Alternatively, or in combination, a heterologous nucleic acid molecule coding for a mutated malate dehydrogenase (exhibiting LDH activity) can be introduced in the recombinant microbial host cell. As such, the recombinant microbial host cell can comprise a heterologous nucleic acid coding for a mutated malate dehydrogenase exhibiting LDH activity. In an embodiment, when the malate dehydrogenase is from Escherichia coli, it can be mutated at position 153 (to replace the arginine residue which another residue, such as, for example, a cysteine) to provide LDH activity (Wright and Viola, 2001).

In embodiments in which the recombinant microbial host cell is intended to produce valencene as the at least one flavor compound, the recombinant microbial host cell of the present disclosure includes (and in an embodiment expresses) a heterologous nucleic acid molecule coding for one or more heterologous polypeptide for the production of valencene, such as, for example, a farnesyl diphosphate synthase and/or a valencene synthase. Proteins having farnesyl disphosphate synthase activity catalyze the production of farnesyl disphosphate whereas proteins having valencene synthase activity catalyze the conversion of farnesyl disphophate into valencene. In one embodiment, the one or more polypeptide is or comprises a farnesyl diphosphate synthase (FDPS), a variant thereof or a fragment thereof. The FDPS can be derived, for example, from a Arabidopsis sp. (including but not limited to Arabidopsis thaliana and having, for example, the amino acid sequence of SEQ ID NO: 12), a Glycyrrhiza sp. (including but not limited to Glycyrrhiza uralensis and having, for example, the amino acid sequence of SEQ ID NO: 13), a Capsella sp. (including, but not limited to Capsella rubella and having, for example, the amino acid sequence of SEQ ID NO: 14) or from a Lupinus sp. (including but not limited to Lupinus angustifolius and having, for example, the amino acid sequence of SEQ ID NO: 16). Alternatively, or in combination, the one or more polypeptide is or comprises a valencene synthase, a variant thereof or a fragment thereof. The valencene synthase can be derived from a Citrus sp. (including, but not limited to a Citrus sinensis and having, for example, the amino acid sequence of SEQ ID NO: 17 or to a Citrus junos and having, for example, the amino acid sequence of SEQ ID NO: 18), a Vitis sp. (including, but not limited to Vitis vinifera and having, for example, the amino acid sequence of SEQ ID NO: 19), a Callitropsis sp. (including, but not limited to Callitropsis nootkatensis and having, for example, the amino acid sequence of SEQ ID NO: 20) or from a Populus sp. (including, but not limited to, Populus trichocarpa and having, for example, the amino acid sequence of SEQ ID NO: 21).

In embodiments in which the recombinant microbial host cell is intended to produce, nootkatone as the at least one flavor compound, the recombinant microbial host cell of the present disclosure includes (and in an embodiment expresses) a heterologous nucleic acid molecule coding for one or more polypeptide for the production of nootkatone, such as, for example, a farnesyl diphosphate synthase (FDPS), a valencene synthase, a cytochrome P450 oxygenase, a cytochrome P450 hydrozylase and/or a valencene oxidase. The nootkatone flavor can be produced by converting valencene into nootkatone using a valencene oxidase (Cankar et al., 20014) or a combination of a cytochrome P450 oxygenase and a cytochrome P450 hydroxylase (Wriessnegger et al., 2014). In one embodiment, the one or more polypeptide is or comprises a farnesyl diphosphate synthase (FDPS), a variant thereof or a fragment thereof. In one embodiment, the one or more polypeptide is or comprises a farnesyl diphosphate synthase (FDPS), a variant thereof or a fragment thereof. The FDPS can be derived, for example, from a Arabidopsis sp. (including but not limited to Arabidopsis thaliana and having, for example, the amino acid sequence of SEQ ID NO: 12), a Glycyrrhiza sp. (including but not limited to Glycyrrhiza uralensis and having, for example, the amino acid sequence of SEQ ID NO: 13), a Capsella sp. (including, but not limited to Capsella rubella and having, for example, the amino acid sequence of SEQ ID NO: 14) or from a Lupinus sp. (including but not limited to Lupinus angustilblius and having, for example, the amino acid sequence of SEQ ID NO: 16). Alternatively, or in combination, the one or more polypeptide comprises a valencene synthase, a variant thereof or a fragment thereof. The valencene synthase can be derived from a Citrus sp. (including, but not limited to a Citrus sinensis and having, for example, the amino acid sequence of SEQ ID NO: 17 or to a Citrus junos and having, for example, the amino acid sequence of SEQ ID NO: 18), a Vitis sp. (including, but not limited to Vitis vinifera and having, for example, the amino acid sequence of SEQ ID NO: 19), a Callitropsis sp. (including, but not limited to Callitropsis nootkatensis and having, for example, the amino acid sequence of SEQ ID NO: 20) or from a Populus sp. (including, but not limited to, Populus trichocarpa and having, for example, the amino acid sequence of SEQ ID NO: 21). Alternatively, or in combination, the one or more polypeptide is or comprises a cytochrome P450 oxygenase. The cytochrome P450 oxygenase can be derived from a Bacillus sp. (including, but not limited to Bacillus subtilis and having, for example, the amino acid sequence of SEQ ID NO: 22); to a Bacillus amyloliquefaciens and having, for example, the amino acid sequence of SEQ ID NO: 23); to a Bacillus halotolerans and having for example, the amino acid sequence of SEQ ID NO: 24); to a Bacillus nakamurai and having, for example, the amino acid sequence of SEQ ID NO: 25) or to a Bacillus velezensis and having, for example, the amino acid sequence of SEQ ID NO: 26). Alternatively, or in combination, the one or more polypeptide is or comprises a cytochrome P450 hydroxylase. The cytochrome P450 hydrozylase cane be derived from a Hyoscyamus sp. (including, but not limited to, Hyoscyamus muticus and having, for example, the amino acid sequence of SEQ ID NO: 27), a Nicotiana sp. (including, but not limited to Nicotiana attenuate and having, for example, the amino acid sequence of SEQ ID NO: 28), a Solanum sp. (including, but not limited to Solanum tuberosum and having, for example, the amino acid sequence of SEQ ID NO: 29; to Solanum pennellii and having, for example, the amino acid sequence of SEQ ID NO: 31) or from a Capsicum sp. (including, but not limited to Capsicum annuum and having, for example, the amino acid sequence of SEQ ID NO: 30). Alternatively, or in combination, the one or more polypeptide is or comprises a cytochrome P450 reducatase. The cytochrome P450 reductase can be derived from Arabidopsis sp. (including, but not limited to, Arabidopsis thaliana and having, for example, the amino acid sequence of SEQ ID NO: 32), Brassica sp. (including, but not limited to, Brassica napus and having, for example, the amino acid sequence of SEQ ID NO: 33), Tarenaya sp. (including, but not limited to Tarenaya hassleriana and having, for example, the amino acid sequence of SEQ ID NO: 34), Quercus sp. (including, but not limited to Quercus suber and having, for example, the amino acid sequence of SEQ ID NO: 35) or from Prunus sp. (including, but not limited to Prunus persica and having, for example, the amino acid sequence of SEQ ID NO: 36). Alternatively, or in combination, the one or more polypeptide is or comprises a valencene oxidase. The valencene oxidase can be derived from Callitropsis sp. (including, but not limited to, Callitropsis nootkatensis and having, for example, the amino acid sequence of SEQ ID NO: 37).

In some embodiments, when the recombinant microbial host cell is intended to produce valencene or nootkanone, it may be advantageous to provide a microbial host cell expressing a polypeptide having the 3-hydroxy-3-methylglutaryl-coenzyme A reductase 1 (HMG1) activity or further modify the cell so as to increase the activity of HMG1. This can be done for example, by including one or more copies of the gene encoding HMG1 or a corresponding gene ortholog in the microbial genome. In the context of the present disclosure, an “HMG1 gene ortholog” is understood to be a gene in a different species that evolved from a common ancestral gene by speciation. Genes encoding HMG1 or corresponding orthologs include, but are not limited to, proteins having the GenBank Accession number CAA86503.1 and KZV08767.1 (S. cerevisiae), CAA70691.1 (A. thaliana) and XP_566774.1 (Cryptococcus neoformans var. neoformans JEC21).

In an embodiment in which the recombinant microbial host cell is intended to produce vanillin as the at least one flavor compound. In order to produce the vanillin as the flavor compound, it is possible to modify the recombinant microbial host cell of the present disclosure to include (and in an embodiment to express) a heterologous nucleic acid molecule coding for a feruloyl-CoA synthetase (FCS) and/or an enoyl-coA hydratase (ECH, also known as feruloyl-CoA hydratase or FCH). Alternatively, it is possible to modify the recombinant microbial host cell to produce directly vanillin from ferulic acid to include (and in an embodiment to express), a vanillin synthase. In one embodiment, the one or more polypeptide is or comprises a feruloyl-CoA synthetase (FCS). The feruloyl-coA synthetase can be derived from a Pseudomonas sp. (including, but not limited to, Pseudomonas fluorescens and having, for example, the amino acid sequence of SEQ ID NO: 38; Pseudomonas syringae and having, for example, the amino acid sequence of SEQ ID NO: 41), a Streptomyces sp. (including, but not limited to a Streptomyces sp. V-1 and having, for example, the amino acid sequence of SEQ ID NO: 39), a Sphingomonas sp. (including, but not limited to Sphingomonas paucimobilis and having, for example, the amino acid sequence of SEQ ID NO: 40) or from Nocardia sp. (including, but not limited to, Nocardia amikacinitolerans and having, for example, the amino acid sequence of SEQ ID NO: 42). Alternatively or in combination, the one or more polypeptide is or comprises an enoyl-CoA hydratase (ECH). The enoyl-CoA hydratase can be derived from a Pseudomonas sp. (including, but not limited to, Pseudomonas fluorescens and having, for example, the amino acid sequence of SEQ ID NO: 43; Pseudomonas syringae and having, for example, the amino acid sequence of SEQ ID NO: 46), a Streptomyces sp. (including, but not limited to a Streptomyces sp. V-1 and having, for example, the amino acid sequence of SEQ ID NO: 44), a Sphingomonas sp. (including, but not limited to Sphingomonas paucimobilis and having, for example, the amino acid sequence of SEQ ID NO: 45) or from Saccharopolyspora sp. (including, but not limited to, Saccharopolyspora flava and having, for example, the amino acid sequence of SEQ ID NO: 47). Alternatively, or in combination, the one or more polypeptide is or comprises a vanillin synthase. The vanillin synthase can be derived from a Vanilla sp. (including, but not limited to, Vanilla planifolia and having, for example, the amino acid sequence of SEQ ID NO: 48) or from Glechoma sp. (including, but not limited to, Glechoma hederacea and having, for example, the amino acid sequence of SEQ ID NO: 49).

In some embodiments, the recombinant microbial host cell making the vanillin flavor compound is genetically engineered so as to no longer have phenylacrylic acid decarboxylase (PAD1) enzymatic activity. For example, the recombinant microbial host cell can be modified to remove in total or in part the PAD1 gene and/or its corresponding ortholog. In the context of the present disclosure, an “PAD1 gene ortholog” is understood to be a gene in a different species that evolved from a common ancestral gene by speciation. In the context of the present disclosure, a PAD1 ortholog retains the same function, e.g. it exhibits phenylacrylic acid decarboxylase enzymatic activity. This reduction or inhibition in PAD1 activity can be achieved by disrupting the open reading frame of the gene encoding PAD1 or its corresponding ortholog. This can be achieved by removing and/or adding one or more nucleic acid residues in the open reading frame of the PAD1 gene or gene ortholog. In an embodiment, the PAD1 gene can be disrupted by adding the heterologous nucleic acid molecule encoding for the one or more polypeptides for making the vanillin compound.

In an embodiment in which the recombinant microbial host cell is intended to produce isoamyl acetate as the at least one flavor compound, the recombinant microbial host cell of the present disclosure includes (and in an embodiment expresses) a heterologous nucleic acid molecule coding one or more heterologous polypeptide for the production of isoamyl acetate, such as, for example, an alcohol acetyl transferase, a variant thereof or a fragment thereof. The alcohol acetyl transferase may comprise ATF1 and/or ATF2 alcohol acetyl transferase. In one embodiment, the one or more polypeptide is or comprises a ATF1 alcohol acetyl transferase. The alcohol acetyl transferase ATF1 can be derived, for example, from a Saccharomyces sp. (including but not limited to, Saccharomyces cerevisiae and having, for example, the amino acid sequence of SEQ ID NO: 51; to Saccharomyces pastorianus and having, for example, the amino acid sequence of SEQ ID NO: 50; to Saccharomyces kudriavzevii and having, for example, the amino acid sequence of SEQ ID NO: 52). In one embodiment, the one or more polypeptide is or comprises an ATF2 alcohol acetyl transferase. The alcohol acetyl transferase ATF2 can be derived, for example, from a Saccharomyces sp. (including but not limited to, Saccharomyces cerevisiae and having, for example, the amino acid sequence of SEQ ID NO: 53; to Saccharomyces eubayanus and having, for example, the amino acid sequence of SEQ ID NO: 54).

In embodiments in which the recombinant microbial host cell is intended to produce isoamyl acetate as the at least one flavor compound, it may be advantageous to provide a microbial host cell expressing a native ATF enzyme or further modify the recombinant microbial host cell to overexpress an ATF enzyme. for example by cloning a promoter for overexpressing for controlling the expression of the native ATF enzyme. In another embodiment, the recombinant microbial host cell can be selected to express a native ATF enzyme (in addition to the heterologous ATF enzyme). This can be done for example, by including one or more copies of the gene encoding ATF enzyme or a corresponding gene ortholog in the microbial genome. In the context of the present disclosure, an “ATF gene ortholog” is understood to be a gene in a different species that evolved from a common ancestral gene by speciation.

In an embodiment in which the recombinant microbial host cell is intended to produce 4-(4-hydroxyphenyl)-2-butanone as the at least one flavor compound, the recombinant microbial host cell of the present disclosure includes (and in an embodiment expresses) a heterologous nucleic acid molecule coding one or more heterologous polypeptide for the production of coumaric acid from phenylalanine as well as 4-(4-hydroxyphenyl)-2-butanone from coumaric acid. Heterologous polypeptides capable of converting phenylalanine into coumeric acid include, without limitation, phenylalanine-ammonium lyase (PAL) and/or cinnamate-4-hydroxylase (C4L). Heterologous polypeptides capable of converting coumeric acid into 4-(4-hydroxyphenyl)-2-butanone include, without limitation, coumarate-CoA ligase (4CL) and/or a benzalacetone synthase (BAS). In one embodiment, the one or more heterologous polypeptides is or comprises a phenylalanine-ammonium lyase (PAL), a variant thereof or a fragment thereof. In some embodiments, the PAL is derived from Rhodosporidium sp. (including, but not limited to Rhodosporidium toruloides and having, for example, the amino acid sequence of SEQ ID NO: 79). In one embodiment, the one or more heterologous polypeptides is or comprises a C4L, a variant thereof or a fragment thereof. For example, the C4L can be derived from Arabidopsis sp. (including, but not limited to Arabidopsis thaliana and having, for example, the amino acid sequence of SEQ ID NO: 80). In an embodiment, the one or more heterologous polypeptide is or comprises a coumarate-CoA ligase (4CL), a variant thereof or a fragment thereof. In another embodiment, 4CL is derived from Petroselinum sp. (including but not limited to Petroselinum crispum and having, for example, the amino acid sequence of SEQ ID NO: 56 or 84), Arabidopsis sp. (including, but not limited to Arabidopsis thaliana and having, for example, the amino acid sequence of SEQ ID NO: 55 or 83), a Paulownia sp. (including, but not limited to Paulownia fortune and having, for example, the amino acid sequence of SEQ ID NO: 57), Brassica sp. (including, but not limited to Brassica napus and having, for example, the amino acid sequence of SEQ ID NO: 58) or from Capsicum sp. (including, but not limited to Capsicum baccatum and having, for example, the amino acid sequence of SEQ ID NOL 59). In another embodiment, the one or more heterologous polypeptide is or comprises a benzalacetone synthase (BAS), a variant thereof or a fragment thereof. In another embodiment, BAS is derived from Rheum sp. (including but not limited to Rheum palmatum and having, for example, the amino acid sequence of SEQ ID NO: 60 or 61), Polygonum sp. (including, but not limited to Polygonum cuspidatum and having, for example, the amino acid sequence of SEQ ID NO; 62), Camellia sp. (including, but not limited to Camellia sinensis and having, for example, the amino acid sequence of SEQ ID NO: 63) or from Vitis sp. (including, but not limited to Vitis vinifera and having, for example, the amino acid sequence of SEQ ID NO: 64).

In some embodiments, the one or more heterologous protein is or comprises a chimeric polypeptide having 4CL and BAS activity. In such embodiment, a polypeptide having 4CL activity can be fused to a polypeptide having BAS activity either directly or via the use of an amino acid linker (for example, the amino acid linker having the amino acid sequence of SEQ ID NO: 85). In one embodiment, the carboxyl terminus of the polypeptide having 4CL activity can be linked (directly or indirectly via the use of an amino acid linker) to the amino terminus of the polypeptide having BAS activity. In such embodiment, the chimeric polypeptide can have the amino acid sequence of SEQ ID NO: 81 or 82. In another embodiment of the chimeric polypeptide, the carboxyl terminus of the polypeptide having BAS activity can be linked (directly or indirectly via the use of an amino acid linker) to the amino terminus of the polypeptide having 4CL activity.

In embodiments in which the recombinant microbial host cell is intended to produce 4-(4-hydroxypheny)-2-butanone as the at least one flavor compound, it may be advantageous to provide a microbial host cell expressing a native benzalacetone reductase enzyme or further modify the recombinant microbial host cell to overexpress a benaylacetone reductase enzyme for example by cloning a promoter for overexpressing for controlling the expression of the native benzalacetone reductase enzyme. In another embodiment, the recombinant microbial host cell can be selected to express a native benzalacetone reductase enzyme (in addition to the heterologous ATF enzyme). This can be done for example, by including one or more copies of the gene encoding the benzalacetone reductase enzyme or a corresponding gene ortholog in the microbial genome. In the context of the present disclosure, a “benaylacetone reductase gene ortholog” is understood to be a gene in a different species that evolved from a common ancestral gene by speciation.

In an embodiment in which the recombinant microbial host cell is intended to produce 4-ethyl phenol and/or 4-ethyl guaiacol as the at least one flavor compound, the recombinant microbial host cell of the present disclosure includes (and in an embodiment expresses) a heterologous nucleic acid molecule coding one or more heterologous polypeptide for the production of 4-ethyl phenol and/or 4-ethyl guaiacol, such as, for example, a vinylphenol reductase, a variant thereof or a fragment thereof. In an embodiment, the vinylphenol reductase is derived from Brettanomyces sp. (including, but not limited to, Brettanomyces bruxellensis and having, for example, the amino acid sequence of SEQ ID NO: 65, 66 or 67) or from Ogataea sp. (including, but not limited to Ogataea parapolymorpha and having, for example, the amino acid sequence of SEQ ID NO: 68).

In an embodiment in which the recombinant microbial host cell is intended to produce phenylethyl alcohol as the at least one flavor compound, the recombinant microbial host cell of the present disclosure includes (and in an embodiment expresses) a heterologous nucleic acid molecule coding one or more heterologous polypeptide for the production of phenylethyl alcohol, such as, for example, ARO8, ARO9, PDC1, PDC5, PDC6, ARO10, SFA1, ADH4, and/or ADH5. In an embodiment, the one or more heterologous polypeptide is or comprises ARO8 (having, for example, an amino acid sequence of SEQ ID NO: 91), a variant thereof or a fragment thereof. In an embodiment, the one or more heterologous polypeptide is or comprises ARO9 (having for example the amino acid sequence of SEQ ID NO: 92), a variant thereof or a fragment thereof. In an embodiment, the one or more heterologous polypeptide is or comprises PCD1 (having, for example, the amino acid sequence of SEQ ID NO: 93), a variant thereof or a fragment thereof. In an embodiment, the one or more heterologous polypeptide is or comprises PDC5 (having, for example, the amino acid sequence of SEQ ID NO: 94), a variant thereof or a fragment thereof. In an embodiment, the one or more heterologous polypeptide is or comprises PDC6 (having, for example, the amino acid sequence of SEQ ID NO: 95), a variant thereof or a fragment thereof. In an embodiment, the one or more heterologous polypeptide is or comprises ARO10 (having, for example, the amino acid sequence of SEQ ID NO: 96), a variant thereof or a fragment thereof. In an embodiment, the one or more heterologous polypeptide is or comprises SFA1 (having, for example, the amino acid sequence of SEQ ID NO: 97), a variant thereof or a fragment thereof. In an embodiment, the one or more heterologous polypeptide is or comprises ADH4 (having, for example, the amino acid sequence of SEQ ID NO: 98), a variant thereof or a fragment thereof. In an embodiment, the one or more heterologous polypeptide is or comprises ADH5 (having, for example, the amino acid sequence of SEQ ID NO: 99), a variant thereof or a fragment thereof.

In embodiments in which the recombinant microbial host cell is intended to produce phenylethyl alcohol as the at least one flavor compound, it may be advantageous to provide a microbial host cell expressing at least one of native ARO8, ARO9, ARO10, PDC1, PDC5, PDC6, SFA1, ADH4 or ADH5 or further modify the recombinant microbial host cell to overexpress at least one at least one of ARO8, ARO9, ARO10, PDC1, PDC5, PDC6, SFA1, ADH4 or ADH5 for example by cloning a promoter for overexpressing for controlling the expression of the native benzalacetone reductase enzyme. In another embodiment, the recombinant microbial host cell can be selected to express a native ARO8, ARO9, ARO10, PDC1, PDC5, PDC6, SFA1, ADH4 and/or ADH5 (in addition to the heterologous at least one of ARO8, ARO9, ARO10, PDC1, PDC5, PDC6, SFA1, ADH4 and/or ADH5). This can be done for example, by including one or more copies of the gene encoding at least one at least one of ARO8, ARO9, ARO10, PDC1, PDC5, PDC6, SFA1, ADH4 or ADH5 or a corresponding gene ortholog in the microbial genome. In the context of the present disclosure, a “gene ortholog” is understood to be a gene in a different species that evolved from a common ancestral gene by speciation.

In an embodiment in which the recombinant microbial host cell is intended to produce ethyl caproate as the at least one flavor compound, the recombinant microbial host cell of the present disclosure includes (and in an embodiment expresses) a heterologous nucleic acid molecule coding one or more heterologous polypeptide for the production of ethyl caproate, such as, for example, FAS2, a variant thereof, a mutant thereof, or a fragment thereof. In an embodiment, the FAS2 enzyme has the amino acid sequence of SEQ ID NO: 86, is a variant of the amino acid sequence of SEQ ID NO: 86 or is a fragment of the amino acid sequence of SEQ ID NO: 86. In an embodiment, the mutated FAS2 enzyme has the amino acid sequence of SEQ ID NO: 87 or 88, is a variant of the amino acid sequence of SEQ ID NO: 87 or 88 or is a fragment of the amino acid sequence of SEQ ID NO: 87 or 88.

In an embodiment in which the recombinant microbial host cell is intended to produce vanillyloctanamide as the at least one flavor compound, the recombinant microbial host cell of the present disclosure includes (and in an embodiment expresses) a heterologous nucleic acid molecule coding one or more heterologous polypeptide for the production of vanillyloctanamide, such as, for example, capsaicin synthase and/or pAMT1. In an embodiment, the one or more heterologous polypeptide is or comprises capsaicin synthase, a variant thereof or a fragment thereof. In an embodiment, the capsaicin synthase (or acyltransferase) is derived from Capsicum sp. (including, but not limited to C. annuum acylsugar and having, for example, amino acid sequence of SEQ ID NO: 69 or 73). In an embodiment, the capsaicin synthase (or acyltransferase) is derived from Capsicum sp. (including, but not limited to C. frutescense and having, for example, amino acid sequence of SEQ ID NO: 70). In an embodiment, the capsaicin synthase (or acyltransferase) is derived from Solanum sp. (including, but not limited to S. lycospersicum and having, for example, amino acid sequence of SEQ ID NO: 71). In an embodiment, the capsaicin synthase (or acyltransferase) is derived from Capsicum sp. (including, but not limited to C. chacoense and having, for example, amino acid sequence of SEQ ID NO: 72). In an embodiment, the pAMT is derived from Capsicum sp. (including, but not limited to C. chinesne and having, for example, amino acid sequence of SEQ ID NO: 74 or 76). In an embodiment, the pAMT is derived from Capsicum sp. (including, but not limited to C. frutescense and having, for example, amino acid sequence of SEQ ID NO: 75). In an embodiment, the pAMT is derived from Capsicum sp. (including, but not limited to C. baccatum and having, for example, amino acid sequence of SEQ ID NO: 77). In an embodiment, the pAMT is derived from Solanum sp. (including, but not limited to S. lycospersicum and having, for example, amino acid sequence of SEQ ID NO: 78).

The heterologous polypeptide encoded by the heterologous nucleic acid molecule (either for the production of ethanol and/or for the production of the at least one flavor compound) can be a variant of a known/native polypeptide. A variant comprises at least one amino acid difference when compared to the amino acid sequence of the native polypeptide. As used herein, a variant refers to alterations in the amino acid sequence that do not adversely affect the biological functions of the polypeptide. A substitution, insertion or deletion is said to adversely affect the polypeptide when the altered sequence prevents or disrupts a biological function associated with the polypeptide. For example, the overall charge, structure or hydrophobic-hydrophilic properties of the protein can be altered without adversely affecting a biological activity. Accordingly, the amino acid sequence can be altered, for example to render the peptide more hydrophobic or hydrophilic, without adversely affecting the biological activities of the polypeptide. The polypeptide variants have at least 30%, 40%, 50%, 55%, 60%, 65%, 70%, 75%, 80%, 85%, 90%, 95%, 96%, 97%, 98% or 99% identity to the polypeptide described herein. The term “percent identity”, as known in the art, is a relationship between two or more polypeptide sequences or two or more polynucleotide sequences, as determined by comparing the sequences. The level of identity can be determined conventionally using known computer programs. Identity can be readily calculated by known methods, including but not limited to those described in: Computational Molecular Biology (Lesk, A. M., ed.) Oxford University Press, NY (1988); Biocomputing: Informatics and Genome Projects (Smith, D. W., ed.) Academic Press, NY (1993); Computer Analysis of Sequence Data, Part I (Griffin, A. M., and Griffin, H. G., eds.) Humana Press, NJ (1994); Sequence Analysis in Molecular Biology (von Heinje, G., ed.) Academic Press (1987); and Sequence Analysis Primer (Gribskov, M. and Devereux, J., eds.) Stockton Press, NY (1991). Preferred methods to determine identity are designed to give the best match between the sequences tested. Methods to determine identity and similarity are codified in publicly available computer programs. Sequence alignments and percent identity calculations may be performed using the Megalign program of the LASERGENE bioinformatics computing suite (DNASTAR Inc., Madison, Wis.).

The variant heterologous polypeptide described herein may be (i) one in which one or more of the amino acid residues are substituted with a conserved or non-conserved amino acid residue (preferably a conserved amino acid residue) and such substituted amino acid residue may or may not be one encoded by the genetic code, or (ii) one in which one or more of the amino acid residues includes a substituent group, or (iii) one in which the mature polypeptide is fused with another compound, such as a compound to increase the half-life of the polypeptide (for example, polyethylene glycol), or (iv) one in which the additional amino acids are fused to the mature polypeptide for purification of the polypeptide. A “variant” of the polypeptide can be a conservative variant or an allelic variant.

The heterologous polypeptide encoded by the heterologous nucleic acid molecule (either for the production of ethanol and/or for the production of the at least one flavor compound) can be a fragment of a known/native polypeptide. Polypeptide “fragments” have at least 100, 200, 300, 400, or more consecutive amino acids of the polypeptide. A fragment comprises at least one less amino acid residue when compared to the amino acid sequence of the known/native polypeptide and still possess the enzymatic activity of the full-length polypeptide. In some embodiments, fragments of the polypeptide can be employed for producing the corresponding full-length polypeptide by peptide synthesis. Therefore, the fragments can be employed as intermediates for producing the full-length proteins.

The recombinant host cell can be provided as a fermenting agent for making the first fermentation product. In such embodiment, the fermenting agent can include, without limitation a nutrient for the fermenting agent (for example, a carbon source).

The recombinant host cell can be provided in combination with another fermenting and non-genetically-modified organism (such as, for example, a non-genetically-modified yeast). This can be useful to reach, but not surpass, the maximal amount of the at least one flavor compound in the resulting first fermentation product. In an embodiment, the percentage (in cell weight) of the recombinant microbial host cell in the combination can be at least 10, 20, 30, 40, 50, 60, 70, 80, 90% or more. Alternatively or in combination, the percentage (in cell weight) of the non-genetically-modified microbial in the combination can be no more than 90, 80, 70, 60, 50, 40, 30, 20, 10% or less. In an embodiment, the percentage (in cell weight) of the recombinant microbial host cell in the combination can be no more than 90, 80, 70, 60, 50, 40, 30, 20, 10% or less. Alternatively of in combination, the percentage (in cell weight) of the non-genetically-modified microbial in the combination can be at least 10, 20, 30, 40, 50, 60, 70, 80, 90% or more. In such embodiment, the combination can include, without limitation a nutrient for the combination (for example, a carbon source).

### Tools for Making the Recombinant Microbial Host Cell

In order to make the recombinant microbial host cells, heterologous nucleic acid molecules (also referred to as expression cassettes) are made in vitro and introduced into the recombinant microbial host cell in order to allow the recombinant expression of the heterologous polypeptide.

The heterologous nucleic acid molecules of the present disclosure comprise a coding region for the heterologous polypeptide. A DNA or RNA “coding region” is a DNA or RNA molecule (preferably a DNA molecule) which is transcribed and/or translated into a heterologous polypeptide in a cell in vitro or in vivo when placed under the control of appropriate regulatory sequences. “Suitable regulatory regions” refer to nucleic acid regions located upstream (5′ non-coding sequences), within, or downstream (3′ non-coding sequences) of a coding region, and which influence the transcription, RNA processing or stability, or translation of the associated coding region. Regulatory regions may include promoters, translation leader sequences, RNA processing site, effector binding site and stem-loop structure. The boundaries of the coding region are determined by a start codon at the 5′ (amino) terminus and a translation stop codon at the 3′ (carboxyl) terminus. A coding region can include, but is not limited to, prokaryotic regions, cDNA from mRNA, genomic DNA molecules, synthetic DNA molecules, or RNA molecules. If the coding region is intended for expression in a eukaryotic cell (such as the recombinant microbial host cell of the present disclosure), a polyadenylation signal and transcription termination sequence will usually be located 3′ to the coding region. In an embodiment, the coding region can be referred to as an open reading frame. “Open reading frame” is abbreviated ORF and means a length of nucleic acid, either DNA, cDNA or RNA, that comprises a translation start signal or initiation codon, such as an ATG or AUG, and a termination codon and can be potentially translated into a polypeptide sequence.

The heterologous nucleic acid molecules described herein can comprise transcriptional and/or translational control regions. “Transcriptional and translational control regions” are DNA regulatory regions, such as promoters, enhancers, terminators, and the like, that provide for the expression of a coding region in a recombinant host cell. In eukaryotic cells, polyadenylation signals are considered control regions.

In some embodiments, the heterologous nucleic acid molecules of the present disclosure include a promoter as well as a coding sequence for a heterologous polypeptide. The heterologous nucleic acid sequence can also include a terminator. In the heterologous nucleic acid molecules of the present disclosure, the promoter and the terminator (when present) are operatively linked to the nucleic acid coding sequence of the heterologous polypeptide, e.g., they control the expression and the termination of expression of the nucleic acid sequence of the heterologous polypeptide. The heterologous nucleic acid molecules of the present disclosure can also include a nucleic acid coding for a signal peptide, e.g., a short peptide sequence for exporting the heterologous polypeptide outside the host cell. When present, the nucleic acid sequence coding for the signal peptide is directly located upstream and in frame of the nucleic acid sequence coding for the heterologous polypeptide.

In the heterologous nucleic acid molecule described herein, the promoter and the nucleic acid molecule coding for the heterologous polypeptide are operatively linked to one another. In the context of the present disclosure, the expressions “operatively linked” or “operatively associated” refers to fact that the promoter is physically associated to the nucleotide acid molecule coding for the heterologous polypeptide in a manner that allows, under certain conditions, for expression of the heterologous polypeptide from the nucleic acid molecule. In an embodiment, the promoter can be located upstream (5′) of the nucleic acid sequence coding for the heterologous protein. In still another embodiment, the promoter can be located downstream (3′) of the nucleic acid sequence coding for the heterologous protein. In the context of the present disclosure, one or more than one promoter can be included in the heterologous nucleic acid molecule. When more than one promoter is included in the heterologous nucleic acid molecule, each of the promoters is operatively inked to the nucleic acid sequence coding for the heterologous protein. The promoters can be located, in view of the nucleic acid molecule coding for the heterologous protein, upstream, downstream as well as both upstream and downstream.

“Promoter” refers to a DNA fragment capable of controlling the expression of a coding sequence or functional RNA. The term “expression,” as used herein, refers to the transcription and stable accumulation of sense (mRNA) from the heterologous nucleic acid molecule described herein. Expression may also refer to translation of mRNA into a polypeptide. Promoters may be derived in their entirety from a native gene, or be composed of different elements derived from different promoters found in nature, or even comprise synthetic DNA segments. It is understood by those skilled in the art that different promoters may direct the expression at different stages of development, or in response to different environmental or physiological conditions. Promoters which cause a gene to be expressed in most cells at most times at a substantial similar level are commonly referred to as “constitutive promoters”. It is further recognized that since in most cases the exact boundaries of regulatory sequences have not been completely defined, DNA fragments of different lengths may have identical promoter activity. A promoter is generally bounded at its 3′ terminus by the transcription initiation site and extends upstream (5′ direction) to include the minimum number of bases or elements necessary to initiate transcription at levels detectable above background. Within the promoter will be found a transcription initiation site (conveniently defined for example, by mapping with nuclease S1), as well as protein binding domains (consensus sequences) responsible for the binding of the polymerase.

The promoter can be native or heterologous to the nucleic acid molecule encoding the heterologous polypeptide. The promoter can be heterologous or derived from a strain being from the same genus or species as the recombinant host cell. In an embodiment, the promoter is derived from the same genus or species of the microbial host cell and the heterologous polypeptide is derived from a different genus than the host cell. The promoter can be a single promoter or a combination of different promoters.

In the context of the present disclosure, the promoter controlling the expression of the heterologous polypeptide can be a constitutive promoter (such as, for example, tef2p (e.g., the promoter of the tef2 gene), cwp2p (e.g., the promoter of the cwp2 gene), ssa1p (e.g., the promoter of the ssa1 gene), eno1p (e.g., the promoter of the eno1 gene), hxk1 (e.g., the promoter of the hxk1 gene) and pgk1p (e.g., the promoter of the pgk1 gene). In some embodiment, the promoter is adhip (e.g., the promoter of the adh1 gene). However, in some embodiments, it is preferable to limit the expression of the polypeptide. As such, the promoter controlling the expression of the heterologous polypeptide can be an inducible or modulated promoters such as, for example, a glucose-regulated promoter (e.g., the promoter of the hxt7 gene (referred to as hxt7p)) or a sulfite-regulated promoter (e.g., the promoter of the gpd2 gene (referred to as gpd2p or the promoter of the fzf1 gene (referred to as the fzf1p)), the promoter of the ssu1 gene (referred to as ssu1p), the promoter of the ssu1-r gene (referred to as ssur1-rp). In an embodiment, the promoter is an anaerobic-regulated promoters, such as, for example tdh1p (e.g., the promoter of the tdh1 gene), pau5p (e.g., the promoter of the pau5 gene), hor7p (e.g., the promoter of the hor7 gene), adh1p (e.g., the promoter of the adh1 gene), tdh2p (e.g., the promoter of the tdh2 gene), tdh3p (e.g., the promoter of the tdh3 gene), gpd1p (e.g., the promoter of the gdp1 gene), cdc19p (e.g., the promoter of the cdc19 gene), eno2p (e.g., the promoter of the eno2 gene), pdc1p (e.g., the promoter of the pdc1 gene), hxt3p (e.g., the promoter of the hxt3 gene), dan1 (e.g., the promoter of the dan1 gene) and tpi1p (e.g., the promoter of the tpi1 gene). In an embodiment, the promoter used to allow the expression of the heterologous polypeptide is the adhip. One or more promoters can be used to allow the expression of each heterologous polypeptides in the recombinant microbial host cell.

One or more promoters can be used to allow the expression of each heterologous polypeptide in the recombinant microbial host cell. In the context of the present disclosure, the expression “functional fragment of a promoter” when used in combination to a promoter refers to a shorter nucleic acid sequence than the native promoter which retains the ability to control the expression of the nucleic acid sequence encoding the heterologous polypeptide. Usually, functional fragments are either 5′ and/or 3′ truncation of one or more nucleic acid residue from the native promoter nucleic acid sequence.

In some embodiments, the nucleic acid molecules include a one or a combination of terminator sequence(s) to end the translation of the heterologous polypeptide. The terminator can be native or heterologous to the nucleic acid sequence encoding the heterologous polypeptide. In some embodiments, one or more terminators can be used. In some embodiments, the terminator comprises the terminator derived from is from the dit1 gene, from the idp1 gene, from the gpm1 gene, from the pma1 gene, from the tdh3 gene, from the hxt2 gene, from the adh3 gene, from the cyc1 gene, from the pgk1 gene and/or from the ira2 gene. In the context of the present disclosure, the expression “functional variant of a terminator” refers to a nucleic acid sequence that has been substituted in at least one nucleic acid position when compared to the native terminator which retain the ability to end the expression of the nucleic acid sequence coding for the heterologous protein. In the context of the present disclosure, the expression “functional fragment of a terminator” refers to a shorter nucleic acid sequence than the native terminator which retain the ability to end the expression of the nucleic acid sequence coding for the heterologous protein.

The heterologous nucleic acid molecule encoding the one or more heterologous polypeptide, variant or fragment thereof can be integrated in the genome of the microbial host cell. The term “integrated” as used herein refers to genetic elements that are placed, through molecular biology techniques, into the genome of a host cell. For example, genetic elements can be placed into the chromosomes of the host cell as opposed to in a vector such as a plasmid carried by the host cell. Methods for integrating genetic elements into the genome of a host cell are well known in the art and include homologous recombination. The heterologous nucleic acid molecule can be present in one or more copies in the microbial host cell's genome. Alternatively, the heterologous nucleic acid molecule can be independently replicating from the microbial's genome. In such embodiment, the nucleic acid molecule can be stable and self-replicating.

The present disclosure also provides nucleic acid molecules for modifying the microbial host cell so as to allow the expression of the one or more heterologous polypeptide, variants or fragments thereof. The nucleic acid molecule may be DNA (such as complementary DNA, synthetic DNA or genomic DNA) or RNA (which includes synthetic RNA) and can be provided in a single stranded (in either the sense or the antisense strand) or a double stranded form. The contemplated nucleic acid molecules can include alterations in the coding regions, non-coding regions, or both. Examples are nucleic acid molecule variants containing alterations which produce silent substitutions, additions, or deletions, but do not alter the properties or activities of the encoded polypeptide, variants or fragments.

In some embodiments, the heterologous nucleic acid molecules which can be introduced into the recombinant host cells are codon-optimized with respect to the intended recipient recombinant microbial host cell. As used herein the term “codon-optimized coding region” means a nucleic acid coding region that has been adapted for expression in the cells of a given organism by replacing at least one, or more than one, codons with one or more codons that are more frequently used in the genes of that organism. In general, highly expressed genes in an organism are biased towards codons that are recognized by the most abundant tRNA species in that organism. One measure of this bias is the “codon adaptation index” or “CAI,” which measures the extent to which the codons used to encode each amino acid in a particular gene are those which occur most frequently in a reference set of highly expressed genes from an organism. The CAI of codon optimized heterologous nucleic acid molecule described herein corresponds to between about 0.8 and 1.0, between about 0.8 and 0.9, or about 1.0.

The heterologous nucleic acid molecules can be introduced in the microbial host cell using a vector. A “vector,” e.g., a “plasmid”, “cosmid” or “artificial chromosome” (such as, for example, a yeast artificial chromosome) refers to an extra chromosomal element and is usually in the form of a circular double-stranded DNA molecule. Such vectors may be autonomously replicating sequences, genome integrating sequences, phage or nucleotide sequences, linear, circular, or supercoiled, of a single- or double-stranded DNA or RNA, derived from any source, in which a number of nucleotide sequences have been joined or recombined into a unique construction which is capable of introducing a promoter fragment and DNA sequence for a selected gene product along with appropriate 3′ untranslated sequence into a cell.

The present disclosure also provides heterologous nucleic acid molecules that are hybridizable to the complementary nucleic acid molecules encoding the heterologous polypeptides as well as variants or fragments. A nucleic acid molecule is “hybridizable” to another nucleic acid molecule, such as a cDNA, genomic DNA, or RNA, when a single stranded form of the nucleic acid molecule can anneal to the other nucleic acid molecule under the appropriate conditions of temperature and solution ionic strength. Hybridization and washing conditions are well known and exemplified, e.g., in Sambrook, J., Fritsch, E. F. and Maniatis, T. MOLECULAR CLONING: A LABORATORY MANUAL, Second Edition, Cold Spring Harbor Laboratory Press, Cold Spring Harbor (1989), particularly Chapter 11 and Table 11.1 therein. The conditions of temperature and ionic strength determine the “stringency” of the hybridization. Stringency conditions can be adjusted to screen for moderately similar fragments, such as homologous sequences from distantly related organisms, to highly similar fragments, such as genes that duplicate functional enzymes from closely related organisms. Post-hybridization washes determine stringency conditions. One set of conditions uses a series of washes starting with 6×SSC, 0.5% SDS at room temperature for 15 min, then repeated with 2×SSC, 0.5% SDS at 45° C. for 30 min, and then repeated twice with 0.2×SSC, 0.5% SDS at 50° C. for 30 min. For more stringent conditions, washes are performed at higher temperatures in which the washes are identical to those above except for the temperature of the final two 30 min washes in 0.2×SSC, 0.5% SDS are increased to 60° C. Another set of highly stringent conditions uses two final washes in 0.1×SSC, 0.1% SDS at 65° C. An additional set of highly stringent conditions are defined by hybridization at 0.1×SSC, 0.1% SDS, 65° C. and washed with 2×SSC, 0.1% SDS followed by 0.1×SSC, 0.1% SDS.

Hybridization requires that the two nucleic acid molecules contain complementary sequences, although depending on the stringency of the hybridization, mismatches between bases are possible. The appropriate stringency for hybridizing nucleic acids depends on the length of the nucleic acids and the degree of complementation, variables well known in the art. The greater the degree of similarity or homology between two nucleotide sequences, the greater the value of Tm for hybrids of nucleic acids having those sequences. The relative stability (corresponding to higher Tm) of nucleic acid hybridizations decreases in the following order: RNA:RNA, DNA:RNA, DNA:DNA. For hybrids of greater than 100 nucleotides in length, equations for calculating Tm have been derived. For hybridizations with shorter nucleic acids, i.e., oligonucleotides, the position of mismatches becomes more important, and the length of the oligonucleotide determines its specificity. In one embodiment the length for a hybridizable nucleic acid is at least about 10 nucleotides. Preferably a minimum length for a hybridizable nucleic acid is at least about 15 nucleotides; more preferably at least about 20 nucleotides; and most preferably the length is at least 30 nucleotides. Furthermore, the skilled artisan will recognize that the temperature and wash solution salt concentration may be adjusted as necessary according to factors such as length of the probe.

### Processes for Making the First Fermentation Product

The recombinant microbial host cell of the present disclosure have been designed to be used in the preparation of the first fermentation product. The present disclosure thus provides a process comprising contacting the recombinant microbial host cell of the present disclosure with a carbohydrate to provide a mixture and fermenting the mixture so as to obtain at most 3% v/w of the at least one flavor compound and at least 5 g/L of ethanol once the carbohydrates have been converted. The fermentation can be conducted in the presence of or by the recombinant microbial host cell described herein. In some embodiments, it may be advantageous to provide the recombinant microbial host cell of the present disclosure as a fermentation agent. In one embodiment, a fermenting agent for making the first fermentation product comprising or consisting essentially of the recombinant microbial host cell described herein. As used herein, “consisting essentially of” in reference to a fermenting agent refers to a population of fermenting organisms which do not include a substantial amount of additional fermenting or flavoring organisms which participate to the fermentation process. In an embodiment, a fermenting agent consisting essentially of the recombinant microbial host cell of the present disclosure is made up of at least 80%, 85%, 90%, 95%, 99%, or 99.9% of the recombinant microbial host cell described herein. In still another embodiment, a fermenting agent consisting essentially of the recombinant microbial host cell of the present disclosure is a monoculture of one strain of a recombinant microbial host cell. Alternatively, a fermenting agent consisting essentially of the recombinant microbial host cell of the present disclosure is a combination of more than one strains of the recombinant microbial host cell described herein.

In a specific embodiment, the recombinant host cell can be provided in combination with another fermenting and non-genetically-modified organism (such as, for example, a non-genetically-modified microbial). The combination can be useful to reach, but not surpass, the maximal amount of the flavor compound in the resulting first fermentation product. In an embodiment, the percentage (in cell weight) of the recombinant microbial host cell in the combination can be at least 10, 20, 30, 40, 50, 60, 70, 80, 90% or more. Alternatively or in combination, the percentage (in cell weight) of the non-genetically-modified microbial in the combination can be no more than 90, 80, 70,60,50,40,30,20, 10% or less. In an embodiment, the percentage (in cell weight) of the recombinant microbial host cell in the combination can be no more than 90, 80, 70, 60, 50, 40, 30, 20, 10% or less. Alternatively of in combination, the percentage (in cell weight) of the non-genetically-modified microbial in the combination can be at least 10, 20, 30, 40, 50, 60, 70, 80, 90% or more. In such embodiment, the combination can include, without limitation a nutrient for the combination (for example, a carbon source).

In an embodiment, the recombinant microbial host cell of the present disclosure can be used in a distilling process. In such embodiment, the process includes contacting the recombinant microbial host cell (alone or in a combination) of the present disclosure with a carbohydrate source to create a mixture, fermenting the mixture and distilling the fermented mixture.

The present invention will be more readily understood by referring to the following examples which are given to illustrate the invention rather than to limit its scope.

### Example I—Production of Flavored Solution by Fermentation

### Heterologous Expression of Flavor by a Recombinant Yeast Host Cell:

TABLE 5
Genotypes of the strains used in the examples.

| Designation | Polypeptides overexpressed |
|---|---|
| A-1 | Alcohol O-acetyltransferase (ATF1) from S. cerevisiae |
| | (SEQ ID NO: 50) under the control of the ADH1p |
| B-1 | Phenylalanine ammonia-lyase (PAL) from Rhodotorula toruloides |
| | (SEQ ID NO: 79) under the control of the adh1p; |
| | Cinnamate-4-hydroxylase (4CH) from Arabidopsis thaliana |
| | (SEQ ID NO: 80) under the control of the tdh1p; |
| | Chimeric fusion between Coumarate-CoA ligase (4CL2) from |
| | Petroselinum crispum (SEQ ID NO: 84)) and Benzalacetone |
| | synthase (BAS) from Rheum palmatum (SEQ ID NO: 60) under the |
| | control of the tef2p with linker (SEQ ID NO: 85); |
| | (Chimeric amino acid sequence for the fusion protein |
| | SEQ ID NO: 82). |
| C-1 | Lactate dehydrogenase from Rhizopus oryzae (SEQ ID |
| | NO: 2) under the control of the ADH1p; |

Isoamyl Acetate Flavored Solution Derived from Fermentation of Strain A-1:

### Mashing

Target mash thickness was set at 22° Brix and achieved by using 300 kg milled grains (77% corn, 15% rye and 8% malted barley) in ˜950 L total volume at 55° C. The cook process made use of 150 mL of DistilaZyme® AA (alpha-amylase) to break starch (65.5° C. for 45 minutes, then heat to 84° C. for 90 minutes).

### Fermentation

The mash was cooled to 30° C. and the fermentation protocol followed a delayed simultaneous saccharification and fermentation (DSSF) strategy with 155 ppm DistilaZyme® glucoamylase (GA) added 24 hours after yeast pitch. The A-1 yeast strain was pitched as 2.5 L of stabilized liquid yeast into 950 L of mash. The nutrients DistilaVite® GN (150 ppm) and diammonium phosphate (DAP, 100 ppm) were added 2 and 24 hours after yeast pitching, respectively. The fermentation was maintained under 34° C. and completed within 72 hours.

### Distillation

The distillation comprised a 300 L hybrid still design and employed a pot only style distillation for wash to low wines production followed by the same pot combined with a 4-tray column for the distillation of the low wines to spirit.

The fermented wash was split into three batches that were distilled to produce three batches of low wines. The three batches of low wines were combined and further distilled to collect 15 L of heads cut, ˜80 L of heart cut and ˜45 L of a first tails cut. The procedure was performed twice to obtain enough volume to fill a 200 L barrel for conditioning. The heart cut from the first distillation (57 L at 78.5% ABV), the heart cut from the second distillation (57 L at 83.5% ABV) and the first tail cut (49 L at 75.7% ABV) were combined and then diluted with potable water to achieve 204 L of distillate at 63.5% ABV, containing 171 g/100 L absolute alcohol (A.A.) of isoamyl acetate, 477 g/100 L A.A. of ethyl acetate and 58 g/100 L A.A. of 2-phenylethyl acetate. This distillate was used as flavored solution in the following examples (examples II, Ill and IV).

4-(4-Hydroxyphenyl)-2-butanone (Raspberry Ketone) Flavored Solution Derived from Fermentation of Strain B-1:

### Fermentation

Laboratory-scale whisky fermentations were carried out in 1 L flasks charged with 600 g of bourbon mash at 1.0863 specific gravity supplemented with 100 ppm of the raspberry ketone precursor coumaric acid. B-1 yeast was pitched at 0.35 g DCW/L (grams of dry cell weight per liter) from spun down overnight YPD (yeast extract, peptone, dextrose medium) cultures resuspended in sterile tap water. The fermentation protocol followed a simultaneous saccharification and fermentation (SSF) strategy with 0.340 μl/gDS (microliters per grams of dry solids) of DistilaZyme™ GA glucoamylase added at the beginning of fermentation. Diammonium phosphate (DAP, 1094 ppm) was added as an extra source of nitrogen, Incubation was carried out for 72 hours (until final gravity ˜1.002) at 30° C. and 150 rpm. The fermentation wash was stored at −20° C. until distillation.

### Distillation

Single distillation was performed using a glass distillation system where a 1 L round bottom flask (RBF) was connected to a lyne arm followed by a condenser to simulate a pot distillation. A volume of 0.5 L of wash was loaded into the 1 L RBF and a total of 17 g of copper wool was used at various points throughout the system. The condenser was chilled using a temperature-controlled recirculation system, set to 10° C. The heating source for the RBF was a 1 L heating and stirring mantle (Cole-Palmer 115 VAC). The distillate (approximately 185 mL) was collected until the ethanol concentration of the condensate reached 1% ABV. The final ethanol concentration in the distillate was 32% ABV. This distillate was used as flavored solution in example IV.

Ethyl Lactate Flavored Solution Derived from Fermentation of Strain C-1:

### Fermentation

Laboratory-scale malted barley fermentations was carried out in 1 L flasks charged with 600 g of malted barley wort at 1.0613 specific gravity. C-1 yeast was pitched at 1 g DCW/L from spun down overnight YPD cultures resuspended in sterile tap water. DistilaZyme™ GA glucoamylase was added at a dosage of 0.051 μl/gDS at the beginning of fermentation. Incubation was carried out for 72 hours (until final gravity <1.010) at 30° C. and 150 rpm. The fermentation wash was stored at −20° C. until distillation. C-1 yeast produces lactic acid during fermentation, which is then converted to ethyl lactate during distillation.

### Distillation

Single distillation was performed using a glass distillation system where a 1 L round bottom flask (RBF) was connected to a lyne arm followed by a condenser to simulate a pot distillation. A volume of 0.5 L of wash was loaded into the 1 L RBF and a total of 17 g of copper wool was used at various points throughout the system. The condenser was chilled using a temperature-controlled recirculation system, set to 10° C. The heating source for the RBF was a 1 L heating and stirring mantle (Cole-Palmer 115 VAC). The distillate (approximately 140 mL) was collected until the ethanol concentration of the condensate reached 1% ABV. The final ethanol of the distillate was 25% ABV. This distillate was used as flavored solution example IV.

Control Solution from Fermentation with the A-1 Non-Engineered Parental Strain Mashing

Target mash thickness was set at 22° Brix and achieved by using 300 kg milled grains (77% corn, 15% rye and 8% malted barley) in ˜950 L total volume at 55° C. The cook process made use of 150 mL of DistilaZyme® AA (alpha-amylase) to break starch (65.5° C. for 45 minutes, then heat to 84° C. for 90 minutes).

### Fermentation

The mash was cooled to 30° C. and the fermentation protocol followed a delayed simultaneous saccharification and fermentation (DSSF) strategy with 155 ppm DistilaZyme® GA (glucoamylase) added 24 hours after yeast pitch. The A-1 non-engineered parental yeast was pitched as 2.5 L of stabilized liquid yeast into 950 L of mash. The nutrients DistilaVite® GN (150 ppm) and diammonium sulphate (DAP, 100 ppm) were added 2 and 24 hours after yeast pitching, respectively. The fermentation was maintained under 34° C. and completed within 72 hours.

### Distillation

The distillation comprised a 300 L hybrid still design and employed a pot only style distillation for wash to low wines production followed by the same pot combined with a 4-tray column for the distillation of the low wines to spirit.

The fermented wash was split into three batches that were distilled to produce three batches of low wines. The three batches of low wines were combined and further distilled to collect 15 L of heads cut, ˜80 L of heart cut and ˜49 L of a first tails cut. The procedure was performed twice to obtain enough volume to fill a 200 L barrel for conditioning. The heart cut from the first distillation (57 L at 77.8% ABV), the heart cut from the second distillation (57 L at 82.8% ABV) and the first tails cut from the second distillation (49 L at 72.8% ABV) were combined and then diluted with potable water to achieve 204 L of distillate at 63.5% ABV and 2.3 g/100 L A.A. of isoamyl acetate, 10.2 g/100 L A.A. of ethyl acetate and 0.3 g/100 L A.A. of 2-phenylethyl acetate. This distillate was used as control solution in the following examples (examples II, III and IV).

Control Solution from Fermentation with the B-1 Non-Engineered Parental Strain

### Fermentation

Laboratory-scale whisky fermentation was carried out in 1 L flasks charged with 600 g of bourbon mash at 1.0863 specific gravity supplemented with 100 ppm of coumaric acid. The B-1 non-engineered parental yeast was pitched at 0.35 g DCW/L from spun down overnight YPD cultures resuspended in sterile tap water. The fermentation protocol followed a simultaneous saccharification and fermentation (SSF) strategy with 0.340 μl/gDS of DistilaZyme™ GA glucoamylase added at the beginning of fermentation. Diammonium sulphate (DAP, 1094 ppm) was added as an extra source of nitrogen, Incubation was carried out for approximately 72 hours (until final gravity ˜1.002) at 30° C. and 150 rpm. The fermentation wash was stored at −20° C. until distillation. The B-1 non-engineered yeast does not produce raspberry ketone from coumaric acid.

### Distillation

Single distillation was performed using a glass distillation system where a 1 L round bottom flask (RBF) was connected to a lyne arm followed by a condenser to simulate a pot distillation. A volume of 0.5 L of wash was loaded into the 1 L RBF and a total of 17 g of copper wool was used at various points throughout the system. The condenser was chilled using a temperature-controlled recirculation system, set to 10° C. The heating source for the RBF was a 1 L heating and stirring mantle (Cole-Palmer 115 VAC). The distillate (approximately 185 mL) was collected until the ethanol concentration of the condensate reached 1% ABV. The final ethanol of the distillate was 33% ABV. This distillate was used as control solution in example IV.

Control Solution from Fermentation with the C-1 Non-Engineered Parental Strain

### Fermentation

Laboratory-scale malted barley fermentation was carried out in 1 L flasks charged with 600 g of malted barley wort at 1.0613 specific gravity. The C-1 non-engineered yeast was pitched at 1 g DCW/L from spun down overnight YPD cultures resuspended in sterile tap water. DistilaZyme™ GA glucoamylase was added at a dosage of 0.051 μl/gDS at the beginning of fermentation. Incubation was carried out for approximately 72 hours (until final gravity <1.010) at 30° C. and 150 rpm. The fermentation wash was stored at −20° C. until distillation.

### Distillation

Single distillation was performed using a glass distillation system where a 1 L round bottom flask (RBF) was connected to a lyne arm followed by a condenser to simulate a pot distillation. A volume of 0.5 L of wash was loaded into the 1 L RBF and a total of 17 g of copper wool was used at various points throughout the system. The condenser was chilled using a temperature-controlled recirculation system, set to 10° C. The heating source for the RBF was a 1 L heating and stirring mantle (Cole-Palmer 115 VAC). The distillate (approximately 165 mL) was collected until the ethanol concentration of the condensate reached 1% ABV. The final ethanol of the distillate was 25.5% ABV. This distillate was used as control solution in example IV.

### Example II—200 L Cask Assay—Isoamyl Acetate Flavored Whiskey

Two 200 L ex-Bourbon oak single-fill casks were filled with spirit produced with either strain A-1 (cask M1), or with A-1 parental strain (control cask C1), as prepared in example I. Both casks were disgorged after 18 weeks to obtain the treated barrels. During the conditioning 11.5 g/100 L A.A. of isoamyl acetate (−7%) were lost in the M1 cask and 0.6 g/100 L A.A. (−27%) were lost in the C1 control cask due to evaporation, absorption by the cask and in drink liquid.

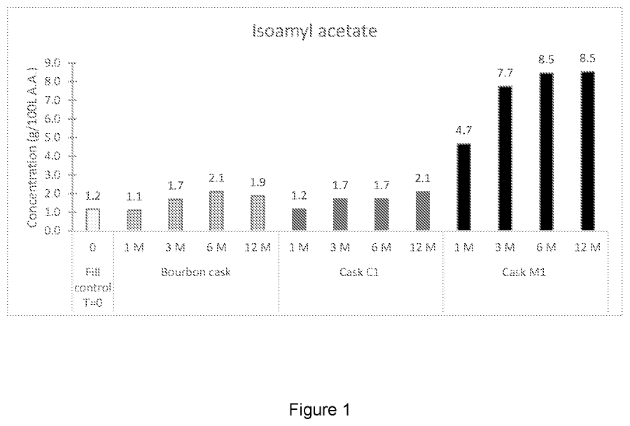

The two treated barrels, and a third untreated ex-Bourbon oak single-fill cask used as additional control, were filled with malt Scotch new-make spirit for maturation (63.5% ABV; 1.2 g/100L A.A. of isoamyl acetate, 21.1 g/100L A.A. of ethyl acetate and 0.7 g/100L of 2-phenylethyl acetate) and were stored in a whisky warehouse at room temperature. To evaluate the effect of the treated barrels on the aging product, a sample was taken from each cask after 1, 3, 6 and 12 months of aging and was subjected to chemical analysis (gas chromatography, see method section below) for flavor compounds (congeners) quantification. (FIG. 1; Table 6).

### Methods

### Gas Chromatography (GC-FID)

Congener quantification (esters, higher alcohols, aldehydes and acetal) was performed using an Agilent 7820A gas chromatography (GC) system coupled with a 7697A headspace (HS) auto sampler and equipped with a flame ionization detector (FID). The headspace heating zone was maintained at 80° C., the loop at 110° C. and the transfer line at 120° C. A CP-Wax 57 CB Agilent column (50 m×0.25 mm×0.2 μm) was used for chromatography separation. The carrier gas was high purity hydrogen with a constant flow rate of 4 mL/min. The injector was set at 220° C. and the split ratio to 30:1. The oven temperature was set at an initial temperature of 40° C., held for 2 min, raised at 10° C./min to 120° C., held for 10 min, raised at 70° C./min to 200° C. and held for 5 min the total run time was 26 min. The detector temperature was set at 300° C. 2-Pentanol at 160 ppm was used as an internal standard. Samples were loaded as 100 μL aliquots to 20 mL crimp-top headspace vials (23×75 mm) containing 0.5*0.05 g of sodium chloride. Data was normalized to g/100 L of absolute alcohol (g/100L A.A.) for analysis.

### Results

Samples for quantitative chemical analysis (HS-GC-FID) were taken to assess the concentration differences of congeners (flavor compounds) from the treated casks (FIG. 1 and Table 6):
Untreated Bourbon cask control: ex-Bourbon single fill cask (control) used as a non-treated control.
C1 control cask: ex-Bourbon single fill cask, treated with whisky distillate obtained from the A-1 non-engineered parental strain.
M1 casks: ex-Bourbon single fill cask, treated with isoamyl acetate flavored distillate from strain A-1.

At 12 months, the whisky aged in the M1 cask had 4 times more isoamyl acetate (8.5 g/100L A.A.) than the whisky aged in the C1 (2.1 g/100L A.A) and in the Bourbon cask control (1.91 g/100L AA) (FIG. 1; Table 6). In general, the M1 samples had significantly higher acetate esters (isoamyl acetate, ethyl acetate and phenethyl acetate) than the two control casks at all sampling times. (FIG. 1; Table 6).

TABLE 6
Chemical analysis of the distillates used for the conditioning step (top section) and obtained after the maturation
step (bottom section). The conditioning section provides the chemical analysis of the distillates used for the 18
week conditioning step (conditioning fill of cask C1 or M1). The maturation section provides the chemical analysis
of the fill distillate (e.g., ethanol 63.5% ABV) either prior to (T = 0) or after 1, 3, 6, 9 and 12 months
of maturation (in Bourbon cask control, control cask C1 or flavor cask M1). Data is in g/100 L of absolute alcohol.

Concentration (g/100 L absolute alcohol)

| | | | | | | | | |
|---|---|---|---|---|---|---|---|---|
| Sample | Conditioning | Maturation | Ethanol | | Ethyl | | | |
| Description | Time | time | % abv | Acetaldehyde | acetate | Acetal | Methanol | 1-Propanol |

200 L CASK CONDITIONING SOLUTION

| | | | | | | | | |
|---|---|---|---|---|---|---|---|---|
| Control Cask C1 Fill | NA | NA | 63.5 | 7.0 | 10.2 | 1.4 | 5.2 | 39.5 |
| Flavor Cask M1 Fill | NA | NA | 63.5 | 6.7 | 477 | 4.0 | 9.5 | 31.8 |

DISTILLATE MATURATION

| Fill Control T = 0 | NA | 0 | | 63.5 | 1.8 | 21.1 | 1.6 | 5.0 | 17.1 |
|---|---|---|---|---|---|---|---|---|---|
| Bourbon Cask | NA | 1 | MONTH | 63.5 | 2.0 | 21.9 | 1.6 | 4.9 | 16.6 |
| Cask C1 | 18 WEEKS | 1 | MONTH | 63.5 | 2.3 | 21.5 | 1.8 | 5.2 | 18.0 |
| Cask M1 | 18 WEEKS | 1 | MONTH | 63.5 | 2.1 | 33.4 | 1.6 | 5.0 | 16.9 |
| Bourbon Cask | NA | 3 | MONTHS | 62.1 | 2.2 | 26.5 | 2.9 | 5.7 | 19.2 |
| Cask C1 | 18 WEEKS | 3 | MONTHS | 62.8 | 2.3 | 24.5 | 3.2 | 5.6 | 19.8 |
| Cask M1 | 18 WEEKS | 3 | MONTHS | 63 | 2.8 | 45.9 | 3.2 | 5.8 | 19.0 |
| Bourbon Cask | NA | 6 | MONTHS | 62 | 2.4 | 28.3 | 3.4 | 5.5 | 19.0 |
| Cask C1 | 18 WEEKS | 6 | MONTHS | 63.2 | 2.4 | 23.7 | 3.3 | 5.5 | 19.7 |
| Cask M1 | 18 WEEKS | 6 | MONTHS | 62.7 | 2.4 | 49.3 | 3.7 | 6.0 | 19.8 |
| Bourbon Cask | NA | 12 | MONTHS | 62.6 | 2.5 | 28.9 | 3.5 | 5.9 | 19.5 |
| Cask C1 | 18 WEEKS | 12 | MONTHS | 62.7 | 2.6 | 26.3 | 3.7 | 6.0 | 20.7 |
| Cask M1 | 18 WEEKS | 12 | MONTHS | 61.5 | 2.4 | 46.7 | 3.5 | 5.9 | 19.8 |

| | Concentration (g/100 L absolute alcohol) | | | | | | | | |
|---|---|---|---|---|---|---|---|---|---|
| Sample | | Isoamyl | | 2-Methyl- | 3-Methyl- | Ethyl | Ethyl | Ethyl | Phenethyl |
| Description | Isobutanol | acetate | 1-Butanol | 1-butanol | 1-butanol | hexanoate | Octanoate | decanoate | acetate |
| | 200 L CASK CONDITIONING SOLUTION | | | | | | | | |
| Control Cask C1 Fill | 66.2 | 2.3 | 3.3 | 111 | 269 | <LOD | 1.5 | 1.4 | 0.3 |
| Flavor Cask M1 Fill | 54.7 | 171 | 2.3 | 68.9 | 61.8 | 0.3 | 1.1 | 1.3 | 57.7 |
| | DISTILLATE MATURATION | | | | | | | | |
| Fill Control T = 0 | 60.5 | 1.2 | 0.3 | 59.2 | 141 | 0.3 | 2.1 | 7.2 | 0.7 |
| Bourbon Cask | 58.2 | 1.1 | 0.3 | 57.2 | 137 | 0.3 | 2.1 | 6.9 | 0.6 |
| Cask C1 | 60.0 | 1.2 | 0.4 | 58.1 | 142 | 0.3 | 2.1 | 6.7 | 0.6 |
| Cask M1 | 59.2 | 4.7 | 0.3 | 57.5 | 134 | 0.3 | 2.1 | 6.8 | 2.7 |
| Bourbon Cask | 69.8 | 1.7 | 0.9 | 67.2 | 172 | 0.4 | 2.5 | 9.5 | 0.8 |
| Cask C1 | 68.9 | 1.7 | 0.9 | 65.4 | 169 | 0.4 | 2.5 | 9.3 | 0.8 |
| Cask M1 | 67.1 | 7.7 | 0.8 | 60.4 | 149 | 0.4 | 2.3 | 7.3 | 2.9 |
| Bourbon Cask | 69.5 | 2.1 | 0.9 | 66.2 | 167 | 0.4 | 2.6 | 8.7 | 0.8 |
| Cask C1 | 68.2 | 1.7 | 1.0 | 65.0 | 166 | 0.3 | 2.4 | 8.5 | 0.6 |
| Cask M1 | 70.2 | 8.5 | 0.9 | 64.3 | 160 | 0.5 | 2.5 | 8.7 | 4.1 |
| Bourbon Cask | 71.4 | 1.9 | 0.9 | 68.1 | 168 | 0.4 | 2.6 | 9.1 | 0.6 |
| Cask C1 | 71.7 | 2.1 | 1.0 | 66.4 | 168 | 0.4 | 2.5 | 7.9 | 0.6 |
| Cask M1 | 69.8 | 8.5 | 1.0 | 66.8 | 168 | 0.4 | 2.6 | 9.8 | 4.8 |

NA means not applicable; <LOD means inferior to the limit of detection.

### Example III—1 L Cask Assay

Two 1 L American oak casks charred to level 2-3 were filled with conditioning spirits produced with either strain A-1 (flavor distillate fill A-1), or with A-1 non-engineered parental strain (control fill A-1), as prepared in example I. The casks were treated for three weeks, then disgorged to obtain the treated casks (control cask A-1 and flavor cask A-1). Chemical analysis of the distillates used for the conditioning step is shown in Table 7.

Two other 1 L American oak casks charred to level 2-3 were filled with an ethanol solution at 63.5% ABV (control fill cask 1), or a flavour spiked solution (spike fill cask 2). The spiked solution was prepared by addition of the volatile compounds ethyl acetate (17.5 g/100L A.A; fruity), ethyl decanoate (10.6 g/100L AA; fruity, red apple, floral), isoamyl acetate (14.1 g/100L A.A.; banana, pear drops) and vanillin (16.5 g/100L A.A., vanilla), as well as the non-volatile carbohydrates galactose (1045 g/100L AA, sweet flavor) and sucrose (1164 g/100L A.A, sweet flavor) in an ethanol solution at 63.5% ABV. The casks were treated for three weeks, then disgorged to obtain the treated casks (control cask 1 and spike cask 2). Chemical analysis of the distillates used for the conditioning step is shown in Table 8.

The treated casks were then filled with an ethanol solution at 63.5% ABV for maturation and were stored at room temperature. To evaluate the effect of the treated casks on the aging product, samples were withdrawn from the casks after 1 week and subjected to chemical analysis for flavor compound (congener) quantification (Tables 7 and 8). Ethyl acetate, isoamyl acetate and ethyl decanoate were measured by gas chromatography (GC-FID) as described in example II. Vanillin was measured by high pressure liquid chromatography (HPLC-UV) as described in the method section below. Galactose and sucrose were measured by ion chromatography (IC-PAED), as described in the method section below.

### Methods

### Ion Chromatography (IC-PAED)

Galactose and sucrose were quantified using ion chromatography coupled with pulsed amperometric electrochemical detection with a disposable gold electrode (IC-PAED). A Dionex CarboPac PA10 column was used at flowrate of 0.3 mL/min and 100 mM potassium hydroxide was used as mobile phase. Run time was approximately 50 min plus a 15 min equilibration period.

### Liquid Chromatography (HPLC-UV)

Vanillin quantification was performed using high pressure liquid chromatography coupled with ultraviolet detection (HPLC-UV). Carbohydratess were separated on a YMC carotenoid column (CT99S031546W) held at 40° C. and using a 0.1% formic acid/acetonitrile mobile phase ramped from 10% to 100% acetonitrile over 25 min. Flow rate was 0.5 mL/min. Vanillin was detected at 320 nm.

### Results

After 1 week of maturation, the fill distillate (63.5% ABV) aged in the A-1 flavor cask had 73 times more isoamyl acetate (10.7 g/100L A.A.) than the control (0.1 g/100L AA), 19 times more ethyl acetate (40 g/100L AA.) than the control (2.1 g/100L A.A) and 4.6 g/100L A.A. of 2-phenethylethyl acetate compared to none in the control (inferior to the limit of detection) as demonstrated in the maturation section of Table 7. After 4 weeks of maturation, the fill distilate (63.5% ABV) aged in the A-1 flavor cask had 45 times more isoamyl acetate (13.4 g/100L A.A.) than the control (0.3 g/100L AA), 12 times more ethyl acetate (42.6 g/100L A.A.) than the control (3.4 g/100L AA) and 7.7 g/100L A.A. of 2-phenethylethyl acetate compared to none in the control (inferior to the limit of detection)(Table 7, maturation section).

After 1 and 4 week aging times, the fill distillate (63.5% ABV) aged in the spiked cask demonstrated significantly higher concentrations of all the compounds spiked compared to the control cask as demonstrated in Table 8.

TABLE 7
Chemical analysis of the distillates used for the conditioning step (top section) and obtained after the maturation
step (bottom section). The conditioning section provides the chemical analysis of the distillates used for the
3 week conditioning step (control fill A-1 or flavor distillate fill A-1). The maturation section provides the
chemical analysis of the fill distillate (e.g, ethanol 63.5% ABV) either prior to (T = 0) or after 1 and
4 weeks of maturation (in control cask A-1 or flavor cask A-1). Data is in g/100 L of absolute alcohol.

| | | | Concentration (g/100 L absolute alcohol) | | | | | |
|---|---|---|---|---|---|---|---|---|
| Sample | Conditioning | Maturation | | Ethyl | | | | |
| Description | Time | time | Acetaldehyde | acetate | Acetal | Methanol | 1-Propanol | Isobutanol |

1 L CASK CONDITIONING SOLUTION

| | | | | | | | | |
|---|---|---|---|---|---|---|---|---|
| Control Fill A-1 | NA | NA | 7.0 | 10.2 | 1.4 | 5.2 | 39.5 | 66.2 |
| Flavor Distillate Fill (A-1) | NA | NA | 6.7 | 477.2 | 4.0 | 9.5 | 31.8 | 54.7 |

DISTILLATE MATURATION

| | | | | | | | | |
|---|---|---|---|---|---|---|---|---|
| Fill Distillate | NA | 0.0 | 0.7 | 0.7 | <LOD | <LOD | 1.2 | 1.2 |
| (ethanol 63.5% ABV) | | | | | | | | |
| Control | 3 WEEKS | 1 WEEK | 1.3 | 2.1 | <LOD | 1.3 | 4.6 | 5.1 |
| Cask A-1 | | | | | | | | |
| Flavor Cask A-1 | 3 WEEKS | 1 WEEK | 1.2 | 39.9 | 0.3 | 1.6 | 3.2 | 4.4 |
| Control | 3 WEEKS | 4 WEEKS | 1.7 | 3.4 | 0.7 | 1.9 | 4.2 | 6.8 |
| Cask A1 | | | | | | | | |
| Flavor Cask A-1 | 3 WEEKS | 4 WEEKS | 1.5 | 42.6 | 1.1 | 2.0 | 3.8 | 5.6 |

| | Concentration (g/100 L absolute alcohol) | | | | | | | |
|---|---|---|---|---|---|---|---|---|
| Sample | Isoamyl | | 2-Methyl- | 3-Methyl- | Ethyl | Ethyl | Ethyl | 2-Phenethyl |
| Description | acetate | 1-Butanol | 1-butanol | 1-butanol | hexanoate | octanoate | decanoate | acetate |
| | 1 L CASK CONDITIONING SOLUTION | | | | | | | |
| Control Fill A-1 | 2.3 | 3.3 | 110.6 | 268.7 | <LOD | 1.5 | 1.4 | 0.3 |
| Flavor Distillate | 171.4 | 2.3 | 68.9 | 61.8 | 0.3 | 1.1 | 1.3 | 57.7 |
| Fill (A-1) | | | | | | | | |
| | DISTILLATE MATURATION | | | | | | | |
| Fill Distillate | <LOD | 0.1 | 1.8 | 3.3 | <LOD | <LOD | <LOD | <LOD |
| (ethanol 63.5% ABV) | | | | | | | | |
| Control | 0.1 | 0.3 | 8.1 | 19.1 | <LOD | <LOD | <LOD | <LOD |
| Cask A-1 | | | | | | | | |
| Flavor Cask A-1 | 10.7 | 0.2 | 5.5 | 5.0 | <LOD | <LOD | <LOD | 4.6 |
| Control | 0.3 | 0.4 | 10.0 | 24.0 | <LOD | <LOD | <LOD | <LOD |
| Cask A1 | | | | | | | | |
| Flavor Cask A-1 | 13.4 | 0.3 | 7.5 | 7.3 | <LOD | <LOD | <LOD | 7.7 |

NA means not applicable; <LOD means inferior to the limit of detection.

TABLE 8
Chemical analysis of the distillates used for the conditioning step (top section) and obtained after the
maturation step (bottom section). The conditioning section provides the chemical analysis of the distillates
used for the 3 week conditioning step (control fill or spike fill). The maturation section provides the
chemical analysis of the fill distillate (e.g., ethanol 63.5% ABV) either prior to (T = 0) or after
1 and 4 weeks of maturation (in control cask 1 or spike cask 2). Data is in g/100 L of absolute alcohol.

| | | | Concentration (g/100 L absolute alcohol) | | | | | |
|---|---|---|---|---|---|---|---|---|
| Sample | Conditioning | Maturation | | | | Ethyl | Isoamyl | Ethyl |
| Description | Time | time | Galactose | Sucrose | Vanillin | acetate | acetate | decanoate |

1 L CASK CONDITIONING SOLUTION

| | | | | | | | | |
|---|---|---|---|---|---|---|---|---|
| Control Fill (Cask 1) | NA | NA | 0.0 | <LOD | <LOD | <LOD | <LOD | <LOD |
| Spike Fill (Cask 2) | NA | NA | 1045 | 1164 | 16.5 | 17.5 | 14.1 | 10.6 |

DISTILLATE MATURATION

| | | | | | | | | |
|---|---|---|---|---|---|---|---|---|
| Fill Distillate (Ethanol | NA | 0 | <LOD | <LOD | <LOD | 0.6 | <LOD | <LOD |
| 63.5 % ABV) | | | | | | | | |
| Control (Cask 1) | 3 WEEKS | 1 WEEK | 0.2 | 2.8 | 0.1 | 1.4 | <LOD | <LOD |
| Spike (Cask 2) | 3 WEEKS | 1 WEEK | 45.5 | 30.5 | 1.3 | 2.7 | 1.0 | 1.2 |
| Control (Cask 1) | 3 WEEKS | 4 WEEKS | 0.2 | 1.8 | 0.4 | 3.2 | <LOD | <LOD |
| Spike (Cask 2) | 3 WEEKS | 4 WEEKS | 37 | 32.4 | 1.9 | 3.8 | 1.6 | 1.3 |

NA means not applicable; <LOD means inferior to the limit of detection.

### Example IV—Oak Chip Treatment with Spirits from Engineered Yeast

### Engineered Strain A-1:

Two 500 mL jars were filled with oak wood chips (40 g/L) and 250 mL of conditioning distillates produced either by: the A-1 strain (Flavor Distillate Fill A-1) or the A-1 non-engineered parental strain (Control distillate Fill A-1), as described in example I.

The oak chips were conditioned (treated) for two weeks in their respective jars, and then drained to obtain the isolated treated wood chips (control wood chip A-1 and flavored wood chip A-1). Chemical analysis of the distillates used for the conditioning step is shown in Table 9.

The isolated treated wood chips were transferred to clean 500 mL jars which were then filled with 250 mL of 63.5% ABV ethanol solution for maturation. The jars were stored at room temperature. To evaluate the effect of the treated wood chips on the aging product, samples were withdrawn from the flasks after 2 and 4 weeks and subjected to chemical analysis (GC-FID) for flavor compound (congener) quantification.

### Results

After two weeks of maturation, the fill distillate (63.5% ABV) aged with the A-1 flavor oak chips had 4.9 g/100L A.A. of isoamyl acetate compared to none in the control (inferior to the limit of detection); 14 times more ethyl acetate (14.6 g/100L AA.) than the control (1.11 g/100L AA); 2 g/100L A.A. of 2-phenethylethyl acetate compared to none in the control (inferior to the limit of detection) as demonstrated in the maturation section of Table 9. After 4 weeks of maturation, the fill distillate (63.5% ABV) aged with the flavor A-1 oak chips had 4.6 g/100L A.A. of isoamyl acetate compared to none in the control (inferior to the limit of detection); 13 times more ethyl acetate (13.4 g/100L A.A.) than the control (1.11 g/100L AA); 3 g/100L A.A. of 2-phenethylethyl acetate compared to none in the control (inferior to the limit of detection) as demonstrated in the maturation section of Table 9.

TABLE 9
Chemical analysis of the distillates used for the conditioning step (top section) and obtained after the maturation
step (bottom section). The conditioning section provides the chemical analysis of the distillates used for the
2 week conditioning step (control distillate fill or flavor distillate fill). The maturation section provides the
chemical analysis of the fill distillate (e.g., ethanol 63.5% ABV) either prior to (T = 0) or after 2 and
4 weeks of maturation (with control wood chip A-1 or flavor wood chip A-1). Data is in g/100 L of absolute alcohol.

| | | | Concentration (g/100 L absolute alcohol) | | | | | |
|---|---|---|---|---|---|---|---|---|
| Sample | Conditioning | Maturation | | Ethyl | | | | |
| Description | Time | time | Acetaldehyde | acetate | Acetal | Methanol | 1-Propanol | Isobutanol |

OAK CHIP CONDITIONING SOLUTION

| | | | | | | | | |
|---|---|---|---|---|---|---|---|---|
| Control distillate | NA | NA | 7.0 | 10.2 | 1.4 | 5.2 | 39.5 | 66.2 |
| Fill (A-1) | | | | | | | | |
| Flavor Distillate | NA | NA | 6.7 | 477.2 | 4.0 | 9.5 | 31.8 | 54.7 |
| Fill (A-1) | | | | | | | | |

DISTILLATE MATURATION

| | | | | | | | | |
|---|---|---|---|---|---|---|---|---|
| Fill Distillate | NA | 0 | 0.7 | <LOD | <LOD | <LOD | <LOD | <LOD |
| (Ethanol 63.5% ABV) | | | | | | | | |
| Control wood | 2 WEEKS | 2 WEEKS | 1.0 | 1.1 | <LOD | <LOD | 3.6 | 2.7 |
| chip (A-1) | | | | | | | | |
| Flavor wood | 2 WEEKS | 2 WEEKS | 1.0 | 14.6 | <LOD | <LOD | 5.1 | 2.7 |
| chip (A-1) | | | | | | | | |
| Control wood | 2 WEEKS | 4 WEEKS | 1 | 1 | <LOD | <LOD | 2.1 | 2.8 |
| chip (A-1) | | | | | | | | |
| Flavor wood | 2 WEEKS | 4 WEEKS | 1 | 13.4 | <LOD | <LOD | 1.7 | 2.5 |
| chip (A-1) | | | | | | | | |

| | Concentration (g/100 L absolute alcohol) | | | | | | | |
|---|---|---|---|---|---|---|---|---|
| Sample | Isoamyl | | 2-Methyl- | 3-Methyl- | Ethyl | Ethyl | Ethyl | 2-Phenethyl |
| Description | acetate | 1-Butanol | 1-butanol | 1-butanol | hexanoate | octanoate | decanoate | acetate |
| | OAK CHIP CONDITIONING SOLUTION | | | | | | | |
| Control distillate | 2.3 | 3.3 | 110.6 | 268.7 | <LOD | 1.5 | 1.4 | 0.3 |
| Fill (A-1) | | | | | | | | |
| Flavor Distillate | 171.4 | 2.3 | 68.9 | 61.8 | 0.3 | 1.1 | 1.3 | 57.7 |
| Fill (A-1) | | | | | | | | |
| | DISTILLATE MATURATION | | | | | | | |
| Fill Distillate | <LOD | <LOD | <LOD | <LOD | <LOD | 0.0 | <LOD | <LOD |
| (Ethanol 63.5% ABV) | | | | | | | | |
| Control wood | <LOD | <LOD | 4.3 | 9.4 | <LOD | 0.1 | <LOD | <LOD |
| chip (A-1) | | | | | | | | |
| Flavor wood | 4.9 | <LOD | 2.8 | 2.2 | <LOD | 0.0 | <LOD | 2.0 |
| chip (A-1) | | | | | | | | |
| Control wood | <LOD | <LOD | 4.4 | 9.5 | <LOD | 0 | <LOD | <LOD |
| chip (A-1) | | | | | | | | |
| Flavor wood | 4.6 | <LOD | 2.8 | 2.3 | <LOD | 0 | <LOD | 3 |
| chip (A-1) | | | | | | | | |

NA means not applicable; <LOD means inferior to the limit of detection.

### Engineered Strain B-1:

Two 500 mL jars are filled with oak wood chips (40 g/L) and 180 mL of conditioning distillates produced either by the B-1 strain (flavor distillate B-1) or the B-1 non-engineered parental strain (control distillate B-1), as described in example I.

The oak chips were conditioned (treated) for 2 weeks in their respective jars, and then drained to obtain the isolated treated wood chips (control wood chip B-1 and flavored wood chip B-1). Chemical analysis (GC-MS) was conducted on the samples as described in the method section below.

### Methods

Gas Chromatography Coupled with Mass Spectrometry (GC-MS)

Samples were analyzed by GC-MS using a Thermo TSQ with a StabilWax DA column (60 m×0.32 mm ID; 0.25 μm film thickness). Helium was used as a carrier gas at a flow rate of 2.1 mL/min. Injection volume was 1 μL. The injector was held at 250° C. with a split ratio of 2.0. Raspberry ketone was detected by following the MS-MS transition m/z 164 to 94, with a confirmation transition of m/z 164 to 107.

### Results

GC-MS chemical analysis of the distillates used for the conditioning step was performed at fill time. Raspberry ketone was quantified as 50 ppb in the B-1 flavor distillate fill, and lower than the limit of detection in the control distillate fill.

The treated wood chips were transferred in clean 500 mL jars which were then filled with 180 ml of 63.5% ABV ethanol solution for maturation. The jars were stored at room temperature. To evaluate the effect of the treated wood chips on the aging product, samples are withdrawn from the flasks after two weeks and subjected to GC-MS chemical analysis (raspberry ketone) quantification.

### Results

After 2 and 16 weeks of maturation, raspberry ketone was not detected (<LOD of 100 ppb) by chemical analysis in neither the fill distillate aged with the B-1 flavor oak chips nor the control. However, as the sensory threshold of raspberry ketone (1 to 10 ppb) is lower than the limit of the detection of the analytical method used, a paired comparison olfactory evaluation was performed to determine if a difference in aroma intensity existed between the two aged distillates. A panel of 39 untrained assessors participated in the paired comparison test and was asked which of the two samples had the most intense bubblegum, raspberry, candy-like aroma. Of the 39 assessors, 29 selected the B-1 flavor oak chips distillate as the most intense, meaning that there was a significant difference (p<0.05) in aroma between the two distillates and that the B-1 flavor oak chips sample was characterized by higher intensity in bubblegum, raspberry, and candy-like aromas.

### Engineered Strain C-1:

Two 500 mL jars were filled with oak wood chips (40 g/L) and 135 mL of conditioning distillates produced either by the C-1 strain (flavor distillate C-1) or the C-1 non-engineered parental strain (control distillate C-1), as described in example I.

The oak chips were conditioned (treated) for 2 weeks in their respective jars, and then drained to obtain the isolated treated wood chips (control wood chip C-1 and flavored wood chip C-1). Chemical analysis (GC-FID) of the distillates used for the conditioning step was performed at fill time.

The treated wood chips were transferred to clean 500 mL jars which were then filled with 135 ml of 63.5% ABV ethanol solution for maturation. The jars were stored at room temperature. To evaluate the effect of the treated wood chips on the aging product, samples were withdrawn from the flasks after 2 weeks and subjected to GC-FID chemical analysis for flavor compound (ethyl lactate) quantification, as described in example II.

### Results

After 2 and 4 weeks of maturation, the fill distillate (63.5% ABV) aged with the C-1 flavor oak chips had 2.5 and 2.3 g/100L AA. of ethyl lactate, respectively, compared to none in the control (inferior to the limit of detection). The results are demonstrated in the maturation section of Table 10.

TABLE 10
Chemical analysis of the distillates used for the conditioning
step (top section) and obtained after the maturation step (bottom
section). The conditioning section provides the chemical analysis
of the distillates used for the 2 week conditioning step (control
distillate fill or flavor distillate fill). The maturation section
provides the chemical analysis of the fill distillate (e.g.,
ethanol 63.5% ABV) either prior to (T = 0) or after 2 and
4 weeks of maturation (with control wood chip C-1 or flavor wood
chip C-1). Data is in g/100 L of absolute alcohol.

| | | | |
|---|---|---|---|
| | | | Conc. (g/100 L |
| | Conditioning | Maturation | A.A.) |
| Sample Description | Time | time | Ethyl lactate |

OAK CHIP CONDITIONING SOLUTION

| | | | |
|---|---|---|---|
| Control distillate Fill (C-1) | NA | NA | 1.0 |
| Flavor Distillate Fill C-1 | NA | NA | 112.0 |

DISTILLATE MATURATION

| | | | |
|---|---|---|---|
| Fill Distillate (Ethanol 63.5 | NA | 0 | <LOD |
| % ABV) | | | |
| Control wood chip (C-1) | 2 WEEKS | 2 WEEKS | <LOD |
| Flavor wood chip (C-1) | 2 WEEKS | 2 WEEKS | 2.5 |
| Control wood chip (C-1) | 2 WEEKS | 4 WEEKS | <LOD |
| Flavor wood chip (C-1) | 2 WEEKS | 4 WEEKS | 4.3 |

NA means not applicable; <LOD means inferior to the limit of detection.

### Example V—Oak Chip Treatment with Spiked Solution

Oak wood chips (40 g/L) were added to 250 mL of conditioning solution in 500 ml glass jars. Conditioning solution were either an ethanol solution at 63.5% ABV (control) or a spiked solution produced by addition of the volatile compounds ethyl acetate (18 g/100L A.A.), isoamyl acetate (14.2 g/100L A.A.), ethyl decanoate (9.9 g/100L AA.), and vanillin (16 g/100L A.A), as well as the non-volatile compounds galactose (1092 g/100L A.A.) and sucrose (885 g/100L A.A) in an ethanol solution at 63.5% ABV.

The oak chips were conditioned (treated) for one day, one week, two weeks, or four weeks and then drained to obtain the isolated treated wood chips. Chemical analysis (GC-FID, as explained in example II; HPLC-UV and IC-PAED, as explained in example Ill) of the conditioning solution is shown in the section oak chip conditioning of Table 11, 12, 13 and 14.

The isolated treated wood chips were transferred to clean 500 ml jars which are then filled with an ethanol solution at 63.5% ABV for maturation. The jars were stored at room temperature for a period of two or four weeks. To evaluate the effect of the treated wood chips on the aging product, samples were withdrawn from the flasks at week 2 and week 4 and subjected to chemical analysis (GC-FID, as explained in example II; HPLC-UV and IC-PAED, as explained in example III) for flavor compound (congener) quantification (Tables, 11, 12, 13 and 14). After 4 weeks the flavored beverage was isolated from the treated wood chips.

### Results

### Table 11

Samples for quantitative chemical analysis were taken to assess the concentration differences of congeners (flavor compounds) from oak chips treated with the spiked distillate or the control distillate for 1 day.

After 2 and 4 weeks of maturation, the fill distillate (63.5% ABV) aged with the spiked oak chips showed higher concentrations of flavor compounds than the control. In addition, the distillate aged for 4 weeks with the spiked oak chips was showing higher concentration of flavor compounds than the distillate aged for 2 weeks, while the distillate treated with the control oak chips shows no significant differences from 2 and 4 weeks maturation time.

### Table 12

Samples for quantitative chemical analysis were taken to assess the concentration differences of congeners (flavor compounds) from oak chips treated with the spiked distillate or the control distillate for 1 week.

After 2 and 4 weeks of maturation, the fill distillate (63.5% ABV) aged with the spiked oak chips demonstrated higher concentrations of flavor compounds than the control.

The 2-week aged distillate from oak chips treated for 1 week with the spiked solution demonstrated higher concentrations of flavor compounds than the 2-week aged distillate from oak chips treated for 1 day (Table 12).

### Table 13

Samples for quantitative chemical analysis were taken to assess the concentration differences of congeners (flavor compounds) from oak chips treated with the spiked distillate or the control distillate for 2 weeks.

After 2 and 4 weeks of maturation, the fill distillate (63.5% ABV) aged with the spiked oak chips demonstrated higher concentration of flavor compounds than the control (Table 13).

### Table 14

Samples for quantitative chemical analysis were taken to assess the concentration differences of congeners (flavor compounds) from oak chips treated with the spiked distillate or the control distillate for 4 weeks.

After 2 and 4 weeks of maturation, the fill distillate (63.5% ABV) aged with the spiked oak chips demonstrated higher concentration of flavor compounds than the control (Table 14).

TABLE 11
Chemical analysis of the distillates used for the conditioning step (top section) and obtained after the
maturation step (bottom section). The conditioning section provides the chemical analysis of the distillates
used for the 1 day conditioning step (control fill or spike fill). The maturation section provides the chemical
analysis of the fill distillate (e.g., ethanol 63.5% ABV) either prior to (T = 0) or after 2 weeks
and 4 weeks of maturation (with control or spiked wood chips). Data is in g/100 L of absolute alcohol.

| | | | Concentration (g/100 L absolute alcohol) | | | | | |
|---|---|---|---|---|---|---|---|---|
| | Conditioning | Maturation | | | | Ethyl | Isoamyl | Ethyl |
| Sample Description | time | time | Galactose | Sucrose | Vanillin | acetate | acetate | decanoate |

OAK CHIP CONDITIONING SOLUTION

| | | | | | | | | |
|---|---|---|---|---|---|---|---|---|
| Control Fill (Oak Chips 6) | NA | NA | 0.1 | 0.2 | <LOD | <LOD | <LOD | <LOD |
| Spike Fill (Oak Chips 7) | NA | NA | 1092 | 885 | 15.8 | 18.0 | 14.2 | 9.9 |

DISTILLATE MATURATION

| | | | | | | | | |
|---|---|---|---|---|---|---|---|---|
| Untreated Oak chips - | NA | <LOD | <LOD | <LOD | <LOD | <LOD | <LOD | <LOD |
| Fill Distillate | | | | | | | | |
| (Ethanol 63.5% ABV) | | | | | | | | |
| Control (Oak Chips 6) | 1 DAY | 2 WEEKS | <LOD | 3.7 | <LOD | 0.6 | <LOD | <LOD |
| Spike (Oak Chips 7) | 1 DAY | 2 WEEKS | 20.6 | 17.6 | 0.5 | 1.0 | 0.4 | 0.3 |
| Control (Oak Chips 6) | 1 DAY | 4 WEEKS | <LOD | 3.4 | <LOD | 0.7 | <LOD | <LOD |
| Spike (Oak Chips 7) | 1 DAY | 4 WEEKS | 33.4 | 25.4 | 0.6 | 1.1 | 0.5 | 0.4 |

NA means not applicable; <LOD means inferior to the limit of detection.

TABLE 12
Chemical analysis of the distillates used for the conditioning step (top section) and obtained after the
maturation step (bottom section). The conditioning section provides the chemical analysis of the distillates
used for the 1 week conditioning step (control fill or spike fill). The maturation section provides the
chemical analysis of the fill distillate (e.g., ethanol 63.5% ABV) either prior to (T = 0) or after
2 and 4 weeks of maturation (with control or spiked wood chips). Data is in g/100 L of absolute alcohol.

| | | | Concentration (g/100 L absolute alcohol) | | | | | |
|---|---|---|---|---|---|---|---|---|
| | Conditioning | Maturation | | | | Ethyl | Isoamyl | Ethyl |
| Sample Description | time | time | Galactose | Sucrose | Vanillin | acetate | acetate | decanoate |

OAK CHIP CONDITIONING SOLUTION

| | | | | | | | | |
|---|---|---|---|---|---|---|---|---|
| Control Fill (Oak Chips 8) | NA | NA | <LOD | <LOD | <LOD | <LOD | <LOD | <LOD |
| Spike Fill (Oak Chips 9) | NA | NA | 1092 | 885 | 15.8 | 18.0 | 14.2 | 9.9 |

DISTILLATE MATURATION

| | | | | | | | | |
|---|---|---|---|---|---|---|---|---|
| Untreated Oak chips - Fill | NA | 0 | <LOD | <LOD | <LOD | <LOD | <LOD | <LOD |
| Distillate (Ethanol 63.5% ABV) | | | | | | | | |
| Control (Oak Chips 8) | 1 WEEK | 2 WEEKS | 0.3 | 1.6 | <LOD | <LOD | <LOD | <LOD |
| Spike (Oak Chips 9) | 1 WEEK | 2 WEEKS | 51.6 | 27.9 | 0.7 | 1.1 | 0.5 | 0.6 |
| Control (Oak Chips 8) | 1 WEEK | 4 WEEKS | 0.1 | 2.5 | <LOD | <LOD | <LOD | <LOD |
| Spike (Oak Chips 9) | 1 WEEK | 4 WEEKS | 28.7 | 30.9 | 0.7 | 1.2 | 0.5 | 0.4 |

NA means not applicable; <LOD means inferior to the limit of detection.

TABLE 13
Chemical analysis of the distillates used for the conditioning step (top section) and obtained after the
maturation step (bottom section). The conditioning section provides the chemical analysis of the distillates
used for the 2 week conditioning step (control fill or spike fill). The maturation section provides the
chemical analysis of the fill distillate (e.g., ethanol 63.5% ABV) either prior to (T = 0) or after
2 and 4 weeks of maturation (with control or spiked wood chips). Data is in g/100 L of absolute alcohol.

| | | | Concentration (g/100 L absolute alcohol) | | | | | |
|---|---|---|---|---|---|---|---|---|
| | Conditioning | Maturation | | | | Ethyl | Isoamyl | Ethyl |
| Sample Description | time | time | Galactose | Sucrose | Vanillin | acetate | acetate | decanoate |

OAK CHIP CONDITIONING

| | | | | | | | | |
|---|---|---|---|---|---|---|---|---|
| Control Fill (Oak Chips 10) | NA | NA | <LOD | <LOD | <LOD | <LOD | <LOD | <LOD |
| Spike Fill (Oak Chips 11) | NA | NA | 1092 | 885 | 15.8 | 18.0 | 14.2 | 9.9 |

DISTILLATE MATURATION

| | | | | | | | | |
|---|---|---|---|---|---|---|---|---|
| Untreated Oak chips -Fill | NA | 0 | <LOD | <LOD | <LOD | <LOD | <LOD | <LOD |
| Distillate (Ethanol 63.5% ABV) | | | | | | | | |
| Control (Oak Chips 10) | 2 WEEKS | 2 WEEKS | <LOD | <LOD | <LOD | 0.7 | <LOD | <LOD |
| Spike (Oak Chips 11) | 2 WEEKS | 2 WEEKS | 45.5 | 30.9 | 0.7 | 1.2 | 0.6 | 0.5 |
| Control (Oak Chips 10) | 2 WEEKS | 4 WEEKS | 0 | 8.7 | 0 | 0.6 | <LOD | <LOD |
| Spike (Oak Chips 11) | 2 WEEKS | 4 WEEKS | 30.9 | 33 | 0.8 | 1.2 | 0.5 | 0.4 |

NA means not applicable; <LOD means inferior to the limit of detection.

TABLE 14
Chemical analysis of the distillates used for the conditioning step (top section) and obtained after
the maturation step (bottom section). The conditioning section provides the chemical analysis of the
distillates used for the 4 week conditioning step (control fill or spike fill) as well as the conditioning
time that was used to generate the chips. The maturation section provides the chemical analysis of
the fill distillate (e.g., ethanol 63.5% ABV) either prior to (T = 0) or after 2 and 4 weeks
of maturation (with control or spiked wood chips). Data is in g/100 L of absolute alcohol.

| | | | Concentration (g/100 L absolute alcohol) | | | | | |
|---|---|---|---|---|---|---|---|---|
| | Conditioning | Maturation | | | | Ethyl | Isoamyl | decanoate |
| Sample Description | time | time | Galactose | Sucrose | Vanillin | acetate | acetate | Ethyl |

OAK CHIP CONDITIONING

| | | | | | | | | |
|---|---|---|---|---|---|---|---|---|
| Control Fill (Oak Chips 12) | NA | NA | <LOD | <LOD | <LOD | <LOD | <LOD | <LOD |
| Spike Fill (Oak Chips 13) | NA | NA | 1092 | 885 | 15.8 | 18.0 | 14.2 | 9.9 |

DISTILLATE MATURATION

| | | | | | | | | |
|---|---|---|---|---|---|---|---|---|
| Fill Distillate | NA | 0 | <LOD | <LOD | <LOD | <LOD | <LOD | <LOD |
| (Ethanol 63.5% ABV) | | | | | | | | |
| Control (Oak Chips 12) | 4 WEEKS | 2 WEEKS | <LOD | 5.1 | <LOD | 0.6 | <LOD | <LOD |
| Spike (Oak Chips 13) | 4 WEEKS | 2 WEEKS | 24.4 | 21.9 | 0.6 | 1.0 | 0.4 | 0.4 |
| Control (Oak Chips 12) | 4 WEEKS | 4 WEEKS | <LOD | 4.2 | <LOD | 0.6 | <LOD | <LOD |
| Spike (Oak Chips 13) | 4 WEEKS | 4 WEEKS | 22.7 | 24.6 | 0.7 | 2 | 0.9 | 0.4 |

NA means not applicable; <LOD means inferior to the limit of detection.

While the invention has been described in connection with specific embodiments thereof, it will be understood that the scope of the claims should not be limited by the preferred embodiments set forth in the examples, but should be given the broadest interpretation consistent with the description as a whole.

### REFERENCES

Adachi, E., Torigoe, M., Sugiyama, M., Nikawa, J.-I., & Shimizu, K. (1998). Modification of metabolic pathways of Saccharomyces cerevisiae by the expression of lactate dehydrogenase and deletion of pyruvate decarboxylase genes for the lactic acid fermentation at low pH value. Journal of Fermentation and Bioengineering, 86(3), 284-289. https://doi.org/10.1016/S0922-338X(98)80131-1
Burdock, G. A. (2010). Fenaroli's Handbook of Flavor Ingredients (6th ed.). CRC Press. https://doi.org/10.1201/9781439847503
Cankar, K., van Houwelingen, A., Goedbioed, M., Renirne, R., de Jong, R. M., Bouwmeester, H., Bosch, D., Sonke, T., & Beekwilder, J. (2014). Valencene oxidase CYP706M1 from Alaska cedar (Callitropsis nootkatensis). FEBS Letters, 588(6), 1001-1007. https://doi.org/10.1016/j.febslet.2014.01.061
Conner, J. (2014). Maturation. In I. Russell & G. G. Stewart (Eds.), Whisky: Technology, Production and Marketing (2nd ed., pp. 199-220). Academic Press.
Conner, J. M., Paterson, A., & Piggott, J. R. (1992). Analysis of lignin from oak casks used for the maturation of Scotch whisky. Journal of the Science of Food and Agriculture, 60(3), 349-353. https://doi.org/10.1002/jsfa.2740600312
De Keersmaecker, J. (1996). The Mystery of Lambic Beer. Scientific American, 275, 74-80.
DEFRA. Technical File for Scotch Whisky. (2013).
Goward, C. R., & Nicholls, D. J. (1994). Malate dehydrogenase: A model for structure, evolution, and catalysis. Protein Science, 3(10), 1883-1888. https://doi.org/10.1002/pro.5560031027
Hasuo, T., & Yoshizawa, K. (1986). Substance change and substance evaporation through the barrel during whisky ageing. In I. Campbell & F. G. Priest (Eds.), Proceedings of the Second Aviemore Conference on Malting, Brewing & Distilling (pp. 404-408). Institute of Brewing.
Nishimura, K., & Matsuyama, R. (1989). Maturation and maturation chemistry. In J. R. Piggott, R. Sharp, & R. E. B. Duncan (Eds.), The Science and Technology of Whiskies (1st ed., pp. 235-263). Longman Scientific and Technical.
Osbum, K., Amaral, J., Metcalf, S. R., Nickens, D. M., Rogers, C. M., Sausen, C., Caputo, R., Miller, J., Li, H., Tennessen, J. M., & Bochman, M. L. (2018). Primary souring: A novel bacteria-free method for sour beer production. Food Microbiology, 70, 76-84. https://doi.org/10.1016/j.fm.2017.09.007
Philip, J. M. (1986). Scotch whisky flavour development during maturation. In I. Campbell & F. G. Priest (Eds.), Proceedings of the Second Aviemore Conference on Malting, Brewing & Distilling (pp. 148-163). Institute of Brewing.
Porro, D., Brambilla, L., Ranzi, B. M., Martegani, E., & Alberghina, L. (1995). Development of metabolically engineered Saccharomyces cerevisiae cells for the production of lactic acid. Biotechnology Progress, 11(3), 294-298. https//doi.org/10.1021/bp00033a009
Sauer, M., Porro, D., Mattanovich, D., & Branduardi, P. (2010). 16 years research on lactic acid production with yeast—ready for the market?Biotechnology and Genetic Engineering Reviews, 27(1), 229-256. https://doi.org/10.1080/02648725.2010.10648152
Skory, C. D. (2000). Isolation and Expression of Lactate Dehydrogenase Genes from Rhizopus oryzae. Applied and Environmental Microbiology, 66(6), 2343-2348. https://doi.org/10.1128/AEM.66.6.2343-2348.2000
Skory, C. D. (2003). Lactic acid production by Saccharomyces cerevisiae expressing a Rhizopus oryzae lactate dehydrogenase gene. Journal of Industrial Microbiology & Biotechnology, 30(1), 22-27. https://doi.org/10.1007/s10295-002-0004-2
Spitaels, F., Wieme, A. D., Janssens, M., Aerts, M., Daniel, H.-M., Van Landschoot, A., De Vuyst, L., & Vandamme, P. (2014). The Microbial Diversity of Traditional Spontaneously Fermented Lambic Beer. PLoS ONE, 9(4), e95384. https://doi.org/10.1371/journal.pone.0095384
Wiessnegger, T., Augustin, P., Engleder, M., Leitner, E., Müller, M., Kaluzna, I., Schürmann, M., Mink, D., Zellnig, G., Schwab, H., & Pichler, H. (2014). Production of the sesquiterpenoid (+)-nootkatone by metabolic engineering of Pichia pastoris. Metabolic Engineering, 24, 18-29. https://doi.org/10.1016/j.ymben.2014.04.001
Wight, S. K., & Viola, R. E. (2001). Alteration of the Specificity of Malate Dehydrogenase by Chemical Modulation of an Active Site Arginine. Journal of Biological Chemistry, 276(33), 31151-31155. https://doi.org/10.1074/jbc.M100892200

1. A method for obtaining a flavored porous material comprising at least one flavor compound, the method comprising:
a) optionally fermenting a biomass with a recombinant microbial host cell comprising at least one genetic modification to produce the at least one flavor compound to obtain a first fermentation product;
b) providing a flavored solution having the at least one flavor compound, wherein the flavored solution is:
I. the first fermentation product or is derived from the first fermentation product; and/or
II. obtained by adding the at least one flavor compound to an aqueous solution; and
c) contacting the flavored solution with a porous material for a period of time allowing the at least first flavor compound to generate the flavored porous material.

2. The method according to claim 1, wherein the method further comprises, after step c):
separating the flavored solution from the flavored porous material to obtain an isolated flavored porous material and an isolated flavored solution.

3. The method according to claim 1, wherein the porous material is a container, a piece, and/or comprises a wooden material.

4. The method according to claim 3, wherein the container is a cask or the piece is a chip.

5-7. (canceled)

8. The method according to claim 3, wherein the wooden material comprises or is derived from an oak wood.

9. The method according to claim 1, wherein the period of time is at least 1 day and/or the flavored solution is at a temperature between 15-35° C. for the period of time.

10. (canceled)

11. The method according to claim 1, wherein the at least one flavor compound comprises a volatile compound or a non-volatile compound.

12. (canceled)

13. The method according to claim 1, wherein the at least one flavor compound comprises 1-(2,3,6-Trimethyl phenyl)-1,3-butadiene, 1,2,5,6-Tetrahydrobenzaldehyde, 1,2-Epithiohumulene, 10-Undecenal, 2-(or 5)-Ethyl-5-(or 2)-methyl-4-hydroxy-3(2H)-furanone, 2,2-Dimethyl-trans-4-heptenal, 2,3,5-Trithiahexane, 2,3,6-Trichloroanisole, 2,3-Butanediol, 2,3-Dihydro-5-hydroxy-6-methyl-4(H)-pyran-4-one, 2,3-Dimethylpyrazine, 2,3-Hexanedione, 2,3-Pentanedione, 2,4-Dimethyl-3-pentanone, 2,5-Dimethyl-4-(1-pyrrolidinyl)-3(2H)-furanone, 2,5-Dimethyl-4-hydroxy-3(2H)-furanone, 2,5-Dimethylpyrazine, 2,6-Dimethyl-4-heptanone, 2,6-Dimethylpyrazine, 2-Acetyl-1-pyrroline, 2-Acetylfuran, 2-Acetylpyrrole, 2-Aminoacetophenone, 2-Butanethiol, 2-Butanol, 2-Butanone, 2-Butenal, 2-Butyl acetate, 2-Decanol, 2-Decanone, 2-Dodecanone, 2-Ethyl-2-hexenal, 2-Ethyl-5-methylpyrazine, 2-Ethyl-6-methylpyrazine, 2-Ethylbutanal, 2-Ethylhexanal, 2-Furfurylmercaptan, 2-Heptanol, 2-Heptanone, 2-Hexanol, 2-Hexanone, 2-Hexenal, 2-Methoxyphenol, 2-Methoxypyrazine, 2-Methyl-2-butenal, 2-Methylbutanal, 2-Methylbutanoic acid, 2-Methylbutanol, 2-Methylbutyl 2-methylpropanoate, 2-Methylbutyl acetate, 2-Methylpropanal, 2-Methylpropanoic acid, 2-Methylpropanol, 2-Nonanol, 2-Nonanone, 2-Octanol, 2-Octanone, 2-Pentanol, 2-Pentanone, 2-Phenylethanal, 2-Phenylethanol, 2-Phenylethyl acetate, 2-Propanol, 2-Propenal, 2-Tridecanone, 2-Undecanone, 3,3-Dimethyl-2-butanone, 3-Decanone, 3-Heptanone, 3-Hexenoic acid, 3-Hydroxy-3-methyl-2-butanone, 3-Hydroxy-4,5-dimethyl-2(5H)-furanone, 3-Mercaptohexanol, 3-Methyl-2-(1-pyrrolidinyl)-2-cyclopenten-1-one, 3-Methyl-2-butanone, 3-Methyl-2-butene-1-thiol, 3-Methyl-3-mercaptobutyl, 3-Methyl-3-mercaptobutyl formate, 3-Methylbutanal, 3-Methylbutanol, 3-Methylthiophene, 3-Octanone, 3-Pentanol, 3-Pentanone, 4-(4-Hydroxyphenyl)-2-butanone, 4-Ethyl phenol, 4-Ethylguaiacol, 4-Heptanone, 4-Hydroxybenzaldehyde, 4-Mercapto-4-methyl-pentan-2-one, 4-Methoxybenzaldehyde, 4-Methyl-2-pentanone, 4-Methylcyclo-hexanone, 4-Phenyl-3-buten-2-one, 4-Propyl syringol, 4-Vinyl phenol, 4-Vinylguaiacol, 5-Hydroxymethylfurfural, 5-Methyl-2-hexanone, 5-Methyl-4-hydroxy-3(2H)-furanone, 5-Methylfurfural, 6-Methyl-3-heptanone, 8-methyl-N-vanillyl-6-nonenamide, 9-Decenoic acid, 9-Undecenal, Acetaldehyde, Acetic acid, Acetoin, Acetone, Acetophenone, Acetosyringone, Acetovanillone, Acetylpyrazine, Adenosine, Adenosine-5′-monophosphate, Alanine, Aldol, Ammonium chloride, Arginine, Asparagine, Aspartic acid, Benzaldehyde, Benzyl alcohol, Benzylacetone, Butanal, Butanoic acid, Butyl acetate, Butyl butyrate, Butyric acid, Caffeic acid, Calcium carbonate, Calcium chloride, Calcium sulfate, Capric acid, Caproic acid, Chlorophenol, Cinnamaldehyde, Cinnamic acid, cis-1,5-Octadien-3-one, cis-3-Hexenal, cis-3-Hexenoic acid, cis-3-Hexenol, cis-4-Heptenal, Citralt, Citric acid, Citronellal, Citronellol, Cuminaldehyde, Cyclohexanone, Cyclooctanecarboxaldehyde, Cyclopentanone, Cytidine, D-2-Octanol, D-Carvone, Decanal, Decanoic acid, D-Glyceraldehyde, Diacetyl, Dibutyl sulfide, Diethoxyethane, Diethyl disulfide, Diethyl sulfide, Dimethyl disulfide, Dimethyl sulfide, Dimethyl trisulfide, Dimethylallyl methyl sulfide, Dodecanal, D-Tartaric acid, Ellagic acid, Ethanol, Ethyl 2-methylbutanoate, Ethyl 2-methylpropanoate, Ethyl 3-hydroxyhexanoate, Ethyl 3-methylbutanoate, Ethyl 3-phenylpropanoate, Ethyl 4-methylpentanoate, Ethyl acetate, Ethyl butanoate, Ethyl caprylate, Ethyl cinnamate, Ethyl decanoate, Ethyl formate, Ethyl heptanoate, Ethyl hexanoate, Ethyl lactate, Ethyl laurate, Ethyl levulinate, Ethyl linoleate, Ethyl mercaptan, Ethyl myristate, Ethyl nicotinate, Ethyl nonanoate, Ethyl oleate, Ethyl palmitate, Ethyl palmitoleate, Ethyl pentadecanoate, Ethyl pentanoate, Ethyl stearate, Ethyl thioacetate, Ethyl tridecanoate, Ethyl undecanoate, Eugenol, Farnesene, Ferulic acid, Formaldehyde, Formic acid, Fructose, Fumaric acid, Furfural, Furfuryl acetate, Furfuryl alcohol, Furfuryl ethyl ether, Furylacrolein, Galactose, Gallic acid, Geraniol, Geranyl acetate, Geranyl isobutyrate, Glucose, Glutamic acid, Glutamine, Glycerinaldehyde, Glycerol, Glycine, Glyoxal, Glyoxylic acid, Guaiacol, Guanosine-5′-monophosphate, Heptanal, Heptanol, Hepten-3-ol, Heptyl acetate, Heptyl butyrate, Hexanal, Hexanol, Hexyl acetate, Histidine, Humuladienone, Humulene, Humulene epoxide, Hydrocinnamaldehyde, Hydrogen sulfide, Hydroxycitronellal, Inosine, Isoamyl acetate, Isoamyl caprate, Isoamyl caproate, Isoamyl caprylate, Isoamyl formate, Isoamyl isobutyrate, Isoamyl mercaptan, Isoamyl nonanoate, Isoamyl propionate, Isobutyl acetate, Isobutyl formate, Isobutyl mercaptan, Isoeugenol, Isohumulone, Isomaltol, Isomaltose, Isopropyl sulphide, Isovaleric acid, Lactic acid, Lactose, Lauric acid, Leucine, Linalool, Linoleic acid, Linolenic acid, Lysine, Magnesium carbonate, Magnesium chloride, Magnesium sulfate, Malic acid, Maltol, Maltose, Maltotriose, m-Cresol, Mercaptan, Mesityl oxide, Methanethiol, Methanol, Methional, Methionine, Methionol, Methyl acetate, Methyl caprate, Methyl formate, Methyl vanillate, Methylglyoxal, Methylpyrazine, Methylthioacetate, Myrcene, Myrcene disulfide, N-[(4-hydroxy-3-methoxyphenyl)methyl]nonanamide, n-Amyl butyrate, n-Butanol, n-Butyl mercaptan, n-Decanal, n-Decanol, n-Dodecanol, Nerol, Niacin, n-Nonanol, n-Octyl acetate, n-Octyl butyrate, n-Octyl caproate, Nonanal, Nonanoic acid, Nootkatone, n-Pentanol, n-Propyl acetate, n-Propylmercaptan, n-Undecan-2-ol, n-Undecanal, n-Undecanol, N-vanillyl octanamide, o-Cresol, Oct-2-enal, Octanal, Octanoic acid, Octanol, Octen-3-ol, Octen-3-one, Octyl ester acetate, Oleic acid, Oxalacetic acid, Oxalic acid, Pantothenic acid, p-Coumaric acid, p-Cresol, Pentanal, Pentanedione, Penten-3-ol, Penten-3-one, Phenol, Phenylacetic acid, Phenylalanine, Phenylethanol, Phenylpyruvic acid, p-Hydroxybenzoic acid, p-Methane-8-thiol-3-one, Potassium chloride, Proline, Propanal, Propanoic acid, Propanol, Pyrazine, Pyridoxine, Pyroglutamic acid, Pyruvic acid, Quercitrin, Riboflavin, Salicylaldehyde, Serine, S-Methyl-2-methylthiobutanoate, S-Methyl-2-methylthiopropionate, S-Methyl-3-methylthiobutanoate, S-Methylthiohexanoate, S-Methylthiomethyl-2-methylbutanethiolate, Sodium carbonate, Sodium chloride, Sodium sulfate, Stearic acid, Succinic acid, Succinic acid diethyl ester, Sucrose, Sulfur dioxide, Syringaldehyde, Tartaric acid, tert-Amyl mercaptan, tert-Butanol, tert-Butyl acetate, tert-Butyl mercaptan, Thiamine, Thiazole, Threonine, Thymol, trans,cis-2,4-Hexadienal, trans,cis-2,6-Nonadienal, trans,trans-2,4-Decadienal, trans,trans-2,4-Hexadienal, trans,trans-2,4-Nonadienal, trans-2-Decenal, trans-2-Heptenal, trans-2-Hexen-1-ol, trans-2-Hexenal, trans-2-Nonenal, trans-2-Nonenoic acid, trans-2-Octenal, Trichloroanisole, Trimethylpyrazine, Tryptophan, Tryptophol, Tyrosine, Tyrosol, Valencene, Valeric acid, Valine, Vanillic acid, Vanillin, Vanillin acetate, Vanillyl alcohol, Xylose, α-Ionone, α-Terpineol, β-Caryophyllene, β-Damascenone, β-Eudesmol, β-Farnesene, β-Ionone, β-Phenylacetaldehyde, γ-Aminobutyric acid, γ-Butyrolactone, γ-Decalactone, γ-Hexalactone, γ-Nonalactone, γ-Octalactone, γ-Pentalactone, and/or δ-Decalactone or the at least one flavor compound comprises galactose, sucrose, ethyl decanoate, ethyl acetate, ethyl lactate, 4-(4-Hydroxyphenyl)-2-butanone, isoamyl acetate, phenethyl acetate and/or vanillin.

14. (canceled)

15. The method according to claim 1, wherein the flavored solution comprises a further flavor compound and/or a distillate derived from the first fermentation product.

16. (canceled)

17. The method according to claim 1, wherein the aqueous solution is an ethanol-containing solution.

18. The method according to claim 17, wherein the ethanol-containing solution is derived from a second fermentation product or comprises a distillate derived from the second fermentation product.

19. (canceled)

20. The method according to claim 1, wherein the recombinant microbial host cell has a heterologous nucleic acid molecule encoding one or more heterologous polypeptide for the production the at least one flavor compound and/or is a recombinant yeast host cell.

21. The method according to claim 20, wherein the at least one flavor compound comprises isoamyl acetate and the one or more heterologous polypeptide comprises a heterologous alcohol acetyl transferase (ATF) enzyme, a variant thereof or a fragment thereof; and/or 4-(4-hydroxyphenyl)-2-butanone and the one or more heterologous polypeptide comprises:
i. a heterologous phenylalanine-ammonium lyase (PAL) enzyme, a variant thereof or a fragment thereof;
ii. a heterologous cinnimate-4-hydroxylase (C4H) enzyme, a variant thereof or a fragment thereof;
iii. a heterologous coumarate-CoA ligase (4CL) enzyme, a variant thereof or a fragment thereof;
iv. a heterologous benzalacetone synthase (BAS) enzyme, a variant thereof or a fragment thereof; and/or
v. a chimeric enzyme comprising a heterologous coumarate-CoA ligase (4CL) enzyme moiety and a heterologous benzalacetone synthase (BAS) enzyme moiety; and
vi. optionally, the recombinant microbial host cell overexpresses a native benzalacetone reductase.

22. (canceled)

23. (canceled)

24. A method for flavoring a beverage to obtain a flavored beverage, the method comprising contacting the isolated flavored porous material according to any one of claim 2 with a first untreated beverage to release the at least one flavor compound to obtain a first flavored beverage.

25. The method according to claim 24, wherein the isolated flavored porous material and the first untreated beverage are in contact for at least 1 day and/or the isolated flavored porous material and the first untreated beverage are in contact at a temperature between 15-35° C.

26. (canceled)

27. The method according to claim 24 wherein the method further comprises a step of separating the flavored beverage from the isolated flavored porous material to obtain a separated flavored porous material and a separated flavored beverage and/or further comprises contacting the separated flavored porous material with a second untreated beverage to release the at least one flavor compound to obtain a second flavored beverage.

28. (canceled)

29. The method according to claim 24, wherein the beverage is an alcoholic beverage and/or the alcoholic beverage is beer, brandy, cachaça, mezcal, whisky, whiskey, gin, tequila, rum, wine, mead, sake, baiju, shochu, soju, cider, perry, arrack, jenever, vermouth, Armagnac, korn, raki, pulque, basi, vodka, poitin, akvavit, aquavit, absinthe, spirits, new-make spirit, white dog, or moonshine.

30. (canceled)

31. The method according to claim 1, wherein the at least one flavor compound comprises a typical flavor compound for the beverage and/or an atypical flavor compound for the beverage.

32. (canceled)

33. A flavored porous material obtained by the method of claim 1.

34. A flavored beverage obtained by the method of claim 24.


SEQUENCE LISTING (99 sequences)

SEQ ID NO: 1 - DNA, 963 bp, synthetic construct
  source 1..963: mol_type = other DNA
atggtcctgcatagtaaggtggcaatagtcggagccggtgccgtaggcgcttcaacagcctacgcgctaatgtttaagaatatatgcacagaaattatagtggtcgatgttaatcctgatattgtgcaagcgcaggtactagacttagccgacgctgcttcaatatctcacactccaatcagggcaggatctgttgaagaagctggtcaagcagacatcgtggtaataaccgcgggtgcaaagcaaagagaaggcgaaccgagaacaaaacttattgaaaggaactacagggttctacaatcaattatcggtggtatgcaacctatccgtcccgacgctgtgattttagttgttgcaaacccagttgacatactaacacacattgctaaaactctatcaggcttgcctcccaatcaagtgattggctcaggaacgtacctggatacaacaaggttaagggtacatttgggcgatgtattcgacgtgaatccccagagcatccacgcctttgtgctgggtgagcacggcgactcacagatgatagcctgggaggccgcgtctatcggagggcagccccttactagctttcccgagttcgcgaagttagacaaaaccgcaattagcaaggccatttcaggaaaggcaatggagataattcgtctgaagggagcgacattttatgggatcggcgcttgtgccgcggacttggttcacactattatgttgaataggaagtccgttcacccggtctcagtttacgtggaaaaatatggcgcgacattttctatgccggccaaacttggatggagaggagttgaacaaatttacgaggtacctcttactgaagaagaagaagcgctacttgtgaagtctgtcgaggcgctgaagtctgttgagtatagcagtacgaaggttcctgagaaaaaggtccatgcaacatcatttagtaaaagtaactgctga

SEQ ID NO: 2 - protein, 300 aa, Rhizopus oryzae
MVLHSKVAIVGAGAVGASTAYALMFKNICTEIIVVDVNPDIVQAQVLDLADAASISHTPIRAGSVEEAGQADIVVITAGAKQREGEPRTKLIERNYRVLQSIIGGMQPIRPDAVILVVANPVDILTHIAKTLSGLPPNQVIGSGTYLDTTRLRVHLGDVFDVNPQSIHAFVLGEHGDSQMIAWEAASIGGQPLTSFPEFAKLDKTAISKAISGKAMEIIRLKGATFYGIGACAADLVHTIMLNRKSVHPVSVYVEKYGATFSMPAKLGWRGVEQIYEVPLTEEEEALLVKSVEALKSVEY

SEQ ID NO: 3 - protein, 320 aa, Lachancea fermentati
MEENQEATVAGPVKIVVIGVGSVGSATAYTLLLSGIVNEIVLIDINKDKAEGESMDLNHAAPSITKSRAGDYADCAGAAIVIVTCGINQKHGQTRMDLAAKNAKIMQDIIPNVAKYAPDTILLIATNPVDVLTYISYKASGFPLNRVIGSGTVLDTARFKYILGDHFKISSDSIDACVIGEHGDSGVPVWSLTNIDGMKLRDYCEKSKQDFDEEAFQKIFEQTRDAAYDIIKRKGYTSYGIAAGLLRIVKAILEDTDSVLTVSTVGDYFGVEQIAISVPTRLNKSGAHQAAELTLDENEIELMKKSAGEIKSVLKNLNIA

SEQ ID NO: 4 - protein, 326 aa, Lachancea fermentati
MSKYSQKSILKTDLRPATIAIVGVGSVGATTAYTLQLSGMIADIVLIDINKDKAEGEYMDLNHAAPMTTETQVRVGEYSDCVDAAIVIIAGGANQKPGQTRMELAAKNAKIIEEIIPNVVKYAPDTILLIATNPVDVLTYASYKLSGFPTSRVIGSGTLLDSTRLRCNIGRYYNISSDSVDACIIGEHGDSELAVWSRATIAGMNLAEFSAATKQEYDKESLHKIFEHTRDAAYNIIKRKGYTAYGIAAALTRIVEAVLRDEGSLLTVSIVGDYYGIKNVALSVPTKVGRDGAHHIMDLTLNEKENEEVKNSAKKIRAACDSLGLK

SEQ ID NO: 5 - protein, 326 aa, Lachancea fermentati
MSKSTQSPALKTDLRPATIAIVGVGSVGATTAYTLQLSGMVADIVLIDINKDKAEGEFMDLNHAAPMTTETQVRVGDYPDCADAAIVIITGGANQKPGQTRMELAAKNAKIMEEIIPNVVKYAPDTILLIATNPVDVLTYASYKLSGFPASRIIGSGTLLDSTRLRCNIGRYYGISSDSVEASIIGEHGDSELAVWSRATIAGMSLAEFSAATQQKYNKESLHKIFEHTRDAAYNIIKRKGYTAYGIAAALTRIVEAILRDEGSLLTVSIVGNYYGVKDVALSVPTKVGRDGAHHIMDLILNQDETDRMKSSAKKIRSACESLGLD

SEQ ID NO: 6 - protein, 324 aa, Lachancea fermentati
MYQDKSMRATVEHAKLIKIVIVGVGSVGSATAYTLILSGIVNDLVLIDVNREKAEGESMDLNHAAPSWASARAGNYSDCKDADIVIITCGVSQTNGQTRMDLAAKNTDIMRDVVSNVAQNAPDTILLIATNPVDVLTYVSYEASGFPLHRVIGSGTVLDTARFKHILGNHFKVPSNTVEACVIGEHGDSSVAAWSLTNIKGMKLREYCEKSNQKFDEEAFQKVFEQTRDAAYDIIKRKGCTSYGIAAGLLRIVRAILANEDHVLPVSTVGAHFGIDHVALSVPTKLNRGGAYPAGALTINEREMELARKSAEKIKSVLDKVFIK

SEQ ID NO: 7 - protein, 326 aa, Lachancea thermotolerans
MAQNKESSTMKAGLNPVKVVVVGTGSVGSTTAYTLLLSGMVAEIVLIDINKDKADGEGMDLNHAAPMTTDCRVYVGDYPDCANAAIVIITGGANQKPGQTRMDLAAKNAKIMQEIIPNIVKNAPDTILLLATNPVDVLTSISYKLSGFPASRVIGSGTLLDSARLRYNLSKYYNISSESIGAFIIGEHGDSELPVWSLASIAGMRLRDYCEKSNQKFDQDALEKIFEKTRSAAYDIIKRKGYTAYGIAAGLVRIVETILKNEGSLLTVSTVGDYFGVKQVALSVPTKVDRTGAHHIVGLSLDDNEIEEVKKSGQNIKSVCSRLGFD

SEQ ID NO: 8 - protein, 327 aa, Lachancea thermotolerans
MPHSIYPPASTIKKVNPVKVAVIGVGSVGSTTAYTLLFSEMISEVVLIDINTHKAEGESMDLNHAAPSTTGSVVYVGDYSDCADAAIVIITGGANQKPGQTRMDLAATNARILQGIIPKIVEYAPKTILLIATNPVDVLTYVSYKVSGFPLNRVIGSGTLLDSARLKYHLSQHFKTSSKNVDAFIVGEHGDSSLPVWSHVKISGIRLRDYCEQSQQAYDHELFHQMFEKTRNAAYDIIERKGYTAYGIAAGILRIVETILKDGGSPLTVSTVGNYFGIEQVALSVPTKLNRNGAHSPVDLSFDIKEIELIKKSALQIKSVCSTLELL

SEQ ID NO: 9 - protein, 324 aa, Lachancea thermotolerans
MFQDTKSQAVRTDAKTVKVVVVGVGSVGSATAYTLLLSGIVSEIVLIDVNKDKAEGESMDLNHAAPSNTRSRAGEYPDCAGAAIVIVTCGINQKNGQTRMDLAAKNANIMLEIIPNVAKYAPDTILLIATNPVDVLTYISYKASGFPLSRVIGSGTVLDTARFKYILGEHFKISSDSIEACVIGEHGDSGVPVWSLTNIDGMKLRDYCEKANHIFDQNAFHRIFEQTRDAAYDIIKRKGYTSYGIAVGLLRIVKAILEDTGSTLTVSTVGDYFGVEQIAISVPTKLNRSGAHQVAELSLDEKEIELMEKSASQIKSVIEHLEIN

SEQ ID NO: 10 - protein, 225 aa, Lachancea fermentati
MELAAKNAKIMEEIIPNVVKYAPDTILLIATNPVDVLTYASYKLSGFLASRIIGSGTLLDSTRLRCNIGRYYGISSDSVEASIIGEHGDSELAVWSRATIAGMSLAEFSAATQQKYDKESLHKIFEHTRDAAYNIIKRKGYTAYGIAAALTRIVEAILRDEGSLLTVSIVGNYYGVKDVALSVPTKVGRDGAHHIMDLILNQDETDRMKSSAKKIRSACESLGLD

SEQ ID NO: 11 - protein, 333 aa, Wickerhamomyces anomalus
MKVTVCGAAGGIGQPLSLLLKLSPYVTELSLYDVVNSPGVGADLSHIDTNTKIQSFLPDNDGLSKALQNTDIVIIPAGVPRKPGMTRDDLFAINAGIVRDLAQGVASFAPDAFVLVISNPVNSTVPIFAEVLKKNGVFNARKLFGVTTLDLVRANTFISQLSNDSLNPENLKIPVIGGHSGDTIVPLFSLGSPEFYKSLSIEQRDALIHRVQFGGDEVVQAKKGMGSATLSMAYSGFKLAEELMKAIKGDSSIVDSSFVYLSDDIKGAKEVRQLLPDLDYISLPVKLSAKGVESIEIDVLNKINDHEKELLNVAIDQLKTNISKGINFIKNQA

SEQ ID NO: 12 - protein, 343 aa, Arabidopsis thaliana
METDLKSTFLNVYSVLKSDLLHDPSFEFTNESRLWVDRMLDYNVRGGKLNRGLSVVDSFKLLKQGNDLTEQEVFLSCALGWCIEWLQAYFLVLDDIMDNSVTRRGQPCWFRVPQVGMVAINDGILLRNHIHRILKKHFRDKPYYVDLVDLFNEVELQTACGQMIDLITTFEGEKDLSKYSLSIHRRIVQHKTAYYSFYLPVACALLMAGENLENHIDVKNVLVDMGIYFQVQDDYLDCFADPETLGKIGTDIEDFKCSWLVVKALERCSEEQTKILYENYGKTDPSNVAKVKDLYKELDLEGVFMEYESKSYEKLTGAIEGHQSKAIQAVLKSFLAKIYKRQK

SEQ ID NO: 13 - protein, 342 aa, Glycyrrhiza uralensis
MADLKSTFLNVYSVLKSELLHDPAFEWSDDSRQWADRMLDYNVPGGKLNRGLSVIDSYRLLKEGQALNDDELFLASALGWCIEWLQAYFLVLDDIMDNSHTRRGQPCWFRVPKVGMIAANDGVLLRNHIPRILRKHFRGKPYYVDLLDLFNEVEFQTASGQMIDLITTLEGEKDLSKYTLSLHRRIVQYKTAYYSFYLPVACALLMMGENLDNHIDVKNILVDMGTYFQVQDDYLDCFGDPQTIGKIGTDIEDFKCSWLVVKALELCNEEQKKVLYEHYGKPDPTNVAKVKALYNELNLQGVFAEYESASYEKLVTSIEAHPSKAVQSVLKSFLAKIYKRQK

SEQ ID NO: 14 - protein, 342 aa, Capsella rubella
MADLKSTFLDVYSILKSELLQDPSFEFTHESRQWVERMLDYNVRGGKLNRGLSVVDSYKLLKQGQDLTDKETFLACALGWCIEWLQAHFLVLDDIMDNSVTRRGQPCWFRQPKVGMIAINDGVLLRNHIHRILRKHFREMPYYVDLVDLFNEVEFQTASGQMIDLITTFDGEKDLSKYSLQIHRRIVQYKTSYYSFYLPVACALFMAGENLETHTDVKNVLVDMGIYFQVQDDYLDCYADPETLGKIGTDIEDFKCSWLVVKALERCSEEQTKILYENYGKSEPSNIAKVKALYKELDLEAAFMEYEKESYEKLTKLIEAHQSKAIQAVLKSFLAKIYKRQK

SEQ ID NO: 15 - protein, 342 aa, Arabidopsis thaliana
MADLKSTFLNVYSVLKAELLQDPAFEYTDVSRQWIERMLDYNVPGGKLNRGLSVIDSYRLLKEGKELTEDEIFLASVLGWCIEWLQAYFLVLDDIMDNSVTRRGQPCWFRVPKVGMIAVNDGVLLRNHIPRMLKNHFKGKPYYVNLLDLFNEVEFQTASGQMIDLITTIEGEKDLSKYALSLHRRIVQYKTAYYSFYLPVACALVMSGEDLENHTVVKDTLVQMGIYFQVQDDYLDCFGDPETIGKVGTDIEDFKCSWLVVKALELCNEEQKKLLHEAYGKPDPENVAKVKALYKELNIEGVFAEYESQSYAELNATIEAHPSKSIQAVLKSFLGKIYKRQK

SEQ ID NO: 16 - protein, 342 aa, Lupinus angustifolius
MADLKSSFLKVYSILKSELLHDPAFEFSNDSRQWVERMVDYNVPGGKLNRGMSVIESYRLLKDGQELHDDEIFLASALGWCIEWLQAHFLVSDDIMDNSHTRRGQPCWFRVPKVGLIAANDGLLLRNHIHRIFKNHFRGKPYYVDLLHLFNEVEFQTVSGQMIDLITTLEGEKDLSKYTLSLHRSIVQYKTTYYSFYLPVACALLMLGENLDNHINVKNILVEMGTFFQVQDDYLDCFGAPETIGKIGTDIEDFKCSWLVVKALELSNEEQKKVLNENYGKPDLANVSKVKALYNELNLQGVFAEYESNSYEKLVASIEAHPSKAVQAALKSFLAKIYKRQK

SEQ ID NO: 17 - protein, 548 aa, Citrus sinensis
MSSGETFRPTADFHPSLWRNHFLKGASDFKTVDHTATQERHEALKEEVRRMITDAEDKPVQKLRLIDEVQRLGVAYHFEKEIGDAIQKLCPIYIDSNRADLHTVSLHFRLLRQQGIKISCDVFEKFKDDEGRFKSSLINDVQGMLSLYEAAYMAVRGEHILDEAIAFTTTHLKSLVAQDHVTPKLAEQINHALYRPLRKTLPRLEARYFMSMINSTSDHLCNKTLLNFAKLDFNILLELHKEELNELTKWWKDLDFTTKLPYARDRLVELYFWDLGTYFEPQYAFGRKIMTQLNYILSIIDDTYDAYGTLEELSLFTEAVQRWNIEAVDMLPEYMKLIYRTLLDAFNEIEEDMAKQGRSHCVRYAKEENQKVIGAYSVQAKWFSEGYVPTIEEYMPIALTSCAYTFVITNSFLGMGDFATKEVFEWISNNPKVVKAASVICRLMDDMQGHEFEQKRGHVASAIECYTKQHGVSKEEAIKMFEEEVANAWKDINEELMMKPTVVARPLLGTILNLARAIDFIYKEDDGYTHSYLIKDQIASVLGDHVPF

SEQ ID NO: 18 - protein, 555 aa, Citrus junos
MSAQVLATVSSSTEKTVRPIAGFHPNLWGDYFLTLASDCKTDDTTHQEEYEALKQEVRSMITATADTPAQKLQLVDAVQRLGVAYHFEQEIEDAMEKIYHDDFDNNDDVDLYTVSLRFRLLRQQGFKVPCDVFAKFKDDEGKFKASLVRDVHGILSLYEAGHLAIRGEGILDEAIAFTRTHLQSMVSQDVCPNNLAEQINHTLDCPLRRALPRVETRFFLSVYPRDDKHDKTLLKFSKLDFNLVQRIHQKELSAITRWWKDLDFTTKLPYARDRIVELYFWIVGTYFEPKYTLARKIMTKTIYTASIIDDTFDAYGFFEELKLFAEAVQRWDIGAMDILPEYMKVLYKALLDTFNEIEQDLAKEGRSSCLPYGKEKMQELVQMYFVQAKWFSEGYVPTWDEYYPVGLVSCGYFMLATNSFLGMCDVANKESFEWISRTLRFQQRHQFICRLRNDIVSHQFEQKRGHIASGVECYIKQYGVSAEEVVTVFTEEVENAWKDMNEEFLKPTAFPVALIERPFNIARVIEFLNKKGDWYTHSHAIKDQIAAVLRDPVTI

SEQ ID NO: 19 - protein, 555 aa, Vitis vinifera
MSIQVSTCPLVQIPKPEHRPMAEFHPSIWGDQFIAYTPEDEDTRACKEKQVEDLKAEVRRELMAAAGNPSQLLNFIDAVQRLGVAYHFEREIEESLQHIYDRFHDADDTEDDLYNIALQFRLLRQQGYNISCGIFNKFKDEKGSFKEDLISNIQGMLGLYEAAHLRVHGEDILEEALAFTTTHLKATVESLGYPLAEQVAHALKHPIRKGLERLEARWYISLYQDEASHDKTLLKLAKLDFNLVQSLHKEELSNLARWWKELDFATKLPFARDRFVEGYFWTLGVYFEPQYSRARRILTKLFSMASIIDDIYDAYGTLEELQPFTEAIERWDIKSIDHLPEYMKLFYVTLLDLYKEIDQELEKYGNQYRVYYAKEVLKSQVRAYFAEAKWSHEGYIPTIEEYMLVALVTSGSCILATWSFIGMGEIMTKEAFDWVISDPKIITASTVIFRLMDDITTHKFEQKRGHVASGIECYMKQYGVSEEQVYSEFHKQVENAWLGINQECLKPTAVPMPLLTRVVNLSRVMDVIYKEGDGYTHVGKVMKDNIGSVLIDPIV

SEQ ID NO: 20 - protein, 589 aa, Callitropsis nootkatensis
MAEMFNGNSSNDGSSCMPVKDALRRTGNHHPNLWTDDFIQSLNSPYSDSSYHKHREILIDEIRDMFSNGEGDEFGVLENIWFVDVVQRLGIDRHFQEEIKTALDYIYKFWNHDSIFGDLNMVALGFRILRLNRYVASSDVFKKFKGEEGQFSGFESSDQDAKLEMMLNLYKASELDFPDEDILKEARAFASMYLKHVIKEYGDIQESKNPLLMEIEYTFKYPWRCRLPRLEAWNFIHIMRQQDCNISLANNLYKIPKIYMKKILELAILDFNILQSQHQHEMKLISTWWKNSSAIQLDFFRHRHIESYFWWASPLFEPEFSTCRINCTKLSTKMFLLDDIYDTYGTVEELKPFTTTLTRWDVSTVDNHPDYMKIAFNFSYEIYKEIASEAERKHGPFVYKYLQSCWKSYIEAYMQEAEWIASNHIPGFDEYLMNGVKSSGMRILMIHALILMDTPLSDEILEQLDIPSSKSQALLSLITRLVDDVKDFEDEQAHGEMASSIECYMKDNHGSTREDALNYLKIRIESCVQELNKELLEPSNMHGSFRNLYLNVGMRVIFFMLNDGDLFTHSNRKEIQDAITKFFVEPIIP

SEQ ID NO: 21 - protein, 553 aa, Populus trichocarpa
MSTQVSQEVVPKAHHNEIIRRTANYHPSIWGDQFISHLPKDKVHEAIELQEIEKLREQFKRELLAAASNSSQQLDLIDAIQRLGVAYHFETEIEEALQHIYNNRIDMEDDDLYNTALGFRLLRQHGYNVSCDIFNKFKDDKGYFKQSNDVRGILGLYEAAHLAVHGEDILDEALAFTTIHLKSMASSPNCPLTAKVSHALKQPIQRGVPRLESRRYISIYQDEPSCNKTLLRLAKLNFNLVQELHKEELAEITRWWKGLDFARRLPFARDRVVECFFWIVGVYFEPQYSLARKILTKVIAMTSIIDDIYDVYGTLEELELFTEAIDRWDTKSMDQLPDYMKICYEALLNVFSEIEEKVAKEGWSYRVHYGKDAMKVLVHAYFNEAKWFHENHIPTMEEYMQVALVTSGYSMLTTVSFIGMGDMVTKQAFDWVFNHPKIIRASETIGRLLDDVKSHKFEQERGHAASGVECYIRQYGLSEQEVYKEFHMQVVNAWKDINEECLKPTAVPTPLLERILNLSRVIDVIYKEEDGYTHVGKVMKNNVASLLINSVPI

SEQ ID NO: 22 - protein, 396 aa, Bacillus subtilis
MNVLNRRQALQRALLNGKNKQDAYHPFPWYESMRKDAPVSFDEENQVWSVFLYDDVKKVIGDKELFSSYMPQQSSAIGNSIINMDPPRHTQIRSVVNKAFTPRVMKQWEPRIQEITDELIQKFQGRSEFDLVHDFSYPLPVIVISELLGVPSEHMDQFKTWSDLLVSTPKDKSEEAEEAFLEERNKCEEELAAFFANIIEEKRNKPAQDVISILVEAEETGEKLSGEELVPFCTLLLVAGNETTTNLISNAMYSILETPDVYNVLRSHPELTPQAVEEALRFRAPAPVLRRIAKRDTEIGGHLIKEGDMVLAFVASANRDETKFDRAHLFDIHRHPNPHIAFGHGIHFCLGAPLARLEAKIALTSLISAFPHMECVSITPIENSVIYGLKSFRVKM

SEQ ID NO: 23 - protein, 406 aa, Bacillus amyloliquefaciens
MSNLRSPRQAIQRTLMKGKDGLDVYNPFPWYEKMRRESPIQFDEETKVWSVFLYDDAKKVISDKETFSSLMSDMKSSIAKSMLNMDPPKHTQIRSAVNRAFTPRVLKEWEPRIEEITDNLLKQAKNKGRIDIVKDLSYPLPVIVISELLGVPSEHMDQFKKWSDILVSMPKDASPEEAEKNQQERDQCETELAAFFAEIIDSKRKQPGQDIISILIKEEEEGEKLSAEDLIPFCNLLLVAGNETTTNLISNAVYSILETPGLYEELRQDPSLIAQTVEETLRFRAPAPFVRRTVRHDTELRGRRLKSGDIVLCYIASANRDENKFEQADVFDIHRQSNPHLSFGFGVHFCLGAPLARLEAEVALRGIVKAFSHLEPVRVEPIQNSVMYGLDSLEAEINENRGEEKR

SEQ ID NO: 24 - protein, 396 aa, Bacillus halotolerans
MNVVNRRQALQRALMNGKNKQDAYHPFPWYESMRKEAPVTYDEDNQVWSVFLYDDVKKVIGDKELFSSYMPEQTSSIGNSIINMDPPRHTQIRSVVNRAFTPRVMKQWEPRIQDIADDLIHRFHGRSEFDLVQDFSYPLPVIVISELLGVPSEHMDAFKTWSDILVSTPRDGSEEAEKAFLKERNKCEEELAAFFAGIIEEKRKKPEQDIISILIKAEETGEKLSGEELIPFCTLLLVAGNETTTNLISNAMYSILDTPGAYDELQRHPELVPQAVEEALRFRAPAPVLRRIAKRDTEIGGHQIKEGDMVLAFVASANRDEAKFDRAHKFDIHRHPNPHIAFGHGIHFCLGAPLARLEAAIALTALTQTFSHMEPVSITPIENSVIYGLKSFRVNI

SEQ ID NO: 25 - protein, 398 aa, Bacillus nakamurai
MSKFKNPRQAVQKTLMKGKNGLDAYDPFPWYEKMRRENPVHFDEENKVWSVFLYDDVKKVIGDKEAFSSHRLQMTSSIGNSILNMDPPKHTRIRSVVNRAFTPRVLKEWEPRIQQITDDLLKQAQGRGSIDIVKDLSYPLPVIVISELLGVPSEHMEQFKEWSDILVSTPKDESPEAAKVNEQEQDQCERELASFFARIIEEKRNQPGQDIISILIKAEEEGEKLSGEDLIPFCTLLLMAGNETTTNLISNAVYSIAETPGLYEELRQDPSLIPQVIEETLRFRAPAPFVRRTVKHDIELSGRLLKSGEMVLGYIASANRDEKKFEHADVFDIRRQPNPHLSFGFGIHFCLGAPLARLEAEVALKGLLKTYHKLKPVRVEPIQNSVMYGLTAFEAETN

SEQ ID NO: 26 - protein, 406 aa, Bacillus velezensis
MSKLRSTRQAIQRTLMKGKNGLDVYNPFPWYEKMRRESPIYFDEETKVWSVFLYDDVKKVISDKETFSSRMTDVKSSIAKSMLNMDPPKHTQIRSAVNRAFTPRVLKEWEPRIKDITAHLLKQAKNKGRIDIVKDLSYPLPVMVISELLGVPSERMDQFKKWSDILVSMPKDASPEAAEKNQQERDQCEAELAAFFAGIIESKRKQPGQDIISILIKEEEEGEKLTPEDLIPFCNLLLVAGNETTTNLISNAVYSILETPGLYEELRQDPSLIAQTVEETLRFRAPAPFVRRTVRHDTELRGRRLKSGEIVLCYVASANRDENKFEKAGVFDIHRQSNPHLSFGFGVHFCLGAPLARLEAEAALKGIVKTFSHLEPVRIEPIRNSVMYGLESLEAEINENEGEEKR

SEQ ID NO: 27 - protein, 502 aa, Hyoscyamus muticus
MQFFSLVSIFLFLSFLFLLRKWKNSNSQSKKLPPGPWKLPLLGSMLHMVGGLPHHVLRDLAKKYGPLMHLQLGEVSAVVVTSPDMAKEVLKTHDIAFASRPKLLAPEIVCYNRSDIAFCPYGDYWRQMRKICVLEVLSAKNVRSFSSIRRDEVLRLVNFVRSSTSEPVNFTERLFLFTSSMTCRSAFGKVFKEQETFIQLIKEVIGLAGGFDVADIFPSLKFLHVLTGMEGKIMKAHHKVDAIVEDVINEHKKNLAMGKTNGALGGEDLIDVLLRLMNDGGLQFPITNDNIKAIIFDMFAAGTETSSSTLVWAMVQMMRNPTILAKAQAEVREAFKGKETFDENDVEELKYLKLVIKETLRLHPPVPLLVPRECREETEINGYTIPVKTKVMVNVWALGRDPKYWDDADNFKPERFEQCSVDFIGNNFEYLPFGGGRRICPGISFGLANVYLPLAQLLYHFDWKLPTGMEPKDLDLTELVGITIARKSDLMLVATPYQPSRE

SEQ ID NO: 28 - protein, 514 aa, Nicotiana attenuate
MQLSFEEYQLTKMQLFSLVSIFLFLSFLFLLRKWKNSNSQSKKLPPGPWKLPILGSMLHMVGGLPHHVLRDLAKKYGPLMHLQLGEVSAVVVTSPDMAKEVLKTHDIAFASRPSLLAPEIVCYNRSDLAFCPYGDYWRQMRKICVLEVLSAKNVRTFSSIRRDEVLRLINFIRSSSGEPVNVTERIFLFTSSMTCRSAFGQVFKDQDKFIQLIKEVILLAGGFDVADIFPSLKFLHVLSGMKGKIMNAHHKVDAIVENVINEHKKNLATGKTNGALGGEDLIDVLLRLMNDGGLQFPITNDNIKAIIFDMFAAGTETSSSTIVWAMVEMVKNPTVFTKAQAEVREAFRGKETFDENDVEELSYLKLVIKETLRLHPPVPLLLPRECREETNINGYTIPVKTKVMVNVWALGRDPKYWDDAEIFKPERFEQCSKDFVGNNFEYLPFGGGRRICPGISFGLANAYLPLAQLLYHFDWKLPAGIKPSDLDLTELVGVTAARKSDLYLVATPYQPPQK

SEQ ID NO: 29 - protein, 500 aa, Solanum tuberosum
MQLVSIFLFISFLFLLRKWKKYLNNSQTKKLPPGPWKLPFIGSMHHLAGGLPHRVLRDLAEKYGPLMHLQLGEVSAVVVTSPEMAKQVLKTHDIAFASRPKLLAMDIICYNRRDIAFSPYGEYWRQMRKICIMEVLSAKNVRSFSSIRHDEVVRLIDSIQPCFTSGELVNFTERIIWFTSSMTCRSAFGQVLKEQEVFIKLIREVISLAEGFDVADIFPSYKFLHGFGGAKKKLLNAHRKVDSIVEDVIKEHKKNIATRKSDDAIGGEDLVDVLLRLMNDKSLQFPINNDNIKAVIIDLFAAGTETSSTTTVWAMAEMLKNPSVFAKAQAEVREAFRDKVTFDGNDVEELKYLKLVIKETMRLHAPVPLLVPRECREETEINGYTIPVKTKVMVNVWALGRDPKYWDDAESFKPERFEQCSIDFIGNNFEYLPFGGGRRICPGISFGLANVYFPLAQLLYHFDWKLPTGMEPKDLDLTESAGITVARKGDLYLIATPHQP

SEQ ID NO: 30 - protein, 501 aa, Capsicum annuum
MQFFSLASIFLFLYFLFLLWKWNKSNSQTKKLPPGPWKLPFIGSMHHMAGGLPHYVLRDLAKKYGPFMHLQLGEVSAVIVTSSVVAKEVLKTHDLAFADRPKLLGMDIMCYDSRNIAFSPYGEYWRQMHKICIMELLSAKNIQSFSSIRHDEVVRLIDSIRSSSSSGELINYTKRIIWFTSSITCRSAFGKLLKDQEKFIKVVGEVTSLAQGFDVADIFPSYKFLHTFSGVKKKLLDAHRKVDSIVEDVINAHKRNIAAHKSDDTLGSEDLIDVLLRLAKDKSLKFPITNDNIKAVIVDMFAAGTETTSITTIWAMVEMMKNPSAFAKVQAEVREAFRDKATLDEMNVEELKYLKLVIKETMRIHPPLPLLIARECREETNINGYTIPENTKVIINAWALGRDPKYWDDAESFKPKRFEQCFMDFFGNNFEYLPFGSGRRICPGILFGLANVYLPLAQLLYHFDWKLPTGMEPRDLDMTESVGGTAPRKSDLYLVATPYQP

SEQ ID NO: 31 - protein, 521 aa, Solanum pennellii
MLDPSLSLSYLMEFQFTFNFIFLFLFLSFLYLLVVQRKKSRNLNKKLPPGPWKLPFIGSVHHLALEGGLPHHALTNLGKKYGPFMHLQLGEISTVVVSSMDMAREILKTHDLAFASRPKFLALDIICYKSTDIAFSPYGDYWRQMRKVCVLELLTTKNVRSFSSIRQDEASRLVQFIRSSTCGKPINVTERILWYQSSITCKAAFGELLKDQEKFIELVKELVELASGFSVADIFPSIKILHVLSGLRSRILKVHKNVDAIVEDTINEHKKNLASGKRGNGAFGGEDLVDVLLRLMESGELKIPITNDNIKAIMIDLFAAGSETSATTTIWAMTEMMRNPNVLAKAQAEVREAFKGKETFDEDVIEVLKYLKQIVKETLRLHPPVPLLVPRECREETNINGYTIPLKTRVMVNVYAMGRDPKYWEDAESFIPERFEHSSVDFMGNNFEYLPFGAGRRMCPGMSFGLINVYLPLAKLLYHFDWKLPHGLKPKDVDMTELSAITAARKSELYLIATPYYPSHE

SEQ ID NO: 32 - protein, 692 aa, Arabidopsis thaliana [sequence omitted]

SEQ ID NO: 33 - protein, 730 aa, Brassica napus
MSPPTVFLFYLSRVFRPLEREKISNPSQSQTKKKKMSSALYASGVFNEVKSILGAFLGDSVSDDVVLVIATTSLALVVGFVVLVWRKTTSDQSKELKPLVIPKSLMAKDEDEDVDLGSGKERVSIFFGTQTGTAEGFAKALAEEIKARYEKAAVKVIDLDDYAADDDQYEEKLKKETLSFFCVATYGDGEPTDNAARFYKWFTEGTEGDIRLQKLAYGVFALGNRQYEHFNKIGIVLDEELSKKGAKRLIEVGLGDDDQSIEDDFNAWKESLWPELDKLLRDEDDTSVATPYTAAIPEYRVMIHDPSFISEKSVDSSVANGNAAIDIHHPRRGNVAVQRELHTPESDRSCIHLEFDISCTGITYETGDHVGVYAENHAELVEEAAKLLGHTLDLVFSIHADKEDGSPLGSSLPPPFPGPCTLGTALAKYADLLTPPRKSALVALAAYATEPSEAKKLKHLTSPDGKDEYSQWIVASQRSLLEVMAAFPSAKPPLGVFFAAIAPRLQPRYYSISSSPRLAPNRVHVTCALVYGPTPTGRIHKGLCSTWMKNAVPAEKSRECSGAPIFIRASNFKLPSNPSTPIVMVGPGTGLAPFRGFLQERMALKEDGVELGPSLLFFGCRNRRMDFIYEDELNNYADQGVISELIVAFSREGAQKEYVQHKILEKATQVWNLIKEEGYLYVCGDAKGMARDVHRTLHTIVQEQEGVSSSEAEAIVKKLQTEGRYLRDVW

SEQ ID NO: 34 - protein, 694 aa, Tarenaya hassleriana
MSSSFGASGLVRYLESALGISLGDSVSDDAALVIATTSLAVIVGFAVLLWRKTAADRSREMKPVTVPQSLMAKDEDDDLDMGSGKTRVTIFFGTQTGTAEGFAKALTEEIKARYEKAAVKVVDMDDYAADDDQYAEKLKKETLAFFIIATYGDGEPTDNAARFYKWFTEGNERGAWLQQLTYGVFGLGNRQYEHFNKIGKVLDEQLSEQGAKRLVQVGLGDDDQSIEDDFNAWKEALWPELDKLLRDEDDTSVVSTYTAAIPEYRVFFYDPAVSPEEDSSSSMQNGSSVADIHHPFRVNVAVQKELHKPESDRSCIHLEFDISGTGITYETGDHVGVYAENHVETVGEAGKLLGQSLDLLFSVHADKEDGSPMGSSLPPPFPGPCTLHTALARYADLLNPPRKAALIALAAYATEPSEAEKLKHLTSPDGKDEYAQWIVASQRSLLEVMAAFPSAKPPLGVFFAAVAPRLQPRYYSISSSPRVAPNRVHVTCALVHGPTPTGRIHKGVCSTWMKNATPREKSDDCSAAPIFIRSSNFKLPSNPLTPIVMVGPGTGLAPFRGFLQERMALKENGVQLGLSLLFFGCRNRRMDFIYEDELYNFVDQGTLSEFVVAFSREGPQKEYVQHKMTEKAAEVWKLIKEGYLYVCGDAKGMARDVHRTLHTIVQEQEGVSSSEAEAIVKKLQNEGRYLRDVW

SEQ ID NO: 35 - protein, 694 aa, Quercus suber
MGSNSELVRTIESVLGISLGESVSDSVVLIVTTSFAVIIGLLVFVWKRSSDRSSSSLVKPVEVPKFSSSNKDEDDEVEVDSGKTKVSVFFGTQTGTAEGFAKALADEIKARYEKAVVKVIDLDDYAADDDQYEEKLKKETLAFFMVATYGDGEPTDNAARFYKWFTEGNDRGAWLQQLRYGVFGLGNRQYEHFNKIGNVVDEQLSEQGAKRLIPVGLGDDDQCIEDDFSAWREQLWPELDQLLLDGDDANTVSTPYTAVIPEYRVVIHDPIVTSYEDNYSNMANGTASFDIQHPCRVNVAVEKELHTPESDRSCIHLEFDISGTGITYETGDHVGVYAENCDETVEEAGKLLGQPLDLLFSIHTDNDDGTPLGSSLPPPFPGPCTLRAALARYADLLNPPRKAALIALAAHAVEPNEAERLKFLSSPQGKDDYSKWVVGSQRSLLEIMAEFPSAKPPLGVFFAAVAPRLPPRYYSISSSPRFAPNRIHVTCALVYGPTPTGRIHKGVCSTWMKNAVPLEKSRNCSWAPIFIRQSNFKLPADHSTPIIMVGPGTGFAPFRGFLQERMALKEEGVQLGPALLFFGCRNRRMDFIYEDELNNFVEQGVLSELIVAFSREGPQKEYVQHKMMDQAAHFWSLVSQGGYLYVCGDAKGMARDVHRTLHTIVQEQENVEPSKAEAIVKKLQMDGRYLRDVW

SEQ ID NO: 36 - protein, 692 aa, Prunus persica
MSSNSDLVSMLESALGVSFGGSVTDSVVVIATTSVALILGVLVLVWRRSSDRSREVKQLAVPKPLVVKDEEDEFEVASGKTRVTIFYGTQTGTAEGFAKALAEEIKARYEKAAVKVLDLDDYAEDDDKYEEKLKKETLAFFMLATYGDGEPTDNAARFYKWFTEGKDRGGWLQHLQYGVFALGNRQYEHFNKIGKVVDDQLSEEGAKRLIPVGLGDDDQCIEDDFSAWRESLWPELDQILRDEDDTNSVATPYTAVIPEYRVVIHDSTVVTSYEDNLLNMANGNASFDIHHPCRVNVAVQRELHKPESDRSCIHLEFDVSGTGITYETGDHVGVYADNCVETIEEAAKYLGQPLDLLFTLHTDSDDGTPLGSSLPPPFPGPCTLRTALAHYADLLNPPRKAALLALAAHAVEPSEAERLKFLSSSQGKDEYSKWIVGSQRSLVEVMAEFPSAKPPLGVFFAAVAPRLQPRYYSISSSPRFAPHRVHVTCALVYGPTPTGRVHKGVCSFWMKNAVSLEKSHNSSWAPIFIRQSNFKLPADPSVPVIMVGPGTGFAPFRGFLQERMALKKEGAQLGPALLFFGCRNRRMDFIYEDELNNFVDEGVLSELIVAFSREGPTKEYVQHKMMDRAAHMWDLISQGGYFYVCGDAKGMARDVHRTLHTIVQEQEKVDSTKAEAIVKQLQMDGRYLRDVW

SEQ ID NO: 37 - protein, 692 aa, Callitropsis nootkatensis [sequence omitted]

SEQ ID NO: 38 - protein, 589 aa, Pseudomonas fluorescens
MRSLKPLAALPDRLLDRLVHWARVRPEQTFIAAREAGGDWRLVSYGQMLDSVRAIAQGLLRYGLSADKPLALLSGNDIEHLQLALGAMYAGIPYCPVSPAYSLLSQDFAKLRHVCDLLQPGLVFVSDASAYQRAIDAVLPPETPLISVRGQVPGRRQASFASLLAEPGGAEADAAFAATGPDSIAKFLFTSGSTKLPKAVITTQRMLCANQQMLLQTFPVFGEEPPVLVDWLPWNHTFGGSHNVGIVLYNGGTFYLDEGKPTAQGFAETLRNLKEISPTAYLTVPKGWEELVNALEQDAELRECFFKRMSLFFFAAAGLSQSVWDRLDRVAEQHCGERIRMMAGLGMTEAAPSCTFTTGPLSMAGYIGLPAPGCEVRLVPVDGKLEGRFRGPHIMPGYWRAAQQTAEVFDAQGFYCSGDALKLADAADPQLGLMFDGRIAEDFKLSSGVFVSVGPLRNRAVLEGAPYVQDLVVAAPDRECLGALVFPRLYECRRLAGLGAEASEAQVLASAPVRQWFGDWLQCLNREASGNASRLEWIALQVEPASIDRGEITDKGSINQRAVLQWRAEQVENLYRGREPSILRAEPKP

SEQ ID NO: 39 - protein, 492 aa, Streptomyces sp. V-1
MVRNQGLGSWPVRRARMSPHATAVRHGGTALTYAELSRRVARLANGLRAAGVRPGDRVAYLGPNHPAYLETLFACGQAGAVFVPLNFRLGVPELDHALADSGASVLIHTPEHAETVAALAAGRLLRVPAGELDAADDEPPDLPVGLDDVCLLMYTSGSTGRPKGAMLTHGNLTWNCVNVLVETDLASDERALVAAPLFHAAALGMVCLPTLLKGGTVILHSAFDPGAVLSAVEQERVTLVFGVPTMYQAIAAHPRWRSADLSSLRTLLCGGAPVPADLASRYLDRGLAFVQGYGMTEAAPGVLVLDRAHVAEKIGSAGVPSFFTDVRLAGPSGEPVPPGEKGEIVVSGPNVMKGYWGRPEATAEVLRDGWFHSGDVATVDGDGYFHVVDRLKDMIISGGENIYPAEVENELYGYPGVEACAVIGVPDPRWGEVGKAVVVPADGSRIDGDELLAWLRTRLAGYKVPKSVEFTDRLPTTGSGKILKGEVRRRFG

SEQ ID NO: 40 - protein, 709 aa, Sphingomonas paucimobilis
MTVEAGVRPQAGARDINRLLRPRSIAIVGASETPGSLGASVLANLVRNEFPGDIHLVNPKRETISGRPAVPSVDALPEGVDCAILAIPRVAVLDTMRQLAARKAGAAIIFAAGFAEGGEQGMADQQEIGRIAHEAGIVVEGPNCLGSVNYLDRIPLTFIDTDIKAPSPGGVGIVSQSGAMAAVLAVMLESRTLDLTYSVSTGNEAGSGVEDYVEFMIADEKTRIIAMIVEQFRDPARFLALMDKANAAGKLVVLLHPGKSSAARESAATHTGAMAGDYKLMRAKVERAGVVVAETLEELGDITEIAARCPALPSGGTAVLGESGALKALTLDLAEELELALPTLDDGNAPALRAALPEFVPVSNPLDLTAQGLVDPDMYYRTLAALFEDDRVGTIFAGIIQTNPATIGIKLPPFLKAVRELKATKPVIFGGVDEGADVPADWIEQLRAEGIPYFPTTERALRAIRRLSAAGARDASRTDAAPASVPALASEKGVVPEYKAKALLAPLGISFPKGQFAATVEDAIAAAEAIGGPVVMKAQAAALSHKSDAGGVALNLVGAEAIRAAWDKMFADVKRYDASIILDGVLIEAMGARGLELIVGAKNDPQWGPVILAGFGGVTAEILQDVRLLSPDMTKEAIVAELGKLKQAALLHGYRGSPALDVGAVAELIGQVGRLLRGEPRIQELDLNPVVVYPEGQGAIALDALMLVD

SEQ ID NO: 41 - protein, 627 aa, Pseudomonas syringae
MSSEFRPQPRSGVAQTRYRHVSIGHSAVEVSERNGNLHMRSLEPLAPLPMRLLDRLVHWAQVRPLQTFIAAREQGGDWRRVSYAQMLDSVRAIAQSLLGYGLSAERPLAILSGNDIEHLQIALGAMYAGIPYCPVSPAYSLLSQDFAKLRHVCDLLQPGLIFVSDAAAYQRAIDAVLPTETPLVAVRGHVPGRSQVNFASLLEHPGGAEADVAFAATGPDSIAKFLFTSGSTKLPKAVITTQRMLCANQQMLLQTFPVFGEEPPVLVDWLPWNHTFGGSHNVGIVLYNGGTFYLDDGKPTAQGFAETLRNLKEVSPTAYLTVPKGWEELVSALENDGELRERFFAHMKLFFFAAAGLSQSVWDRLDQVAEQHCGERIRMMAGLGMTEASPSCTFTTGPLSMAGYIGLPAPGCEVRLVPVDGKLEGRFRGPHIMPGYWRAPQQTAEVFDDEGFYCSGDAIKLADPSDPQLGLMFDGRLAEDFKLSSGVFVSVGPLRNRAVLEGSPYVLDLVVAAPDRECLGALVFPRLYECRRLSGLTKAASDAEVLASAPVRAWFADWLQRLNREASGNASRLEWIAVLDEAASIDRGEITDKGSINQRAVLQWRAAKVEALYRGEDPSILRAGPRS

SEQ ID NO: 42 - protein, 499 aa, Nocardia amikacinitolerans
MRNRGLGSWPARRARMTPTAVAVTADDRQITYAQLRERVDRAAQVLRALGVGAGDRVAYLGPNHPVYLEILFAAGRLGAVFVPLNNRSAVAEIEYALTDSGARVLVHHCEHDAAVAALPGAAALGIVRVGGAGGYDDLLAAASAEPIEVEVGLDDDCLIMYTSGSTGRPKGAVLTHGNLTWNALNVLVESDVTGAEVSLVAAPLFHAAALGMICLPTLLKGGRVVLLAKFDPARVLELIERERVTWMFGVPTMFDALAAQPGWADADLSSLRILLCGGAPVPHATIARYVERGLGFVQGYGMTEAAPGVLVLDRAHAEAKLGSAGVPSFFTDVRIVDAEGAQVAPGERGEVLVSGPNVMRGYWNRPDATAEALRDGWFHSGDVATVDADGYAYIVDRVKDVIISGGENIYPAEVENEIAHHPQVAACAVIGVPDEKWGEVGRAVVVAREGTQPDADELLAFLRERLAGFKIPRSVVFVDELPTTGSGKIRKTEVKKQYG

SEQ ID NO: 43 - protein, 276 aa, Pseudomonas fluorescens
MSNYEGRWTTVKVEIEDGIAWVILNRPEKRNAMSPTLNREMIDVLETLEQDPAAGVLVLTGAGEAWTAGMDLKEYFREVDAGPEILQEKIRREASQWQWKLLRMYAKPTIAMVNGWCFGGGFSPLVACDLAICADEATFGLSEINWGIPPGNLVSKAMADTVGHRQSLYYIMTGKTFGGQKAAEMGLVNDSVPLARLREVTIELARNLLEKNPVVLRAAKHGFKRCRELTWEQNEDYLYAKLDQSRLLDTEGGREQGMKQFLDDKSIKPGLQAYKR

SEQ ID NO: 44 - protein, 287 aa, Streptomyces sp. V-1
MSTAVGNGRVRTEPWGETVLVEFDEGIAWVMLNRPDKRNAMNPTLNDEMVRVLDHLEGDDRCRVLVLTGAGESFSAGMDLKEYFREVDATGSTAVQIKVRRASAEWQWKRLANWSKPTIAMVNGWCFGGAFTPLVACDLAFADEDARFGLSEVNWGIPPGGVVSRALAATVPQRDALYYIMTGEPFDGRRAAEMRLVNEALPADRLRERTREVALKLASMNQVVLHAAKTGYKIAQEMPWEQAEDYLYAKLDQSQFADKAGARAKGLTQFLDQKSYRPGLSAFDPEK

SEQ ID NO: 45 - protein, 284 aa, Sphingomonas paucimobilis
MSEENKPVEREEDTVRYEIVNNVAWVYYNRPTKRNAQSPKLNRQMLKVLTELEFRDDVGVLVLGGEGPAWCAGMDLKEYFRETEAEGLAGTRKAQREAYTWWERLRWYQKPTIAMVHGWCFGGAYGPLFACDLAFAADEAQFGLSEVNWGILPGGGATKVAVDLMPMRVAMYHAMMGENLSGQDAARYNLVNESMPADQLKARVKQVAETLIQKNWATVKYTKDAVRRVKEMTYDNAEDYLIRLQEGLNWFDKSDGRHVAMKQFLDDKTFKPGLGHYDKTKTEV

SEQ ID NO: 46 - protein, 276 aa, Pseudomonas syringae
MSNYEGRWKTVKVEIEEGIAWVILNRPEKRNAMSPTLNREMIEVLEVLEQDPDAGVLVLTGAGEAWTAGMDLKEYFREVDAGPEILQEKIRREASQWQWKLLRMYAKPTIAMVNGWCFGGGFSPLVACDLAICADEATFGLSEINWGIPPGNLVSKAMADTVGHRQSLYYIMTGKTFGGQKAAELGLVNESVPLAQLRDVTVDLARNLLEKNPVVLRAAKQGFKRCRELTWEQNEDYLYAKLDQSRLLDTEGGREQGMKQFLDDKSIKPGLQTYKR

SEQ ID NO: 47 - protein, 278 aa, Saccharopolyspora flava
MSTSEKPWGNTVLVDFEDGIAWVTLNRPEKRNAMNPALNDEMVATLDALEADPRCRVLVLTGAGEAWSAGMDLKEYFREVDEADDPSVQIRVRRASAEWQWKRLANWSKPTIAMVNGWCFGGAFTPLVACDLAIADENARFGLSEINWGIPPGGVVTRALAATVPQRDALYYIMTGELFDGRQASEMRLVNEAVPAERLRERTRELAAKLAATNPVVLRAAKVGYKVARDMPWEQAEDYLYAKFEQSQFLDHTNGRQKGMSQFLDDKTYKPGLSAYRD

SEQ ID NO: 48 - protein, 356 aa, Vanilla planifolia
MAAKLLFFLLFLVSALSVALAGFEEDNPIRSVTQRPDSIEPAILGVLGSCRHAFHFARFARRYGKSYGSEEEIKKRFGIFVENLAFIRSTNRKDLSYTLGINQFADLTWEEFRTNRLGAAQNCSATAHGNHRFVDGVLPVTRDWREQGIVSPVKDQGSCGSCWTFSTTGALEAAYTQLTGKSTSLSEQQLVDCASAFNNFGCNGGLPSQAFEYVKYNGGIDTEQTYPYLGVNGICNFKQENVGVKVIDSINITLGAEDELKHAVGLVRPVSVAFEVVKGFNLYKKGVYSSDTCGRDPMDVNHAVLAVGYGVEDGIPYWLIKNSWGTNWGDNGYFKMELGKNMCGVATCASYPIVAV

SEQ ID NO: 49 - protein, 358 aa, Glechoma hederacea
MARLLLLLVGVLIACAAGARAGSEFLAEDNPIRQVVDGMHELESSILKAVGNSRRAFSFARFAHRYGKSYESSEEIQKRFQVYSENLRMIRSHNKKGLSYSMGVNEFSDLTWDEFKKHRLGAAQNCSATRRGNHKLTSAILPDSKDWRESGIVSPVKSQGSCGSCWTFSSTGALEAAYAQAFGKGISLSEQQLVDCAGAFNNFGCNGGLPSQAFEYIKYNGGLMTEEAYPYTGHDGECKYSSENAAVQVLDSVNITLGAEDELKHAVALVRPVSVAFEVVDGFRSYNGGVYTSTTCGSDPMDVNHAVLAVGYGVEGGVPYWLIKNSWGADWGDQGYFKMEMGKNMCGVATCASYPVVA

SEQ ID NO: 50 - protein, 525 aa, Saccharomyces cerevisiae
MNEIDEKNQAPVQQECLKEMIQNGHARRMGSVEDLYVALNRQNLYRNFCTYGELSDYCTRDQLTLALREICLKNPTLLHIVLPTRWPNHENYYRSSEYYSRPHPVHDYISVLQELKLSGVVLNEQPEYSAVMKQILEEFKNSKGSYTAKIFKLTTTLTIPYFGPTGPSWRLICLPEEHTEKWKKFIFVSNHCMSDGRSSIHFFHDLRDELNNIKTPPKKLDYIFKYEEDYQLLRKLPEPIEKVIDFRPPYLFIPKSLLSGFIYNHLRFSSKGVCMRMDDVEKTDDVVTEIINISPTEFQAIKANIKSNIQGKCTITPFLHVCWFVSLHKWGKFFKPLNFEWLTDIFIPADCRSQLPDDDEMRQMYRYGANVGFIDFTPWISEFDMNDNKENFWPLIEHYHEVISEALRNKKHLHGLGFNIQGFVQKYVNIDKVMCDRAIGKRRGGTLLSNVGLFNQLEEPDAKYSICDLAFGQFQGSWHQAFSLGVCSTNVKGMNIVVASTKNVVGSQESLEELCSIYKALLLGP

SEQ ID NO: 51 - protein, 545 aa, Saccharomyces pastorianus
METEESQFSSITKIINPKTLMNTYSEKTSLVQDECLVKMIQNGHSRRMGSVEDLYAALNRQKLYRNFSTYSELNDYCTKDQLALALRNICLKNPTLLHIVLPARWPDHKKYYLSSEYYSQPRPKHDYISVLPELKLDGVILNEQPEHNALMKQILEEFANSNGSYTAKIFKLTTALTIPYTGPTSPTWRLICLPEEDDTNKWKKFIFVSNHCMCDGRSSIHFFQDLRDELNNIKTLPKKLDYIFEYEKDYQLLRKLPEPIENMIDFRPPYLFIPKSLLSGFIYSHLRFSSKGVCTRMDEIEKSDEIVTEIINISPSEFQKIRTKIKLNIPGKCTITPFLEVCWFVTLHKWGKFFKPLKFEWLTDVFIPADCRSLLPEDEEVRAMYRYGANVGFVDFTPWISKFNMNDSKENFWPLIAHYHEVISGAIKDKKHLNGLGFNIQSLVQKYVNIDKVMRDRALGKSRGGTLLSNVGMFHQSEETEHKYRIRDLAFGQFQGSWHQAFSLGVSSTNVKGMNILISSTKNVVGSQELLEELCAMYKALLLNP

SEQ ID NO: 52 - protein, 524 aa, Saccharomyces kudriavzevii
MTKISEEHFPIQHECLERMIQNGHARRMGSVEDLYVALNRQKLYRNFSAYAELSDYCSKDQLTLALRNICLKNPTLLHIVLPTRWPDHENYYLSSEYYSHPHPEHDYISVLPELKLDGVIINEQPENGKIVRQILEEFRNSNGTYNAKIFKLTTALTIPYFGPTSPNWRLICLPEEHTDKWKKFIFVSNHCMSDGRSSIHFFHDLKAELNDIKTPPKKLDYLFKYENDYQLLRKLPEPIEKVIDFRPPYLFIPKSLLSGFIYNHLRFASRGICTRMDDMEKSDDVVAEIITISPSELQEIRTKIKSNIQGKCTLTPFLQVCWFVSLHQWGKFFKPLNFEWLTDIFIPADCRPQLPDDEEVRQMYRYGANVGFVDFTPWICESNMNDNKENFWPLIEHYHQVISGALRDNKHLHGLGLNIQGFVQKYVNIDKAMCDRAIGKARGGTLLSNVGMFKQLDSSNCNYSIKDLAFGQFQGSWHQAFSLGVCSTDVKGMNIIVASTKNVVGSQESLEELCRVYKAMLLGP

SEQ ID NO: 53 - protein, 535 aa, Saccharomyces cerevisiae
MEDIEGYEPHITQELIDRGHARRMGHLENYFAVLSRQKMYSNFTVYAELNKGVNKRQLMLVLKVLLQKYSTLAHTIIPKHYPHHEAYYSSEEYLSKPFPQHDFIKVISHLEFDDLIMNNQPEYREVMEKISEQFKKDDFKVTNRLIELISPVIIPLGNPKRPNWRLICLPGKDTDGFETWKNFVYVTNHCGSDGVSGSNFFKDLALLFCKIEEKGFDYDEEFIEDQVIIDYDRDYTEISKLPKPITDRIDYKPALTSLPKFFLTTFIYEHCNFKTSSESTLTARYSPSSNANASYNYLLHFSTKQVEQIRAQIKKNVHDGCTLTPFIQACFLVALYRLDKLFTKSLLEYGFDVAIPSNARRFLPNDEELRDSYKYGSNVGGSHYAYLISSFDIPEGDNDKFWSLVEYYYDRFLESYDNGDHLIGLGVLQLDFIVENKNIDSLLANSYLHQQRGGAIISNTGLVSQDTTKPYYVRDLIFSQSAGALRFAFGLNVCSTNVNGMNMDMSVVQGTLRDRGEWESFCKLFYQTIGEFASL

SEQ ID NO: 54 - protein, 545 aa, Saccharomyces eubayanus
MDSLEEYEPHVTQELIDRGHARRMGHLENYFAVLHRQNMYSNFAVYGELNKAVSKRQLRLALRLLLLKYPILSHTIVPKKYPNHEAYYLSQEYLNKPFPQHDFIKVIPHLELEDLIMNSQSEYREVISKVSEQYKNDNFKVTSSLIELVTPIIVPACDPERPNWRLICLPSRDTSAGEAWTNFVYVSNHCGSDGISGTNFFQDLTALLSTIEENGFDYEEEIVDNNVIIDYNEDHKEISKLPISITDRIDYKPRLTSLPKFFLKNIVSEYCEFRTSNESTVTSRYSPSSNANAGFNHLLHFSAEDTQQIRSEIKKKVHAGCTITPFIQACFFVALYRHDKVFTKSFLEYGFDVALPSSTRRFLPNDEELRDSYKYGANVGGSHYTYLISSFNVPEGDANKFWRLVEYYHDCFLKSYDNGDHLIGLGTLQLDFIVQNKNVDQIISTTYLDHQRGGAIISNTGFVRQDTTKPYYARDLIFSQSAGALRFAFGLNVCSTNVGGMNMDMSVVQGTLRNRGEWESFCDVFYHAIGEFASLGCDTAVAGLV

SEQ ID NO: 55 - protein, 571 aa, synthetic construct
MAPQEQAVSQVMEKQSNNNNSDVIFRSKLPDIYIPNHLSLHDYIFQNISEFATKPCLINGPTGHVYTYSDVHVISRQIAANFHKLGVNQNDVVMLLLPNCPEFVLSFLAASFRGATATAANPFFTPAEIAKQAKASNTKLIITEARYVDKIKPLQNDDGVVIVCIDDNESVPIPEGCLRFTELTQSTTEASEVIDSVEISPDDVVALPYSSGTTGLPKGVMLTHKGLVTSVAQQVDGENPNLYFHSDDVILCVLPMFHIYALNSIMLCGLRVGAAILIMPKFEINLLLELIQRCKVTVAPMVPPIVLAIAKSSETEKYDLSSIRVVKSGAAPLGKELEDAVNAKFPNAKLGQGYGMTEAGPVLAMSLGFAKEPFPVKSGACGTVVRNAEMKIVDPDTGDSLSRNQPGEICIRGHQIMKGYLNNPAATAETIDKDGWLHTGDIGLIDDDDELFIVDRLKELIKYKGFQVAPAELEALLIGHPDITDVAVVAMKEEAAGEVPVAFVVKSKDSELSEDDVKQFVSKQVVFYKRINKVFFTESIPKAPSGKILRKDLRAKLANGLVDEAAAKSGR

SEQ ID NO: 56 - protein, 554 aa, synthetic construct
MGDCVAPKEDLIFRSKLPDIYIPKHLPLHTYCFENISKVGDKSCLINGATGETFTYSQVELLSRKVASGLNKLGIQQGDTIMLLLPNSPEYFFAFLGASYRGAISTMANPFFTSAEVIKQLKASLAKLIITQACYVDKVKDYAAEKNIQIICIDDAPQDCLHFSKLMEADESEMPEVVIDSDDVVALPYSSGTTGLPKGVMLTHKGLVTSVAQQVDGDNPNLYMHSEDVMICILPLFHIYSLNAVLCCGLRAGVTILIMQKFDIVPFLELIQKYKVTIGPFVPPIVLAIAKSPVVDKYDLSSVRTVMSGAAPLGKELEDAVRAKFPNAKLGQGYGMTEAGPVLAMCLAFAKEPYEIKSGACGTVVRNAEMKIVDPETNASLPRNQRGEICIRGDQIMKGYLNDPESTRTTIDEEGWLHTGDIGFIDDDDELFIVDRLKEIIKYKGFQVAPAELEALLLTHPTISDAAVVPMIDEKAGEVPVAFVVRTNGFTTTEEEIKQFVSKQVVFYKRIFRVFFVDAIPKSPSGKILRKDLRAKIASGDLPKVDEAAAKSGR

SEQ ID NO: 57 - protein, 543 aa, Paulownia fortune
METTITKQEDIIFRSKLPDIYIPKHLPLHSYCFENISKFSTRPCLINGATNEVYTYEEVELIARKVATGLSKLGIQQGDTILLLLPNSPEYVFAFLGASYIGAISTMANPFFTPAEVIKQAKASNAKLIITQACYVEKVRDYALEKGVKVMCIDAPSADCLQFSELTSADERDMPAVKIHPDDVVALPYSSGTTGLPKGVMLTHKGLVTSVAQQVDGENPNLYIHSEDVMLCVLPLFHIYSLNSVLLCGLRVGAAILIMQKFDIVPFLELIQKYKVTIGPFVPPIVLAIVKSPVVDKYDLSSVRTVMSGAAPLGKELEDAVRIKFPNAKLGQGYGMTEAGPVLAMCLAFAKEPFEIKSGACGTVVRNAEMKIVDIETGASLGRNQPGEICIRGDQIMKGYLNDLESTEGTIDKDGWLHTGDIGFIDTDDELFIVDRLKEIIKYKGFQVAPAELEALLLNHPYISDAAVVPMKDEQAGEVPVAFVVRSNGSTITEDEIKQFISKQVVFYKRINRVFFIDAIPKSPSGKILRKDLRARLAAGVPN

SEQ ID NO: 58 - protein, 551 aa, Brassica napus
MAPQEDAMQKQSSNNSDVIFRSKLPDIYIPNHLPLHDYIFQNISEFASKPCLINGPTGHVYTYSDVHVASRRIAAGFQKLGVNKNDVVMILLSNCPEFVLSFLAASFRGATATAANPFFTPAEIAKQAKASNSKLIVTESRYVDKIKDLQNDGVIIVCTDEEPSPIPEGCLRFTELTQSTEIETVEISSDDVVALPYSSGTTGLPKGVMLTHRGLVTSVAQQVDGDNPNLYFHSDDVILCVLPLFHIYALNSIMLCGLRVGASILIMPKFEINLLLELIQRCKVTVAPMVPPIVLAMAKSPETEKYDLSSIRVVKSGAAPLGKELEDAVSAKFPNAKLGQGYGMTEAGPVLAMSLGFAKEPFPVKSGACGTVVRNAEMKIIDPDTGDSLSKNKPGEICIRGHQIMKGYLNNPAATAETIDKDGWLHTGDIGLIDDDDELFIVDRLKELIKYKGFQVAPAELEALLIGHQDITDVAVVAMKEEAAGEVPVAFVVKSKDSELSEDDVKQFVAKQVVFYKRINKVFFVESIPKAPSGKILRKDLRAKLVNGLVN

SEQ ID NO: 59 - protein, 545 aa, Capsicum baccatum 4
MPMENEAKQGDIIFRSKLPDIYIPNHLSLHSYCFENISEFSSRPCLINGANNQIYTYADVELNSRKVAAGLHKQFGIQQKDTIMILLPNSPEFVFAFLGASYLGAISTMANPLFTPAEVVKQVKASNAEIIVTQACHVNKVKDYALENDVKIVCIDSAPEGCVHFSELIQADEHDIPEVQIKPDDVVALPYSSGTTGLPKGVMLTHKGLVTSVAQQVDGENPNLYIHSEDVMLCVLPLFHIYSLNSVLLCGLRVGAAILIMQKFDIVPFLELIQNYKVTIGPFVPPIVLAIAKSPMVDNYDLSSVRTVMSGAAPLGKELEDTVRAKFPNAKLGQGYGMTEAGPVLAMCLAFAKEPFEIKSGACGTVVRNAEMKIVDPDTGNSLHRNQSGEICIRGDQIMKGYLNDPEATAGTIDKEGWLHTGDIGYIDNDDELFIVDRLKELIKYKGFQVAPAELEALLLNHPNISDAAVVPMKDEQAGEVPVAFVVRSNGSTITEDEVKEFISKQVIFYKRIKRVFFVDGVPKSPSGKILRKDLRAKLAAGFPN

SEQ ID NO: 60 - protein, 384 aa, Rheum palmatum
MATEEMKKLATVMAIGTANPPNCYYQADFPDFYFRVTNSDHLINLKQKFKRLCENSRIEKRYLHVTEEILKENPNIAAYEATSLNVRHKMQVKGVAELGKEAALKAIKEWGQPKSKITHLIVCCLAGVDMPGADYQLTKLLDLDPSVKRFMFYHLGCYAGGTVLRLAKDIAENNKGARVLIVCSEMTTTCFRGPSETHLDSMIGQAILGDGAAAVIVGADPDLTVERPIFELVSTAQTIVPESHGAIEGHLLESGLSFHLYKTVPTLISNNIKTCLSDAFTPLNISDWNSLFWIAHPGGPAILDQVTAKVGLEKEKLKVTRQVLKDYGNMSSATVFFIMDEMRKKSLENGQATTGEGLEWGVLFGFGPGITVETVVLRSVPVIS

SEQ ID NO: 61 - protein, 383 aa, Rheum palmatum
MVTVEEVRKAQRAEGPATVLAIGTATPPNCVGQSTYPDYYFRITNSEHKIELKQKFQRMCDKSMIKKRYMYLTEEILKENPSMCEYMAPSLDARQDMVIVEIPKLGKEAATKAIKEWGQPKSKITHLVFCTTSGVDMPGADYQLIKLFGLRPSVKRLMMYQQGCFAGGTVLRLAKDLAENNRGARVLVVCSEITVVTFRGPSDTHLDCLVGQALFGDGVASIIVGADPLPEIEKPLFELVSAAQTILPDSEGAIEGHLREVGLTFHLLENVPALISKNIEKSLNETFKPLDIMDWNSLFWIAHPGGPAILDQVEAKLGLKPEKLEATGHILSEYGNMSSACVLFILDVVRRKSAANGVTTRILSIGQISKSLLILAWFLFSLV

SEQ ID NO: 62 - protein, 388 aa, Polygonum cuspidatum
MAASTDEMTKALTAATVLAIGTANPPNCYYQADFPDFYFRATNSDHLTHLKHKFKRICEKSMIEKRYLQLTEDILKENPNIGAYEAPSLDVRHEIQVKGVAQLGKEAALKAMQEWGQPKSKITHLIVCCIAGVDMPGANYQLTKLLDLNSSVKRFMFYHLGCYAGGTVLRLAKDIAENNKGARVLIVCSEMTPICFRGPSETHIDSMVGQAIFGDGAAAVIVGANPDLTVEEPIFELISTAQTIIPESDGAIEGHLLEVGLSFQLYQNVPALISNSIGTCLSEAFTPLNISNWNSLFWIAHPGGPAILDHVEATVGLNKEKLKATRQVLNDYGNMSSACVFFIMDEMRKKSLENGHATTGEGLQWGVLFGFGPGITVETVVLRSVPII

SEQ ID NO: 63 - protein, 389 aa, Camellia sinensis
MVTVEDIRRAQRAEGPATVMAIGTATPPNCVDQSTYPDYYFRITNSEHKAELKEKFKRMCDKSMIKKRYMYLTEEILKENPQVCGYMAPSLDARQDMVVVEVPKLGKEAATKAIKEWGQPKSKITHLVFCTTSGVDMPGADYQLTKLLGLRPSVKRLMMYQQGCFAGGTVLRLAKDLAENNKGARVLVVCSGITAVTFRGPSDTHLDSLVGQALFGDGAAAIIVGSDPIPEVENPLFELVSAAQTILPDSDGAIDGHLREVGLTFHLLKDVPGLISKNIEKSLAEAFQPLGISDWNSLFWIAHPGGPAILDQVELKLGLKEEKLRATRHVLSEYGNMSSACVLFILDEMRKKSAADGLKTTGEGLEWGVLFGFGPGLTVETVVLHSLCT

SEQ ID NO: 64 - protein, 393 aa, Vitis vinifera
MVSVGEIRKSQRAEGPATVLAIGTATPANCVYQADYPDYYFRITNSEHMTELKEKFKRMCEKSMINKRYMHLTEEILKENPNVCAYMAPSLDARQDMVVVEVPKLGKEAAVKAIKEWGQPKSKITHLVFCTTSGVDMPGADYQLTKLLGLKPSVKRLMMYQQGCFAGGTVLRLAKDLAENNAGARVLVVCSEITAVTFRGPSDTHLDSLVGQALFGDGAAAIIIGADPDTKIERPLFELVSAAQTILPDSEGAIDGHLREVGLTFHLLKDVPGLISKNIEKSLVEAFKPIGISDWNSLFWIAHPGGPAILDQVELKLGLKEEKLRATRHVLSEYGNMSSACVLFILDEMRKKSIEEGKGTTGEGLEWGVLFGFGPGLTVETVVLHSLATQSTH

SEQ ID NO: 65 - protein, 274 aa, Brettanomyces bruxellensis
MSFIGASRSIRGHIPIRALALSHSTSFKQPVRAIATYLHRTQHRPLYNTYKKGFSRNSFLLLAAMPLMTISDSVKDSLTKSEVVPTVIHDKSFLPKGFLTIQYDSGKEVALGNNIRPADSKNLPRIDFTLNLPSDASSTFNISKDDRFTLIVTDPDAPTRNDEKWSEYLHYLAVDVQLNTFNAENASSNDQLSTADLKGRTLYPYIGPGPPPKTGKHRYVFLLYKQTPGVTPEAPKDRPNWGTGIRGAGAAEYAEKYKLTPYAVNFFYAQNDQQ

SEQ ID NO: 66 - protein, 201 aa, Brettanomyces bruxellensis
MAKVAIIIYTLYHHISELAEAVKKGVEAAGSQADIFQVPETLPENILKILSAPKKPDYPIATTDTLTSYDAILFGVPTRFGNMPSQLKSFIDGTGGLWAKGALYHKPAGVFVSTNTGGGNEMTAVSLLSTFAHHGMIYVPLGFAKAFGELGTTSEAHGGSAWGAGCLAGADGSRTPSELELKIAHIQGEEFAKVAAQLTKN

SEQ ID NO: 67 - protein, 154 aa, Brettanomyces bruxellensis
MVKAVAVVRGDSTVKGVVTFEQTSESEPTTINYNIEGNDPNALRGFHIHTFGDNTNGCTSAGPHFNPFGKTHGAPTDENRHVGDLGNIKTDANGVAKGTIKDKLVKLIGANSIIGRTVVVHAGTDDLGKGGDAGSLQTGNAGGRPACGVIGLSA

SEQ ID NO: 68 - protein, 154 aa, Ogataea parapolymorpha
MVKAVAVVRGDSTVKGIVTFEQASESEPTTVSWEISGNDPNALRGFHIHQFGDNTNGCTSAGPHFNPFGKNHGAPEDSERHVGDLGNITTDANGVAKGAKQDSLIKLFGENSILGRTVVVHSGTDDLGKGGHPDSLKTGNAGGRPACGVIGFSS

SEQ ID NO: 69 - protein, 440 aa, Capsicum annuum
MAFALPSSLVSVCNKSFIKPSSLTPSTLRFHKLSFIDQSLSNMYIPCAFFYPKVQQRLEDSKNSDELSHIAHLLQTSLSQTLVSYYPYAGKLKDNATVDCNDMGAEFLSVRIKCSMSEILDHPHASLAESIVLPKDLPWANNCEGGNLLVVQVSKFDCGGIAISVCFSHKIGDGCSLLNFLNDWSSVTRDHTTTTLVPSPRFVGDSVFSTQKYGSLITPQILSDLNQCVQKRLIFPTDKLDALRAKVAEESGVKNPTRAEVVSALLFKCATKASSSMLPSKLVHFLNIRTMIKPRLPRNAIGNLSSIFSIEATNMQDMELPTLVRNLRKEVEVAYKKDQVEQNELILEVVESMREGKLPFENMDGYKNVYTCSNLCKYPYYTVDFGWGRPERVCLGNGPSKNAFFLKDYKAGQGVEARVMLHKQQMSEFERNEELVEFIA

SEQ ID NO: 70 - protein, 440 aa, Capsicum frutescens
MAFALPSSLVSICDKSFIKPSSLTPSTLRFHKLSFIDQSLSNMYIPCAFFYPKVQQRLEDSKNSDELSHIAHLLQTSLSQTLVSYYPYAGKLKDNATVDCNDMGAEFLSVRIKCSMSEILDHPHASLAESIVLPKDLPWANNCEGGNLLVVQVSKFDCGGIAISVCFSHKIGDGCSLLNFLNDWSSVTRDHTTTTLVPSPRFVGDSVFSTKKYGSLITPQILSDLNECVQKRLIFPTDKLDALRAKVAEESGVKNPTRAEVVSALLFKCATKASSSMLPSKLVHFLNIRTMIKPRLPRNAIGNLSSIFSIEATNMQDMELPTLVRNLRKEVEVAYKKDQVEQNELILEVVESMREGKLPFENMDGYENVYTCSNLCKYPYYTVDFGWGRPERVCLGNGPSKNAFFLKDYKAGQGVEARVMLHKQQMSEFERNEELLEFIA

SEQ ID NO: 71 - protein, 415 aa, Solanum lycospersicum
MAFALPSSLVSVCDKSFIKPSSLTPSTLRFHKLSFIDQSLSNMYIPCAFFYPKVQQRLEDSKNSDELSHIAHLLQTSLSQTLVSYYPYAGKLKDNATVDCNDMGAEFLSVRIKCSMSEILDHPHASLAESIVLPKDLPWANNCEGGNLLVVQVSKFDCGGIAISVCFSHKIGDGCSLLNFLNDWSSVTRDHTTTTLVPSPRFVGDSVFSTQKYGSLITPQILSDLNQCVQKRLIFPTDKLDALRAKVAEESGVKNPTRAEVVSALLFKCATKASSSMLPSKLVHFLNIRTMIKPRLPRNAIGNLSSIFSIEATNMQDMELPTLVRNLRKEVEVAYKKDQVEQNELILEVVESMREGKLPFENMDGYENVYTCSNLCKYPYYTVDFGWGRPERVCLGNGPSKNAFFLKDYKAGQGV

SEQ ID NO: 72 - protein, 415 aa, Capsicum chacoense
MAFALPSSLVSVCDKSFIKPSSLTPSTLRFHKLSFIDQSLSNMYIPCAFFYPKVQQRLEDSKNSDELSHIAHLLQTSLSQTLVSYYPYAGKLKDNATVDCNDMGAEFLSVRINCSMSEILDHPHASLAESVVLPKDLPWANNCEGGNLLVVQVSKFDCGGIAISVCFSHKIGDGCSLLNFLNDWSSITRDHTTTTLVPSPRFVGDSVFSTQKYGSLITPQILSDLNECVQKRLIFPTDKLNALRAKVAEESGVKNPTRAEVVSALLFKCATKASSSMLPSKLVHFLNIRTMIKPRLPRNAIGNLSSIFSIEATNMQDMELPTLVRNLRKEVEVAYKKDQVEQNELILEVVESMREGKLPFENMDGYENVYTCSNLCKYPYYTVDFGWGRPERVCLGNGPSKNAFFLKDYKAGQGV

SEQ ID NO: 73 - protein, 440 aa, Capsicum annuum
MAFALPSSLVSVCNKSFIKPSSLTPSTLRFHKLSFIDQSLSNMYIPCAFFYPKVQQRLEDSKNSDELSHIAHLLQTSLSQTLVSYYPYAGKLKDNATVDCNDMGAEFLSVRIKCSMSEILDHPHASLAESIVLPKDLPWANNCEGGNLLVVQVSKFDCGGIAISVCFSHKIGDGCSLLNFLNDWSSVTRDRTTTTLVPSPRFVGDSVFSTQKYGSLITPQILSDLNQCVQKRLIFPTDKLDALRAKVAEESGVKNPTRAEVVSALLFKCATKASSSMLPSKLVHFLNIRTMIKPRLPRNAIGNLSSIFSIEATNMQDMELPTLVRNLRKEVEVAYKKDQVEQNELILEVVESMREGKLPFENMDGYKNVYTCSNLCKYPYYTVDFGWGRPERVCLGNGPSKNAFFLKDYKAGQGVEARVMLHKQQMSEFERNEELLEFIA

SEQ ID NO: 74 - protein, 459 aa, Capsicum chinesne
MANITNEFMGHDMLAPFTAGWQSDMEPLVIEKSEGSYVYDINGKKYLDTLSGLWCATLGGSETRLVEAANKQLNTLPFYHSFWNRTTKPSLDLAKELLNMFTANKMAKVFFTNSGSEANDTQVKMVWYYNNALGRPQKKKIIARAKAYHGSTYISAGLSGLPPMHQKFDLPPPFVLHTECPHYWAYHLPGETEEEFSTRLANNLESLILKEGPETVAAFIAEPVLGAAGVILPPATYFDKVQAILRKHDILFIADEVVCGFGRLGTMFGSDKYNIKPDLVSVGKALSSGYMPIAAVLVSQKISSVILSESNKIGAFCHGFTYSGHPVACAVALEALKIYKERNITEVVNKISQKFQEGLKAFADSPIIGEIRGTGLALSTEFVDNKSPNDPFPYEWAVGTYFGAQCAKYGMLVSSTGDHVNMAPPFILSLEELDELIRIYGKALKDTEKRVEELKSQKQ

SEQ ID NO: 75 - protein, 459 aa, Capsicum frutesence
MANITNEFMGHDMLAPFTAGWQSDMEPLVIEKSKGSYVYDINGKKYLDTLSGLWCATLGGSETRLVEAANKQLNTLPFYHSFWNRTTKPSLDLAKELLNMFTANKMAKVFFTNSGSEANDTQVKLVWYYNNALGRPQKKKIIARAKAYHGSTYISAGLSGLPPMHQKFDLPPPFVLHTECPHYWAYHLPGETEEEFSTRLANNLESLILNEGPETVAAFIAEPVLGAAGVILPPATYFDKVQAILRKHDILFIADEVVCGFGRLGTMFGSDKYNIKPDLVSVAKALSSGYMPIAAVLVSQKISSVILSESNKIGAFCHGFTYSGHPVACAVALEALKIYKERNITEVVNKISQKFQEGLKAFADSPIIGEIRGTGLALSTEFVDNKSPNDPFPYEWAVGTYFGAQCAKYGMLVSSTGDHVNMAPPFTLSLEELDELIRIYGKALKDTEKRVEELKSQKK

SEQ ID NO: 76 - protein, 459 aa, Capsicum chinesnese
MANITNEFMGHDMLAPFTAGWQSDMEPLVIEKSEGSYVYDINGKKYLDTLSGLWCATLGGSETRLVEAANKQLNTLPFYHSFWNRTTKPSLDLAKELLNMFTANKMAKVFFTNSGSEANDTQVKLVWYYNNALGRPQKKKIIARAKAYHGSTYISAGLSGLPPMHQKFDLPPPFVLHTECPHYWAYHLPGETEEEFSTRLANNLESLILKEGPETVAAFIAEPVLGAAGVILPPATYFDKVQTILRKYDILFIADEVVCGFGRLGTMFGGDKYNIKPDLVSVAKALSSGYMPIAAVLVSQKISSVILSESNKIGAFCHGFTYSGHPVACAVALEALKIYKERNITEVVNKISQKFQEGLKAFADSPIIGEIRGTGLALSTEFVDNKSPNDPFPYEWAVGTYFGAQCAKYGMLVSSTGDHVNMAPPFMLSLEELDELIRIYGKALKDTEKRVEELKSQKK

SEQ ID NO: 77 - protein, 459 aa, Capsicum baccatum
MANITNEFMGHDMLAPFTAGWQSDMEPLVIEKSEGSYVYDINGKKYLDTLSGLWCTTLGGSETRLVEAANKQLNTLPFYHSFWNRTTKPSLDLAKELLNMFTANKMAKVFFTNSGSEANDTQVKLVWYYNNALGRPQKKKIIARAKAYHGSTYISAGLSGLPPMHQKFDLPPPFVLHTECPHYWAYHLPGETEEEFSTRLANNLESLILKEGPETVAAFIAEPVLGAAGVILPPATYFDKVQAILRKHDILFIADEVVCGFGRLGTMFGSDKYNIKPDLVSVAKALSSGYMPIAAVLVSQKISSVILSESNKIGAFCHGFTYSGHPVACAVALEALKIYKERNITEVVNKISQKFQEGLKAFADSPIIGEIRGTGLALSTEFVDNKSPNDPFPYEWAVGTYFGTQCAKYGMLVSSTGDHVNMAPSFTLSLEELDELIRIYGKALKDTEKRVEELKSQKK

SEQ ID NO: 78 - protein, 458 aa, Solanum lycopersicum
MAKTNGFMGHDMLAPFTAAWMIDMGPLVIDKAEGSYVYDVNGKKYLDSLSGLWCSVLGGSEPRLIEAANKQLNKLAFYHSFWNRTTKPSLDLAKELINMFTANKMGKVFFTSSGSEANDTQVKLVWYYNNAIGRPNKKKIISRKNAYHGSTYMTAGLSGLPSLHLKFDLPPPYILHTDCPHYWNYHLPGETEEEYSTRLANNLENLILKEGPETVAAFIAEPVMGGAGVIIPPATYFEKIQAVLKKYDILFIADEVICGFGRLGTMFGCDKYNIKPDLVSIAKALSGGYIPIGAVLVSEEISKVIMSQSNQLGVFCHGFTYSGHPVACAVALEALKIYKEKNITEVVNKLSPKFQEGLKAFIDSPIIGEIRGTGLVLSTEFVDNKSPNDPFPPEWGVGTYFGSQCQKHGMLVSFSGDHVNMAPPFTLSLEELDEMISIYGKALKDTEKRVEELKSQKK

SEQ ID NO: 79 - protein, 716 aa, Rhodosporidium toruloides
MAPSLDSISHSFANGVASAKQAVNGASTNLAVAGSHLPTTQVTQVDIVEKMLAAPTDSTLELDGYSLNLGDVVSAARKGRPVRVKDSDEIRSKIDKSVEFLRSQLSMSVYGVTTGFGGSADTRTEDAISLQKALLEHQLCGVLPSSFDSFRLGRGLENSLPLEVVRGAMTIRVNSLTRGHSAVRLVVLEALTNFLNHGITPIVPLRGTISASGDLSPLSYIAAAISGHPDSKVHVVHEGKEKILYAREAMALFNLEPVVLGPKEGLGLVNGTAVSASMATLALHDAHMLSLLSQSLTAMTVEAMVGHAGSFHPFLHDVTRPHPTQIEVAGNIRKLLEGSRFAVHHEEEVKVKDDEGILRQDRYPLRTSPQWLGPLVSDLIHAHAVLTIEAGQSTTDNPLIDVENKTSHHGGNFQAAAVANTMEKTRLGLAQIGKLNFTQLTEMLNAGMNRGLPSCLAAEDPSLSYHCKGLDIAAAAYTSELGHLANPVTTHVQPAEMANQAVNSLALISARRTTESNDVLSLLLATHLYCVLQAIDLRAIEFEFKKQFGPAIVSLIDQHFGSAMTGSNLRDELVEKVNKTLAKRLEQTNSYDLVPRWHDAFSFAAGTVVEVLSSTSLSLAAVNAWKVAAAESAISLTRQVRETFWSAASTSSPALSYLSPRTQILYAFVREELGVKARRGDVFLGKQEVTIGSNVSKIYEAIKSGRINNVLLKMLA

SEQ ID NO: 80 - protein, 505 aa, Arabidopsis thaliana
MDLLLLEKSLIAVFVAVILATVISKLRGKKLKLPPGPIPIPIFGNWLQVGDDLNHRNLVDYAKKFGDLFLLRMGQRNLVVVSSPDLTKEVLLTQGVEFGSRTRNVVFDIFTGKGQDMVFTVYGEHWRKMRRIMTVPFFTNKVVQQNREGWEFEAASVVEDVKKNPDSATKGIVLRKRLQLMMYNNMFRIMFDRRFESEDDPLFLRLKALNGERSRLAQSFEYNYGDFIPILRPFLRGYLKICQDVKDRRIALFKKYFVDERKQIASSKPTGSEGLKCAIDHILEAEQKGEINEDNVLYIVENINVAAIETTLWSIEWGIAELVNHPEIQSKLRNELDTVLGPGVQVTEPDLHKLPYLQAVVKETLRLRMAIPLLVPHMNLHDAKLAGYDIPAESKILVNAWWLANNPNSWKKPEEFRPERFFEEESHVEANGNDFRYVPFGVGRRSCPGIILALPILGITIGRMVQNFELLPPPGQSKVDTSEKGGQFSLHILNHSIIVMKPRNC

SEQ ID NO: 81 - protein, 954 aa, synthetic construct
MAPQEQAVSQVMEKQSNNNNSDVIFRSKLPDIYIPNHLSLHDYIFQNISEFATKPCLINGPTGHVYTYSDVHVISRQIAANFHKLGVNQNDVVMLLLPNCPEFVLSFLAASFRGATATAANPFFTPAEIAKQAKASNTKLIITEARYVDKIKPLQNDDGVVIVCIDDNESVPIPEGCLRFTELTQSTTEASEVIDSVEISPDDVVALPYSSGTTGLPKGVMLTHKGLVTSVAQQVDGENPNLYFHSDDVILCVLPMFHIYALNSIMLCGLRVGAAILIMPKFEINLLLELIQRCKVTVAPMVPPIVLAIAKSSETEKYDLSSIRVVKSGAAPLGKELEDAVNAKFPNAKLGQGYGMTEAGPVLAMSLGFAKEPFPVKSGACGTVVRNAEMKIVDPDTGDSLSRNQPGEICIRGHQIMKGYLNNPAATAETIDKDGWLHTGDIGLIDDDDELFIVDRLKELIKYKGFQVAPAELEALLIGHPDITDVAVVAMKEEAAGEVPVAFVVKSKDSELSEDDVKQFVSKQVVFYKRINKVFFTESIPKAPSGKILRKDLRAKLANGLVDEAAAKSGRATEEMKKLATVMAIGTANPPNCYYQADFPDFYFRVTNSDHLINLKQKFKRLCENSRIEKRYLHVTEEILKENPNIAAYEATSLNVRHKMQVKGVAELGKEAALKAIKEWGQPKSKITHLIVCCLAGVDMPGADYQLTKLLDLDPSVKRFMFYHLGCYAGGTVLRLAKDIAENNKGARVLIVCSEMTTTCFRGPSETHLDSMIGQAILGDGAAAVIVGADPDLTVERPIFELVSTAQTIVPESHGAIEGHLLESGLSFHLYKTVPTLISNNIKTCLSDAFTPLNISDWNSLFWIAHPGGPAILDQVTAKVGLEKEKLKVTRQVLKDYGNMSSATVFFIMDEMRKKSLENGQATTGEGLEWGVLFGFGPGITVETVVLRSVPVIS

SEQ ID NO: 82 - protein, 937 aa, synthetic construct
MGDCVAPKEDLIFRSKLPDIYIPKHLPLHTYCFENISKVGDKSCLINGATGETFTYSQVELLSRKVASGLNKLGIQQGDTIMLLLPNSPEYFFAFLGASYRGAISTMANPFFTSAEVIKQLKASLAKLIITQACYVDKVKDYAAEKNIQIICIDDAPQDCLHFSKLMEADESEMPEVVIDSDDVVALPYSSGTTGLPKGVMLTHKGLVTSVAQQVDGDNPNLYMHSEDVMICILPLFHIYSLNAVLCCGLRAGVTILIMQKFDIVPFLELIQKYKVTIGPFVPPIVLAIAKSPVVDKYDLSSVRTVMSGAAPLGKELEDAVRAKFPNAKLGQGYGMTEAGPVLAMCLAFAKEPYEIKSGACGTVVRNAEMKIVDPETNASLPRNQRGEICIRGDQIMKGYLNDPESTRTTIDEEGWLHTGDIGFIDDDDELFIVDRLKEIIKYKGFQVAPAELEALLLTHPTISDAAVVPMIDEKAGEVPVAFVVRTNGFTTTEEEIKQFVSKQVVFYKRIFRVFFVDAIPKSPSGKILRKDLRAKIASGDLPKVDEAAAKSGRATEEMKKLATVMAIGTANPPNCYYQADFPDFYFRVTNSDHLINLKQKFKRLCENSRIEKRYLHVTEEILKENPNIAAYEATSLNVRHKMQVKGVAELGKEAALKAIKEWGQPKSKITHLIVCCLAGVDMPGADYQLTKLLDLDPSVKRFMFYHLGCYAGGTVLRLAKDIAENNKGARVLIVCSEMTTTCFRGPSETHLDSMIGQAILGDGAAAVIVGADPDLTVERPIFELVSTAQTIVPESHGAIEGHLLESGLSFHLYKTVPTLISNNIKTCLSDAFTPLNISDWNSLFWIAHPGGPAILDQVTAKVGLEKEKLKVTRQVLKDYGNMSSATVFFIMDEMRKKSLENGQATTGEGLEWGVLFGFGPGITVETVVLRSVPVIS

SEQ ID NO: 83 - protein, 561 aa, Arabidopsis thaliana
MAPQEQAVSQVMEKQSNNNNSDVIFRSKLPDIYIPNHLSLHDYIFQNISEFATKPCLINGPTGHVYTYSDVHVISRQIAANFHKLGVNQNDVVMLLLPNCPEFVLSFLAASFRGATATAANPFFTPAEIAKQAKASNTKLIITEARYVDKIKPLQNDDGVVIVCIDDNESVPIPEGCLRFTELTQSTTEASEVIDSVEISPDDVVALPYSSGTTGLPKGVMLTHKGLVTSVAQQVDGENPNLYFHSDDVILCVLPMFHIYALNSIMLCGLRVGAAILIMPKFEINLLLELIQRCKVTVAPMVPPIVLAIAKSSETEKYDLSSIRVVKSGAAPLGKELEDAVNAKFPNAKLGQGYGMTEAGPVLAMSLGFAKEPFPVKSGACGTVVRNAEMKIVDPDTGDSLSRNQPGEICIRGHQIMKGYLNNPAATAETIDKDGWLHTGDIGLIDDDDELFIVDRLKELIKYKGFQVAPAELEALLIGHPDITDVAVVAMKEEAAGEVPVAFVVKSKDSELSEDDVKQFVSKQVVFYKRINKVFFTESIPKAPSGKILRKDLRAKLANGL

SEQ ID NO: 84 - protein, 425 aa, Petroselinum crispum
QLKASLAKLIITQACYVDKVKDYAAEKNIQIICIDDAPQDCLHFSKLMEADESEMPEVVIDSDDVVALPYSSGTTGLPKGVMLTHKGLVTSVAQQVDGDNPNLYMHSEDVMICILPLFHIYSLNAVLCCGLRAGVTILIMQKFDIVPFLELIQKYKVTIGPFVPPIVLAIAKSPVVDKYDLSSVRTVMSGAAPLGKELEDAVRAKFPNAKLGQGYGMTEAGPVLAMCLAFAKEPYEIKSGACGTVVRNAEMKIVDPETNASLPRNQRGEICIRGDQIMKGYLNDPESTRTTIDEEGWLHTGDIGFIDDDDELFIVDRLKEIIKYKGFQVAPAELEALLLTHPTISDAAVVPMIDEKAGEVPVAFVVRTNGFTTTEEEIKQFVSKQVVFYKRIFRVFFVDAIPKSPSGKILRKDLRAKIASGDLPK

SEQ ID NO: 85 - protein, 10 aa, synthetic construct
VDEAAAKSGR

SEQ ID NO: 86 - protein, 1887 aa, Saccharomyces cerevisiae
MKPEVEQELAHILLTELLAYQFASPVRWIETQDVFLKDFNTERVVEIGPSPTLAGMAQRTLKNKYESYDAALSLHREILCYSKDAKEIYYTPDPSELAAKEEPAKEEAPAPTPAASAPAPAAAAPAPVAAAAPAAAAAEIADEPVKASLLLHVLVAHKLKKSLDSIPMSKTIKDLVGGKSTVQNEILGDLGKEFGTTPEKPEETPLEELAETFQDTFSGALGKQSSSLLSRLISSKMPGGFTITVARKYLQTRWGLPSGRQDGVLLVALSNEPAARLGSEADAKAFLDSMAQKYASIVGVDLSSAASASGAAGAGAAAGAAMIDAGALEEITKDHKVLARQQLQVLARYLKMDLDNGERKFLKEKDTVAELQAQLDYLNAELGEFFVNGVATSFSRKKARTFDSSWNWAKQSLLSLYFEIIHGVLKNVDREVVSEAINIMNRSNDALIKFMEYHISNTDETKGENYQLVKTLGEQLIENCKQVLDVDPVYKDVAKPTGPKTAIDKNGNITYSEEPREKVRKLSQYVQEMALGGPITKESQPTIEEDLTRVYKAISAQADKQDISSSTRVEFEKLYSDLMKFLESSKEIDPSQTTQLAGMDVEDALDKDSTKEVASLPNKSTISKTVSSTIPRETIPFLHLRKKTPAGDWKYDRQLSSLFLDGLEKAAFNGVTFKDKYVLITGAGKGSIGAEVLQGLLQGGAKVVVTTSRFSKQVTDYYQSIYAKYGAKGSTLIVVPFNQGSKQDVEALIEFIYDTEKNGGLGWDLDAIIPFAAIPEQGIELEHIDSKSEFAHRIMLTNILRMMGCVKKQKSARGIETRPAQVILPMSPNHGTFGGDGMYSESKLSLETLFNRWHSESWANQLTVCGAIIGWTRGTGLMSANNIIAEGIEKMGVRTFSQKEMAFNLLGLLTPEVVELCQKSPVMADLNGGLQFVPELKEFTAKLRKELVETSEVRKAVSIETALEHKVVNGNSADAAYAQVEIQPRANIQLDFPELKPYKQVKQIAPAELEGLLDLERVIVVTGFAEVGPWGSARTRWEMEAFGEFSLEGCVEMAWIMGFISYHNGNLKGRPYTGWVDSKTKEPVDDKDVKAKYETSILEHSGIRLIEPELFNGYNPEKKEMIQEVIVEEDLEPFEASKETAEQFKHQHGDKVDIFEIPETGEYSVKLLKGATLYIPKALRFDRLVAGQIPTGWNAKTYGISDDIISQVDPITLFVLVSVVEAFIASGITDPYEMYKYVHVSEVGNCSGSGMGGVSALRGMFKDRFKDEPVQNDILQESFINTMSAWVNMLLISSSGPIKTPVGACATSVESVDIGVETILSGKARICIVGGYDDFQEEGSFEFGNMKATSNTLEEFEHGRTPAEMSRPATTTRNGFMEAQGAGIQIIMQADLALKMGVPIYGIVAMAATATDKIGRSVPAPGKGILTTAREHHSSVKYASPNLNMKYRKRQLVTREAQIKDWVENELEALKLEAEEIPSEDQNEFLLERTREIHNEAESQLRAAQQQWGNDFYKRDPRIAPLRGALATYGLTIDDLGVASFHGTSTKANDKNESATINEMMKHLGRSEGNPVIGVFQKFLTGHPKGAAGAWMMNGALQILNSGIIPGNRNADNVDKILEQFEYVLYPSKTLKTDGVRAVSITSFGFGQKGGQAIVVHPDYLYGAITEDRYNEYVAKVSAREKSAYKFFHNGMIYNKLFVSKEHAPYTDELEEDVYLDPLARVSKDKKSGSLTFNSKNIQSKDSYINANTIETAKMIENMTKEKVSNGGVGVDVELITSINVENDTFIERNFTPQEIEYCSAQPSVQSSFAGTWSAKEAVFKSLGVKSLGGGAALKDIEIVRVNKNAPAVELHGNAKKAAEEAGVTDVKVSISHDDLQAVAVAVSTKK

SEQ ID NO: 87 - protein, 1887 aa, Saccharomyces cerevisiae
MKPEVEQELAHILLTELLAYQFASPVRWIETQDVFLKDFNTERVVEIGPSPTLAGMAQRTLKNKYESYDAALSLHREILCYSKDAKEIYYTPDPSELAAKEEPAKEEAPAPTPAASAPAPAAAAPAPVAAAAPAAAAAEIADEPVKASLLLHVLVAHKLKKSLDSIPMSKTIKDLVGGKSTVQNEILGDLGKEFGTTPEKPEETPLEELAETFQDTFSGALGKQSSSLLSRLISSKMPGGFTITVARKYLQTRWGLPSGRQDGVLLVALSNEPAARLGSEADAKAFLDSMAQKYASIVGVDLSSAASASGAAGAGAAAGAAMIDAGALEEITKDHKVLARQQLQVLARYLKMDLDNGERKFLKEKDTVAELQAQLDYLNAELGEFFVNGVATSFSRKKARTFDSSWNWAKQSLLSLYFEIIHGVLKNVDREVVSEAINIMNRSNDALIKFMEYHISNTDETKGENYQLVKTLGEQLIENCKQVLDVDPVYKDVAKPTGPKTAIDKNGNITYSEEPREKVRKLSQYVQEMALGGPITKESQPTIEEDLTRVYKAISAQADKQDISSSTRVEFEKLYSDLMKFLESSKEIDPSQTTQLAGMDVEDALDKDSTKEVASLPNKSTISKTVSSTIPRETIPFLHLRKKTPAGDWKYDRQLSSLFLDGLEKAAFNGVTFKDKYVLITGAGKGSIGAEVLQGLLQGGAKVVVTTSRFSKQVTDYYQSIYAKYGAKGSTLIVVPFNQGSKQDVEALIEFIYDTEKNGGLGWDLDAIIPFAAIPEQGIELEHIDSKSEFAHRIMLTNILRMMGCVKKQKSARGIETRPAQVILPMSPNHGTFGGDGMYSESKLSLETLFNRWHSESWANQLTVCGAIIGWTRGTGLMSANNIIAEGIEKMGVRTFSQKEMAFNLLGLLTPEVVELCQKSPVMADLNGGLQFVPELKEFTAKLRKELVETSEVRKAVSIETALEHKVVNGNSADAAYAQVEIQPRANIQLDFPELKPYKQVKQIAPAELEGLLDLERVIVVTGFAEVGPWGSARTRWEMEAFGEFSLEGCVEMAWIMGFISYHNGNLKGRPYTGWVDSKTKEPVDDKDVKAKYETSILEHSGIRLIEPELFNGYNPEKKEMIQEVIVEEDLEPFEASKETAEQFKHQHGDKVDIFEIPETGEYSVKLLKGATLYIPKALRFDRLVAGQIPTGWNAKTYGISDDIISQVDPITLFVLVSVVEAFIASGITDPYEMYKYVHVSEVGNCSGSCMGGVSALRGMFKDRFKDEPVQNDILQESFINTMSAWVNMLLISSSGPIKTPVGACATSVESVDIGVETILSGKARICIVGGYDDFQEEGSFEFGNMKATSNTLEEFEHGRTPAEMSRPATTTRNGFMEAQGAGIQIIMQADLALKMGVPIYGIVAMAATATDKIGRSVPAPGKGILTTAREHHSSVKYASPNLNMKYRKRQLVTREAQIKDWVENELEALKLEAEEIPSEDQNEFLLERTREIHNEAESQLRAAQQQWGNDFYKRDPRIAPLRGALATYGLTIDDLGVASFHGTSTKANDKNESATINEMMKHLGRSEGNPVIGVFQKFLTGHPKGAAGAWMMNGALQILNSGIIPGNRNADNVDKILEQFEYVLYPSKTLKTDGVRAVSITSFGFGQKGGQAIVVHPDYLYGAITEDRYNEYVAKVSAREKSAYKFFHNGMIYNKLFVSKEHAPYTDELEEDVYLDPLARVSKDKKSGSLTFNSKNIQSKDSYINANTIETAKMIENMTKEKVSNGGVGVDVELITSINVENDTFIERNFTPQEIEYCSAQPSVQSSFAGTWSAKEAVFKSLGVKSLGGGAALKDIEIVRVNKNAPAVELHGNAKKAAEEAGVTDVKVSISHDDLQAVAVAVSTKK

SEQ ID NO: 88 - protein, 1887 aa, Saccharomyces cerevisiae
MKPEVEQELAHILLTELLAYQFASPVRWIETQDVFLKDFNTERVVEIGPSPTLAGMAQRTLKNKYESYDAALSLHREILCYSKDAKEIYYTPDPSELAAKEEPAKEEAPAPTPAASAPAPAAAAPAPVAAAAPAAAAAEIADEPVKASLLLHVLVAHKLKKSLDSIPMSKTIKDLVGGKSTVQNEILGDLGKEFGTTPEKPEETPLEELAETFQDTFSGALGKQSSSLLSRLISSKMPGGFTITVARKYLQTRWGLPSGRQDGVLLVALSNEPAARLGSEADAKAFLDSMAQKYASIVGVDLSSAASASGAAGAGAAAGAAMIDAGALEEITKDHKVLARQQLQVLARYLKMDLDNGERKFLKEKDTVAELQAQLDYLNAELGEFFVNGVATSFSRKKARTFDSSWNWAKQSLLSLYFEIIHGVLKNVDREVVSEAINIMNRSNDALIKFMEYHISNTDETKGENYQLVKTLGEQLIENCKQVLDVDPVYKDVAKPTGPKTAIDKNGNITYSEEPREKVRKLSQYVQEMALGGPITKESQPTIEEDLTRVYKAISAQADKQDISSSTRVEFEKLYSDLMKFLESSKEIDPSQTTQLAGMDVEDALDKDSTKEVASLPNKSTISKTVSSTIPRETIPFLHLRKKTPAGDWKYDRQLSSLFLDGLEKAAFNGVTFKDKYVLITGAGKGSIGAEVLQGLLQGGAKVVVTTSRFSKQVTDYYQSIYAKYGAKGSTLIVVPFNQGSKQDVEALIEFIYDTEKNGGLGWDLDAIIPFAAIPEQGIELEHIDSKSEFAHRIMLTNILRMMGCVKKQKSARGIETRPAQVILPMSPNHGTFGGDGMYSESKLSLETLFNRWHSESWANQLTVCGAIIGWTRGTGLMSANNIIAEGIEKMGVRTFSQKEMAFNLLGLLTPEVVELCQKSPVMADLNGGLQFVPELKEFTAKLRKELVETSEVRKAVSIETALEHKVVNGNSADAAYAQVEIQPRANIQLDFPELKPYKQVKQIAPAELEGLLDLERVIVVTGFAEVGPWGSARTRWEMEAFGEFSLEGCVEMAWIMGFISYHNGNLKGRPYTGWVDSKTKEPVDDKDVKAKYETSILEHSGIRLIEPELFNGYNPEKKEMIQEVIVEEDLEPFEASKETAEQFKHQHGDKVDIFEIPETGEYSVKLLKGATLYIPKALRFDRLVAGQIPTGWNAKTYGISDDIISQVDPITLFVLVSVVEAFIASGITDPYEMYKYVHVSEVGNCSGSAMGGVSALRGMFKDRFKDEPVQNDILQESFINTMSAWVNMLLISSSGPIKTPVGACATSVESVDIGVETILSGKARICIVGGYDDFQEEGSFEFGNMKATSNTLEEFEHGRTPAEMSRPATTTRNGFMEAQGAGIQIIMQADLALKMGVPIYGIVAMAATATDKIGRSVPAPGKGILTTAREHHSSVKYASPNLNMKYRKRQLVTREAQIKDWVENELEALKLEAEEIPSEDQNEFLLERTREIHNEAESQLRAAQQQWGNDFYKRDPRIAPLRGALATYGLTIDDLGVASFHGTSTKANDKNESATINEMMKHLGRSEGNPVIGVFQKFLTGHPKGAAGAWMMNGALQILNSGIIPGNRNADNVDKILEQFEYVLYPSKTLKTDGVRAVSITSFGFGQKGGQAIVVHPDYLYGAITEDRYNEYVAKVSAREKSAYKFFHNGMIYNKLFVSKEHAPYTDELEEDVYLDPLARVSKDKKSGSLTFNSKNIQSKDSYINANTIETAKMIENMTKEKVSNGGVGVDVELITSINVENDTFIERNFTPQEIEYCSAQPSVQSSFAGTWSAKEAVFKSLGVKSLGGGAALKDIEIVRVNKNAPAVELHGNAKKAAEEAGVTDVKVSISHDDLQAVAVAVSTKK

SEQ ID NO: 89 - protein, 591 aa, Saccharomyces cerevisiae
MLKYKPLLKISKNCEAAILRASKTRLNTIRAYGSTVPKSKSFEQDSRKRTQSWTALRVGAILAATSSVAYLNWHNGQIDNEPKLDMNKQKISPAEVAKHNKPDDCWVVINGYVYDLTRFLPNHPGGQDVIKFNAGKDVTAIFEPLHAPNVIDKYIAPEKKLGPLQGSMPPELVCPPYAPGETKEDIARKEQLKSLLPPLDNIINLYDFEYLASQTLTKQAWAYYSSGANDEVTHRENHNAYHRIFFKPKILVDVRKVDISTDMLGSHVDVPFYVSATALCKLGNPLEGEKDVARGCGQGVTKVPQMISTLASCSPEEIIEAAPSDKQIQWYQLYVNSDRKITDDLVKNVEKLGVKALFVTVDAPSLGQREKDMKLKFSNTKAGPKAMKKTNVEESQGASRALSKFIDPSLTWKDIEELKKKTKLPIVIKGVQRTEDVIKAAEIGVSGVVLSNHGGRQLDFSRAPIEVLAETMPILEQRNLKDKLEVFVDGGVRRGTDVLKALCLGAKGVGLGRPFLYANSCYGRNGVEKAIEILRDEIEMSMRLLGVTSIAELKPDLLDLSTLKARTVGVPNDVLYNEVYEGPTLTEFEDA

SEQ ID NO: 90 - protein, 587 aa, Saccharomyces cerevisiae
MLWKRTCTRLIKPIAQPRGRLVRRSCYRYASTGTGSTDSSSQWLKYSVIASSATLFGYLFAKNLYSRETKEDLIEKLEMVKKIDPVNSTLKLSSLDSPDYLHDPVKIDKVVEDLKQVLGNKPENYSDAKSDLDAHSDTYFNTHHPSPEQRPRIILFPHTTEEVSKILKICHDNNMPVVPFSGGTSLEGHFLPTRIGDTITVDLSKFMNNVVKFDKLDLDITVQAGLPWEDLNDYLSDHGLMFGCDPGPGAQIGGCIANSCSGTNAYRYGTMKENIINMTIVLPDGTIVKTKKRPRKSSAGYNLNGLFVGSEGTLGIVTEATVKCHVKPKAETVAVVSFDTIKDAAACASNLTQSGIHLNAMELLDENMMKLINASESTDRCDWVEKPTMFFKIGGRSPNIVNALVDEVKAVAQLNHCNSFQFAKDDDEKLELWEARKVALWSVLDADKSKDKSAKIWTTDVAVPVSQFDKVIHETKKDMQASKLINAIVGHAGDGNFHAFIVYRTPEEHETCSQLVDRMVKRALNAEGTCTGEHGVGIGKREYLLEELGEAPVDLMRKIKLAIDPKRIMNPDKIFKTDPNEPANDYR

SEQ ID NO: 91 - protein, 500 aa, Saccharomyces cerevisiae
MTLPESKDFSYLFSDETNARKPSPLKTCIHLFQDPNIIFLGGGLPLKDYFPWDNLSVDSPKPPFPQGIGAPIDEQNCIKYTVNKDYADKSANPSNDIPLSRALQYGFSAGQPELLNFIRDHTKIIHDLKYKDWDVLATAGNTNAWESTLRVFCNRGDVILVEAHSFSSSLASAEAQGVITFPVPIDADGIIPEKLAKVMENWTPGAPKPKLLYTIPTGQNPTGTSIADHRKEAIYKIAQKYDFLIVEDEPYYFLQMNPYIKDLKEREKAQSSPKQDHDEFLKSLANTFLSLDTEGRVIRMDSFSKVLAPGTRLGWITGSSKILKPYLSLHEMTIQAPAGFTQVLVNATLSRWGQKGYLDWLLGLRHEYTLKRDCAIDALYKYLPQSDAFVINPPIAGMFFTVNIDASVHPEFKTKYNSDPYQLEQSLYHKVVERGVLVVPGSWFKSEGETEPPQPAESKEVSNPNIIFFRGTYAAVSPEKLTEGLKRLGDTLYEEFGISK

SEQ ID NO: 92 - protein, 513 aa, Saccharomyces cerevisiae
MTAGSAPPVDYTSLKKNFQPFLSRRVENRSLKSFWDASDISDDVIELAGGMPNERFFPIESMDLKISKVPFNDNPKWHNSFTTAHLDLGSPSELPIARSFQYAETKGLPPLLHFVKDFVSRINRPAFSDETESNWDVILSGGSNDSMFKVFETICDESTTVMIEEFTFTPAMSNVEATGAKVIPIKMNLTFDRESQGIDVEYLTQLLDNWSTGPYKDLNKPRVLYTIATGQNPTGMSVPQWKREKIYQLAQRHDFLIVEDDPYGYLYFPSYNPQEPLENPYHSSDLTTERYLNDFLMKSFLTLDTDARVIRLETFSKIFAPGLRLSFIVANKFLLQKILDLADITTRAPSGTSQAIVYSTIKAMAESNLSSSLSMKEAMFEGWIRWIMQIASKYNHRKNLTLKALYETESYQAGQFTVMEPSAGMFIIIKINWGNFDRPDDLPQQMDILDKFLLKNGVKVVLGYKMAVCPNYSKQNSDFLRLTIAYARDDDQLIEASKRIGSGIKEFFDNYKS

SEQ ID NO: 93 - protein, 563 aa, Saccharomyces cerevisiae
MSEITLGKYLFERLKQVNVNTVFGLPGDFNLSLLDKIYEVEGMRWAGNANELNAAYAADGYARIKGMSCIITTFGVGELSALNGIAGSYAEHVGVLHVVGVPSISAQAKQLLLHHTLGNGDFTVFHRMSANISETTAMITDIATAPAEIDRCIRTTYVTQRPVYLGLPANLVDLNVPAKLLQTPIDMSLKPNDAESEKEVIDTILALVKDAKNPVILADACCSRHDVKAETKKLIDLTQFPAFVTPMGKGSIDEQHPRYGGVYVGTLSKPEVKEAVESADLILSVGALLSDFNTGSFSYSYKTKNIVEFHSDHMKIRNATFPGVQMKFVLQKLLTTIADAAKGYKPVAVPARTPANAAVPASTPLKQEWMWNQLGNFLQEGDVVIAETGTSAFGINQTTFPNNTYGISQVLWGSIGFTTGATLGAAFAAEEIDPKKRVILFIGDGSLQLTVQEISTMIRWGLKPYLFVLNNDGYTIEKLIHGPKAQYNEIQGWDHLSLLPTFGAKDYETHRVATTGEWDKLTQDKSFNDNSKIRMIEIMLPVFDAPQNLVEQAKLTAATNAKQ

SEQ ID NO: 94 - protein, 563 aa, Saccharomyces cerevisiae
MSEITLGKYLFERLSQVNCNTVFGLPGDFNLSLLDKLYEVKGMRWAGNANELNAAYAADGYARIKGMSCIITTFGVGELSALNGIAGSYAEHVGVLHVVGVPSISSQAKQLLLHHTLGNGDFTVFHRMSANISETTAMITDIANAPAEIDRCIRTTYTTQRPVYLGLPANLVDLNVPAKLLETPIDLSLKPNDAEAEAEVVRTVVELIKDAKNPVILADACASRHDVKAETKKLMDLTQFPVYVTPMGKGAIDEQHPRYGGVYVGTLSRPEVKKAVESADLILSIGALLSDFNTGSFSYSYKTKNIVEFHSDHIKIRNATFPGVQMKFALQKLLDAIPEVVKDYKPVAVPARVPITKSTPANTPMKQEWMWNHLGNFLREGDIVIAETGTSAFGINQTTFPTDVYAIVQVLWGSIGFTVGALLGATMAAEELDPKKRVILFIGDGSLQLTVQEISTMIRWGLKPYIFVLNNNGYTIEKLIHGPHAEYNEIQGWDHLALLPTFGARNYETHRVATTGEWEKLTQDKDFQDNSKIRMIEVMLPVFDAPQNLVKQAQLTAATNAKQ

SEQ ID NO: 95 - protein, 563 aa, Saccharomyces cerevisiae
MSEITLGKYLFERLKQVNVNTIFGLPGDFNLSLLDKIYEVDGLRWAGNANELNAAYAADGYARIKGLSVLVTTFGVGELSALNGIAGSYAEHVGVLHVVGVPSISAQAKQLLLHHTLGNGDFTVFHRMSANISETTSMITDIATAPSEIDRLIRTTFITQRPSYLGLPANLVDLKVPGSLLEKPIDLSLKPNDPEAEKEVIDTVLELIQNSKNPVILSDACASRHNVKKETQKLIDLTQFPAFVTPLGKGSIDEQHPRYGGVYVGTLSKQDVKQAVESADLILSVGALLSDFNTGSFSYSYKTKNVVEFHSDYVKVKNATFLGVQMKFALQNLLKVIPDVVKGYKSVPVPTKTPANKGVPASTPLKQEWLWNELSKFLQEGDVIISETGTSAFGINQTIFPKDAYGISQVLWGSIGFTTGATLGAAFAAEEIDPNKRVILFIGDGSLQLTVQEISTMIRWGLKPYLFVLNNDGYTIEKLIHGPHAEYNEIQTWDHLALLPAFGAKKYENHKIATTGEWDALTTDSEFQKNSVIRLIELKLPVFDAPESLIKQAQLTAATNAKQ

SEQ ID NO: 96 - protein, 635 aa, Saccharomyces cerevisiae
MAPVTIEKFVNQEERHLVSNRSATIPFGEYIFKRLLSIDTKSVFGVPGDFNLSLLEYLYSPSVESAGLRWVGTCNELNAAYAADGYSRYSNKIGCLITTYGVGELSALNGIAGSFAENVKVLHIVGVAKSIDSRSSNFSDRNLHHLVPQLHDSNFKGPNHKVYHDMVKDRVACSVAYLEDIETACDQVDNVIRDIYKYSKPGYIFVPADFADMSVTCDNLVNVPRISQQDCIVYPSENQLSDIINKITSWIYSSKTPAILGDVLTDRYGVSNFLNKLICKTGIWNFSTVMGKSVIDESNPTYMGQYNGKEGLKQVYEHFELCDLVLHFGVDINEINNGHYTFTYKPNAKIIQFHPNYIRLVDTRQGNEQMFKGINFAPILKELYKRIDVSKLSLQYDSNVTQYTNETMRLEDPTNGQSSIITQVHLQKTMPKFLNPGDVVVCETGSFQFSVRDFAFPSQLKYISQGFFLSIGMALPAALGVGIAMQDHSNAHINGGNVKEDYKPRLILFEGDGAAQMTIQELSTILKCNIPLEVIIWNNNGYTIERAIMGPTRSYNDVMSWKWTKLFEAFGDFDGKYTNSTLIQCPSKLALKLEELKNSNKRSGIELLEVKLGELDFPEQLKCMVEAAALKRNKK

SEQ ID NO: 97 - protein, 386 aa, Saccharomyces cerevisiae
MSAATVGKPIKCIAAVAYDAKKPLSVEEITVDAPKAHEVRIKIEYTAVCHTDAYTLSGSDPEGLFPCVLGHEGAGIVESVGDDVITVKPGDHVIALYTAECGKCKFCTSGKTNLCGAVRATQGKGVMPDGTTRFHNAKGEDIYHFMGCSTFSEYTVVADVSVVAIDPKAPLDAACLLGCGVTTGFGAALKTANVQKGDTVAVFGCGTVGLSVIQGAKLRGASKIIAIDINNKKKQYCSQFGATDFVNPKEDLAKDQTIVEKLIEMTDGGLDFTFDCTGNTKIMRDALEACHKGWGQSIIIGVAAAGEEISTRPFQLVTGRVWKGSAFGGIKGRSEMGGLIKDYQKGALKVEEFITHRRPFKEINQAFEDLHNGDCLRTVLKSDEIK

SEQ ID NO: 98 - protein, 382 aa, Saccharomyces cerevisiae
MSSVTGFYIPPISFFGEGALEETADYIKNKDYKKALIVTDPGIAAIGLSGRVQKMLEERDLNVAIYDKTQPNPNIANVTAGLKVLKEQNSEIVVSIGGGSAHDNAKAIALLATNGGEIGDYEGVNQSKKAALPLFAINTTAGTASEMTRFTIISNEEKKIKMAIIDNNVTPAVAVNDPSTMFGLPPALTAATGLDALTHCIEAYVSTASNPITDACALKGIDLINESLVAAYKDGKDKKARTDMCYAEYLAGMAFNNASLGYVHALAHQLGGFYHLPHGVCNAVLLPHVQEANMQCPKAKKRLGEIALHFGASQEDPEETIKALHVLNRTMNIPRNLKELGVKTEDFEILAEHAMHDACHLTNPVQFTKEQVVAIIKKAYEY

SEQ ID NO: 99 - protein, 351 aa, Saccharomyces cerevisiae
MPSQVIPEKQKAIVFYETDGKLEYKDVTVPEPKPNEILVHVKYSGVCHSDLHAWHGDWPFQLKFPLIGGHEGAGVVVKLGSNVKGWKVGDFAGIKWLNGTCMSCEYCEVGNESQCPYLDGTGFTHDGTFQEYATADAVQAAHIPPNVNLAEVAPILCAGITVYKALKRANVIPGQWVTISGACGGLGSLAIQYALAMGYRVIGIDGGNAKRKLFEQLGGEIFIDFTEEKDIVGAIIKATNGGSHGVINVSVSEAAIEASTRYCRPNGTVVLVGMPAHAYCNSDVFNQVVKSISIVGSCVGNRADTREALDFFARGLIKSPIHLAGLSDVPEIFAKMEKGEIVGRYVVETSK